(19) United States
(12) Patent Application Publication
(10) Pub. No.: US 2011/0295741 A1
(43) Pub. Date: Dec. 1, 2011

(54) MONEY MANAGEMENT DEVICE, MONEY MANAGEMENT SYSTEM, MONEY MANAGEMENT METHOD AND TELLER MACHINE

(76) Inventors: Akihiro Sugitani, Hyogo-Ken (JP); Misa Kitazume, Hyogo-Ken (JP); Hideki Sakurai, Hyogo-Ken (JP)

(21) Appl. No.: 13/129,839

(22) PCT Filed: Nov. 17, 2009
(86) PCT No.: PCT/JP2009/069501

§ 371 Date: Jun. 30, 2011

(30) Foreign Application Priority Data
Nov. 19, 2008 (JP) 2008-295729
Nov. 19, 2008 (JP) 2008-295761
Sep. 2, 2009 (JP) 2009-202783
Nov. 12, 2009 (JP) 2009-258852

(51) Int. Cl. G07D 11/00; G06Q 40/00

(52) U.S. Cl. 705/39

(57) ABSTRACT

A money management system related to one embodiment of the present invention includes a teller machine provided for managing a money amount in a branch of a financial institution, and a money management device that is connectable with the teller machine so as to be able to communicate with each other, and is capable of independently managing the money amount, wherein the teller machine includes: a cooperation-process-information preparation unit configured to prepare cooperation process information for specifying the content of a storage/take-out process, in the case in which the storage/take-out process is performed in regard to the total amount of money stored in the money management device (or money-management-device money amount); and a cooperation-process-information transmission/reception unit configured to transmit and receive the cooperation process information between the teller machine and the money management device, such that the teller machine can manage the money amount including the money-management-device money amount.

### FIELD OF THE INVENTION

The present invention relates to a teller machine (or money management main body) and a money management device (or money management terminal) connected to each other so as to be able to communicate with each other. This invention also relates to a money management system including the teller machine and the money management device and a money management method thereof.

### BACKGROUND ART

In Utility Model Application No. 2599232, a cash management device is disclosed. In this cash management device, a storing unit is provided for each denomination of money, and a weight measuring unit is provided for each storing unit. The weight of coin rolls is measured for each denomination of money by the weight measuring unit in order to calculate the number of the coin rolls, for each denomination of money, from the measured weight. The calculated number of the coin rolls is stored and displayed together with the date and time on which the weight of the coin rolls is measured. The measurement operation for the weight of the coin rolls and the counting and storage operation for the number of the coin rolls are respectively performed each time the cash management device is operated (or each time the data is altered).

This cash management device is utilized when the amount of the cash becomes too much to be deposited in the teller machine. On the other hand, when the amount of the cash becomes adequately small in the teller machine, the cash stored in the cash management device is taken out therefrom in order to be used for supplementing the teller machine.

Upon depositing and/or dispensing money relative to this cash management device, a banker enters the amount of such deposited and/or dispensed money in a ledger or the like.

However, if the amount of the deposited and/or dispensed money entered in the ledger is different from an actual amount of the deposited and/or dispensed money, a great problem should occur. For instance, this cash management device can measure only the actual amount of the deposited and/or dispensed money and cannot check whether or not the amount of the deposited and/or dispensed money entered in the ledger is correct. In addition, this device cannot manage the person who actually handles the deposited and/or dispensed money (e.g., if being the banker, any person can open and close each storing unit of this device). Therefore, for instance, it is theoretically possible that some banker falsifies the amount of the deposited and/or dispensed money.

Further, this cash management device is not intended for managing the money amount in the teller machine together with the money amount in the money management device, thus making it difficult to collectively manage the money amounts in both of the teller machine and money management device.

Meanwhile, JP2726550B discloses a cash management system capable of totalizing the cash balance for a plurality of automatic transaction machines. This cash management system can collectively manage the money amounts for the plurality of automatic transaction machines.

However, in the cash management system described in this JP2726550B, the plurality of automatic transaction machines are not connected with a cash processing machine so as to communicate with each other. Therefore, in order to perform the collective management on the money amount for the entire system, it is necessary to collect information on money amount by carrying a refill unit having a memory and an output unit to each of the plurality of automatic transaction machines and cash processing machine and then attaching and detaching this refill unit relative to each of such machines. This work is quite complicated and troublesome. Therefore, linking and managing the information on money amount should take so much time.

Thus, in the prior art, there has been virtually no money management system that can perform the collective management on the money amount in a financial institution, by readily linking or cooperating together the information on the money amounts in both of the teller machine (or money management main body) and money management device (or money management terminal) which constitute the system.

In addition, the system disclosed in the above JP2726550B is intended for collecting the information on money amount stored in the refill unit, when this refill unit is attached to the teller machine (or ATM), and is not related to the management on the money amount of the money management device configured to allow the banker to deposit and dispense the cash relative to this money management device.

In JP2003-36361A, a system is disclosed, wherein a cash handling machine is connected with a host terminal so as to communication with each other in order to automatically manage the money amount of the teller machine by the host terminal. Further, in JP2002-133094A, another system is disclosed, wherein a branch of a financial institution and a center provided for managing data on this branch are connected with each other so as to communicate with each other in order to manage the money amount data on this branch of the financial institution in real time in the center.

However, each of the systems as described in the above Patent Documents is not related to the management on the money amount of the money management device provided for allowing the banker to deposit and dispense the cash relative to this device.

Accordingly, in the prior art, there has been actually no money management system provided for performing the collective management on the money amount in the financial institution, by linking or cooperating together the information on the money amounts of in both of the teller machine and money management device.

Furthermore, in the cash management system described in the above JP2726550B, the plurality of automatic transaction machines are not respectively connected with the cash processing machine so as to communicate with each other. Therefore, in order to perform the collective management on the money amount in the entire system, it is necessary to collect the information on the money amount, by carrying the refill unit having the memory and output unit to each of the plurality of automatic transaction machines and cash processing machine and then attaching and detaching this refill unit relative to each of such machines. Such many operations should render the work for collecting the information quite complicated and troublesome. Such management on each of the information on the money amounts by linking the information requires so much time.

Thus, in the prior art, there has been virtually no money management system that can readily link or cooperate together the information on the money amounts in both of the teller machine (or money management main body) and money management device (or money management terminal) respectively constituting the system.

Therefore, it is an object of the present invention to provide the money management system and money management method, respectively configured such that the teller machine constituting the system can adequately receive information on the money amount in the money management device, thereby to achieve accurate and collective management on the money amount in the financial institution.

It is another object of the present invention to provide the money management system and money management method, respectively configured such that the teller machine can adequately receive information on the money amount in the money management device, thereby to achieve accurate, collective and well centralized management on the money amount in the financial institution.

It is still another object of the present invention to provide the money management system and money management method, respectively configured such that the centralized management on the money amount in the money management device can be performed by the teller machine, without any need for the banker to directly operate the teller machine, when the money or cash is taken out or stored, by the banker, relative to the money management device.

It is yet still another object of the present invention to provide the teller machine, money management device and money management system, respectively configured such that the teller machine constituting the system can adequately receive information on the money amount in the money management device, thereby to achieve more accurate management on the money amount.

### SUMMARY OF THE INVENTION

A money management system related to one embodiment of the present invention includes a teller machine configured to manage the money amount in a branch of a financial institution, and the money management device that can be connected with the teller machine so as to communicate with each other, and is capable of independently or solely managing the money amount, wherein the teller machine includes:

a money amount management unit configured to manage the money amount including a money-management-device money amount that is the amount of money stored in the money management device;

a cooperation-process-information preparation unit configured to prepare cooperation process information for specifying the content of a storage/take-out process, in the case in which the storage/take-out process is performed in the money management device; and

a cooperation-process-information transmission/reception unit configured to transmit and receive the cooperation process information between the teller machine and the money management device, such that the teller machine can manage the money amount including the money-management-device money amount.

In this embodiment, an individual cooperation number may be assigned to each cooperation process information, such that the content of the storage/take-out process specified in the cooperation process information can be specified by each corresponding cooperation number, and the content of the storage/take-out process specified by the cooperation process information includes information on the denomination and quantity of the money to be handled in the storage/take-out process.

The person in charge of the storage/take-out process may be specified in the cooperation process information, such that the cooperation process information and storage/take-out process can be specified, respectively, when the person in charge of the storage/take-out process inputs individual ID information to the money management device.

The money amount managed by the money amount management unit may include a machine money amount that is the total amount of money stored in the teller machine, a stock money amount that is the total amount of money stored in a main safe in the branch of the financial institution, and an in-hand money amount that is the total amount of money manually managed.

The in-hand money amount may include the money-management-device money amount.

The storage/take-out process specified by the cooperation process information may include a money transfer process between the money deposited/dispensed by a customer and the money management device, the money transfer process between the stock money amount and the money-management-device money amount, and the money transfer process between an in-hand money amount and the money-management-device money amount.

Upon the preparation of the cooperation process information, if the money amount in the money management device, as a result of performing the storage/take-out process to be specified, would exceed a maximum-limit amount of money that can be stored in the money management device, registration of this cooperation process information may be rejected.

A money management method using a money management system related to one embodiment of the present invention, the money management system including the teller machine configured to manage the money amount in the branch of the financial institution, and the money management device that can be connected with the teller machine so as to communicate with each other, and is capable of independently or solely managing the money amount,

the money amount, which is managed by the teller machine, including the money-management-device money amount that is the total amount of money stored in the money management device,

the method including:

preparing the cooperation process information for specifying the content of the storage/take-out process, by using the teller machine, in the case of performing the storage/take-out process in the money management device; and

transmitting and receiving the cooperation process information between the teller machine and the money management device, such that the teller machine can manage the money amount including the money-management-device money amount.

A money management system related to another embodiment of the present invention includes a teller machine configured to manage the money amount in the branch of the financial institution, and a money management device that can be connected with the teller machine so as to communicate with each other, and is capable of independently or solely managing the money amount, wherein the teller machine includes:

a money amount management unit configured to manage the money amount including a money-management-device money amount that is the total amount of money stored in the money management device;

a cooperation-process-information preparation unit configured to prepare cooperation process information for specifying the content of a storage/take-out process, when the storage/take-out process is performed in the money management device;

a cooperation-process-information transmission/reception unit configured to transmit and receive the cooperation process information between the teller machine and the money management device, such that the teller machine can manage the money amount including the money-management-device money amount; and

a cooperation-process-information search unit configured to search and specify the cooperation process information in an unprocessed status, in order to check whether or not the storage/take-out process is already processed, upon a closing balance operation.

In this embodiment, the money amount managed by the money amount management unit may include a machine money amount that is the total amount of money stored in the teller machine, a stock money amount that is the total amount of money stored in a main safe in the branch of the financial institution, and an in-hand money amount that is the total amount of money manually managed.

The in-hand money amount may include the money-management-device money amount.

The teller machine may further include a data clear unit configured to perform a data clear process for clearing the cooperation process information temporarily stored in a predetermined work area of the teller machine and money management device, after this cooperation process information on all transaction processes, including the storage/take-out process performed after the previous closing balance operation, is totalized, recorded and stored, upon the present closing balance operation.

Once the information on the start of the data clear process is transmitted from the teller machine to the money management device, the money management device may totalize the cooperation process information on all of the transaction processes including the storage/take-out process performed in the money management device in a predetermined period, in order to prepare an electronic journal file, and then transmits this electronic journal file to the teller machine.

The teller machine may further includes a clear unit configured to clear the cooperation process information temporarily stored in the predetermined work area of the money management device, by remote control, after the teller machine obtains the electronic journal file.

The data clear unit can forcedly continue the data clear process, irrespectively of the presence of the cooperation process information being in the unprocessed status, and the teller machine may further include a printer configured to print and output a certification print indicating that forced continuation of the data clear process is selected, in the case in which the data clear process is forcedly continued.

The teller machine may further include a status altering unit capable of altering the status of the cooperation process information, irrespectively of the process condition of the storage/take-out process being actually performed.

A money management method using a money management system related to another embodiment of the present invention, the money management system including a teller machine configured to manage the money amount in the branch of the financial institution, and a money management device that can be connected with the teller machine so as to communicate with each other, and is capable of independently or solely managing the money amount,

the money amount, which is managed by the teller machine, including a money-management-device money amount that is the total amount of money stored in the money management device, and

the method comprising

preparing the cooperation process information for specifying the content of the storage/take-out process, by using the teller machine, in the case of performing the storage/take-out process in the money management device;

transmitting and receiving the cooperation process information between the teller machine and the money management device, such that the teller machine can manage the money amount including the money-management-device money amount; and

searching and specifying the cooperation process information in the unprocessed status, in order to check whether or not the storage/take-out process is already processed, upon the closing balance operation.

A money management system related to still another embodiment of the present invention includes a teller machine configured to manage the money amount in the branch of the financial institution, and a money management device that can be connected with the teller machine so as to communicate with each other,

wherein the money management device includes: a storing unit configured to store therein money; a memory configured to store therein money amount of the storing unit; and a communication unit configured to transmit process information to the teller machine, the process information including the denomination, quantity and/or amount data of money deposited into the storing unit or dispensed from the storing unit, in the case in which the money is deposited into the storing unit or in which the money is dispensed from the storing unit, and

wherein the teller machine includes: another communication unit configured to receive the process information from the money management device; another memory configured to store therein at least money amount of the teller machine and money amount of the money management device; and an operation unit configured to updating at least the money amount of the money management device, based on the process information.

In this embodiment, the money management device may further include:

an input unit provided for inputting the denomination, quantity and/or amount of money deposited into the storing unit or dispensed from the storing unit;

a measurement unit configured to measure quantity and/or amount of money for denomination, the money being actually deposited into the storing unit or actually dispensed from the storing unit; and

an error information unit configured to inform an operator for the money management device of an error, in the case in which the denomination, quantity and/or amount of money inputted via the input unit are different from the denomination, quantity and/or amount of money measured by the measurement unit,

wherein if the denomination, quantity and/or amount of money inputted via the input unit are respectively coincident with the denomination, quantity and/or amount of money measured by the measurement unit, the money management device transmits the process information to the teller machine, and

wherein if the denomination, quantity and/or amount of money inputted via the input unit are different from the denomination, quantity and/or amount of money measured by the measurement unit, the money management device informs the operator for this money management device of the error, without transmitting the process information to the teller machine.

The money management system may further includes a safe configured to store therein the money in the branch of the financial institution,

wherein the memory of the teller machine stores therein stock money amount which is amount of money stored in the safe, and

wherein in the case in which the money management device is refilled with the money from the safe or in which the money is collected from the money management device into the safe, the communication unit of the money management device transmits the process information including the denomination, quantity and/or amount of money used for refilling the money management device or money collected into the safe, to the teller machine, and then the operation unit of the teller machine updates the stock money amount, based on the process information.

The memory of the teller machine may store therein the in-hand money amount that is managed, at hand, by a person in charge of handling the money in the branch of the financial institution,

wherein in the case in which the money management device is refilled with the money from the in-hand money or in which the money is collected from the money management device into the in-hand money, the communication unit of the money management device transmits the process information including the denomination, quantity and/or amount of money used for refilling the money management device or money collected into the in-hand money, to the teller machine, and then the operation unit of the teller machine updates the money amount of the in-hand money, based on the process information.

In the case in which the person in charge of handling the money stores the money deposited from the customer, into the money management device in the branch of the financial institution, the money management device may add the amount of money deposited from the customer, to the money amount of the storing unit,

while in the case in which the person in charge of handling the money takes out the money dispensed to the customer from the money management device in the branch of the financial institution, the money management device may subtract the amount of money to be dispensed to the customer, from the money amount of the storing unit,

wherein the communication unit of the money management device transmits the process information including the denomination, quantity and/or amount of money stored in the storing unit or money taken out from the storing unit, to the teller machine, and

wherein the operation unit of the teller machine updates the money amount of the money management device, based on the process information.

A money management method using the money management system related to still another embodiment of the present invention, the money management system including a teller machine configured to manage the money amount in the branch of the financial institution, and a money management device that can be connected with the teller machine so as to communicate with each other,

the money amount, which is managed by the teller machine, including the money amount of the money management device,

the method including:

measuring quantity and/or amount for denomination of money deposited into the money management device or dispensed from the money management device, in the money management device, in the case in which the money is deposited into the money management device or in which the money is dispensed from the money management device;

inputting the denomination, quantity and/or amount of money deposited into the money management device or money dispensed from the money management device, to the money management device;

transmitting process information including the denomination, quantity and/or amount of money deposited into the money management device or money dispensed from the money management device, from the money management device to the teller device, by using the money management device, in the case in which the denomination, quantity and/or amount of money measured in the measurement operation are respectively coincident with the denomination, quantity and/or amount of money inputted in the input operation; and

updating at least the money amount of the money management device, by using the teller machine, based on the process information.

A teller machine related to one embodiment of the present invention is connected with a money management device so as to communicate with each other, the money management device configured to store and manage the money therein,

the teller machine includes:

a storing unit configured to store therein the money;
a full detector configured to detect a full-up condition of the storing unit with the money stored therein;
an operation unit configured to generate cooperation process information indicating information on the money collected, in the case in which the money stored in the storing unit is collected into the money management device; and
a transmission/reception unit configured to transmit the cooperation process information to the money management device, as well as to receive collecting completion information for indicating that the money is collected into the money management device on the basis of the cooperation process information, from the money management device,
   wherein the operation unit interrupts a depositing process, when the full detector detects the full-up condition of the storing unit with the money stored therein during the depositing process, and then restarts this depositing process, after receiving the collecting completion information.

A teller machine related to another embodiment of the present invention is connected with the money management device so as to communicate with each other, the money management device configured to store and manage the money therein,

the teller machine includes:

a storing unit configured to store therein the money;
an empty detector configured to detect a nearly empty condition of the storing unit with the money stored therein;
an operation unit configured to generate cooperation process information indicating information on the money used for a refill process, in the case in which the storing unit is refilled with the money from the money management device; and
a transmission/reception unit configured to transmit the cooperation process information to the money management device, as well as to receive take-out completion information for indicating that the money is taken out from the money management device on the basis of the cooperation process information, from the money management device,
wherein the operation unit interrupts a dispensing process, when the empty detector detects the nearly empty condition of the storing unit with the money stored therein during the dispensing process, and then restarts this dispensing process, after receiving the take-out completion information.

In these two embodiments, the cooperation process information may include a first cooperation number assigned to a money transfer process between the teller machine and the money management device,

wherein the transmission/reception unit receives a second cooperation number from the money management device, the second cooperation number inputted to the money management device by an operator based on the cooperation process information, and

wherein the transmission/reception unit transmits the cooperation process information to the money management device, in the case in which the first cooperation number is coincident with the second cooperation number.

The operation unit may update each of the money amount data on the money stored in the teller machine as well as on the money stored in the money management device, after receiving the collecting completion information or the take-out completion information.

The operation unit may update the money amount of the teller machine and the money amount of the in-hand money of the operator for the teller machine, without generating the cooperation process information, in the case in which the money stored in the storing unit is collected as the in-hand money of the operator for the teller machine.

The operation unit may update the money amount of the teller machine and the money amount of the in-hand money of the operator for the teller machine, without generating the cooperation process information, in the case in which the in-hand money of the operator for the teller machine is used for refilling the storing unit.

The money management device related to one embodiment of the present invention is connected with the teller machine so as to communicate with each other, the teller machine configured to store therein the money as well as to deposit or dispense the money,

the money management device includes:

a storing unit configured to store therein the money;
an operation unit, which is configured to generate a request signal for requesting cooperation process information from the teller machine, the cooperation process information including information on the money collected into the money management device or information on the money used for refilling the teller machine, and which is configured to generate collecting completion information for indicating that the money is collected from a storing unit into the money management device based on the cooperation process information, or to generate take-out completion information for indicating that the money is taken out form the money management device based on the cooperation process information; and
a transmission/reception unit configured to transmit the collecting completion information or take-out completion information, to the teller machine, in the case in which the money is collected into the storing unit based on the cooperation process information obtained from the teller machine, or in which the money is taken out from the storing unit based on the cooperation process information.

In this embodiment, the cooperation process information may include a first cooperation number assigned to a money transfer process between the teller machine and the money management device,

wherein the request signal includes a second cooperation number inputted to the money management device by an operator, and

wherein the money management device transmits the request signal to the teller machine, in the case in which the second cooperation number is inputted thereto, while the money management device receives the cooperation process information from the teller machine, in the case in which the first cooperation number is coincident with the second cooperation number.

The operation unit may update each of the money amount data on the money stored in the teller machine as well as on the money stored in the money management device, after transmitting the collecting completion information or take-out completion information.

### BRIEF DESCRIPTION OF THE DRAWINGS

FIG. 1 is a diagram schematically illustrating one exemplary system related to one embodiment of the present invention.

FIG. 2 is a perspective view showing external appearance of one teller machine 100.

FIG. 3 is a block diagram showing one exemplary control system of the teller machine 100.

FIG. 4 is a perspective view showing external appearance of one money management device 200.

FIG. 5 is a perspective view of a second banknote storage drawer 212 of the money management device 200.

FIG. 6 is a perspective view of a second coin storage drawer 214 of the money management device 200.

FIG. 7 is a schematic side view of a coin storage container 241 shown in FIG. 6.

FIG. 8 is a perspective view of a spare storing unit (or spare drawer) 215.

FIG. 9 is a block diagram showing one exemplary control system of a control unit 225 of the money management device 200.

FIG. 10 is one exemplary flow chart illustrating a preparation process for one deposit/dispense operation on the side of the teller machine 100 related to a first embodiment.

FIG. 11 is one exemplary flow chart illustrating another preparation process for the deposit/dispense operation performed in the money management device 200 related to the first embodiment.

FIG. 12 is a diagram schematically illustrating a general procedure for managing the money amount, according to the money management system and money management method, respectively related to one embodiment of the present invention.

FIG. 13 is a diagram illustrating one example of a display of a selection menu for displaying each money amount managed by the money management system related to one embodiment of the present invention.

FIG. 14 is a diagram illustrating one operational method that can be performed by the money management system and money management method, respectively related to one embodiment of the present invention.

FIG. 15 is a diagram schematically illustrating data transmission/reception and a procedure (or operation) for the data transmission/reception, between the teller machine 100 and the money management device 200, upon the deposit/dispense operation in the money management device 200.

FIG. 16 is a diagram schematically illustrating various flows of information processing, including the processing for the cooperation process information in the teller machine 100 and money management device 200 and performed in the money management system and money management method, respectively related to one embodiment of the present invention.

FIGS. 17A and 17B respectively illustrate examples of the content of the cooperation process information prepared and updated in the money management system and money management method, respectively related to one embodiment of the present invention.

FIG. 18 is a diagram illustrating another example of the content of the cooperation process information prepared and updated in the money management system and money management method, respectively related to one embodiment of the present invention.

FIGS. 19A through 19H respectively illustrate examples of a screen display in the money management device 200, in the case of performing a cooperation process between the teller machine 100 and the money management device 200.

FIGS. 20A through 20G respectively illustrate further examples of the screen display of the money management device 200 in the case of performing the cooperation process between the teller machine 100 and the money management device 200.

FIG. 21 is a diagram illustrating one example of the screen display for the selection menu of the money management device 200.

FIG. 22 is a diagram illustrating one example of the data content of a simplified total amount of money obtained from the money management device 200 as well as illustrating one example of the content of a transaction totalization result calculated from the cooperation process information managed by the teller machine.

FIGS. 23A through 23C respectively illustrate examples of the screen display, upon checking each unprocessed operation or process, based on an inquiry about a transaction history of the money management device 200.

FIG. 24 is a diagram schematically illustrating a procedure for the data clear process, upon the closing balance operation, in the money management system and money management method, respectively related to one embodiment of the present invention.

FIG. 25 is a diagram schematically illustrating a procedure for obtaining the electronic journal file, upon an inquiry about the electronic journal by the teller machine 100, in the money management system and money management method, respectively related to one embodiment of the present invention.

FIG. 26 is a diagram illustrating one example of the screen display of a user setting menu for changing the settings.

FIG. 27 is a diagram illustrating one example of the screen display for receiving each input of the cooperation number for specifying the cooperation process information to be subjected to status alteration.

FIGS. 28A through 28C respectively illustrate one example of the screen display of the cooperation process information and another example of the screen display for confirming the status alteration of the cooperation process information.

FIG. 29 is a flow chart illustrating one example of the deposit/dispense operation or process performed by the money management device 200 related to a second embodiment.

FIG. 30 is a diagram illustrating one screen displayed on a display section 227 of the money management device 200.

FIGS. 31A through 31C respectively illustrate the screen displayed on the display section 227 of the money management device 200.

FIGS. 32A through 32D respectively further illustrate the screen displayed on the display section 227 of the money management device 200.

FIG. 33 is a diagram illustrating process data in the money management device 200, displayed on the display section 227.

FIG. 34 is a diagram illustrating the content of a process cue displayed on the display section 227.

FIGS. 35A and 35B respectively illustrate the screen displayed on a display section 15a of the teller machine 100, after this machine 100 receives the process cue.

FIGS. 36A and 36B respectively illustrate the screen displayed on a display section 15a of the teller machine 100, after this machine 100 receives the process cue.

FIG. 37 is a diagram schematically illustrating a general procedure for the refill process from the stock to the money management device 200.

FIG. 38 is a diagram illustrating the screen displayed, following FIG. 31C, on the display section 227 of the money management section 200, upon a collecting process.

FIG. 39 is a diagram illustrating the content of the process data of the money management device 200 upon the collecting process.

FIGS. 40A and 40B respectively illustrate the screen displayed on the display section 15a of the teller machine 100, after this machine 100 receives the process cue.

FIGS. 41A and 41B respectively illustrate the screen displayed on the display section 15a of the teller machine 100, after this machine 100 receives the process cue.

FIG. 42 is a diagram schematically illustrating a general procedure for the collecting process from the money management device 200 to the stock.

FIG. 43 is a diagram illustrating the screen displayed, following FIG. 31C, on the display section 227 of the money management section 200, upon the storage process.

FIG. 44 is a diagram illustrating the content of the process data of the money management device 200 upon the storage process.

FIGS. 45A and 45B respectively illustrate the screen displayed on the display section 15a of the teller machine 100, after this machine 100 receives the process cue.

FIG. 46 is a diagram schematically illustrating a general procedure for the storage process for storing the money into the money management device 200.

FIGS. 47A through 47D respectively illustrate the screen displayed, following FIG. 31C, on the display section 227 of the money management section 200, upon the take-out process.

FIG. 48 is a diagram illustrating the content of the process data of the money management device 200 upon the take-out process.

FIGS. 49A and 49B respectively illustrate the screen displayed on the display section 15a of the teller machine 100, after this machine 100 receives the process cue.

FIG. 50 is a diagram schematically illustrating a general procedure for the take-out process for taking out the money from the money management device 200.

FIG. 51 is a cross section illustrating one exemplary construction of a bundled-banknote handling unit P1 related to a third embodiment of the present invention.

FIG. 52 is a flow chart illustrating an interrupt collecting process in the case in which any one of the storing units becomes full up with the money during the depositing operation or process for depositing the money into the teller machine 100.

FIG. 53 is a diagram schematically illustrating a collecting process cue (i.e., the cooperation process information).

FIG. 54 is a flow chart illustrating an interrupt refill process in the case in which any one of the storing units becomes empty during the dispensing operation or process for dispensing the money from the teller machine 100.

FIG. 55 is a flow chart illustrating the whole collecting process related to a fourth embodiment.

FIG. 56 is a diagram schematically illustrating one example of a bill of the whole collecting process.

FIG. 57 is a flow chart illustrating the data clear process in a fifth embodiment.

### DETAILED DESCRIPTION OF THE INVENTION

Hereinafter, several embodiments of the present invention will be described, with reference to the drawings. It is noted that such embodiments are not in any way intended to limit this invention, respectively.

### (Construction Common to all Embodiments)

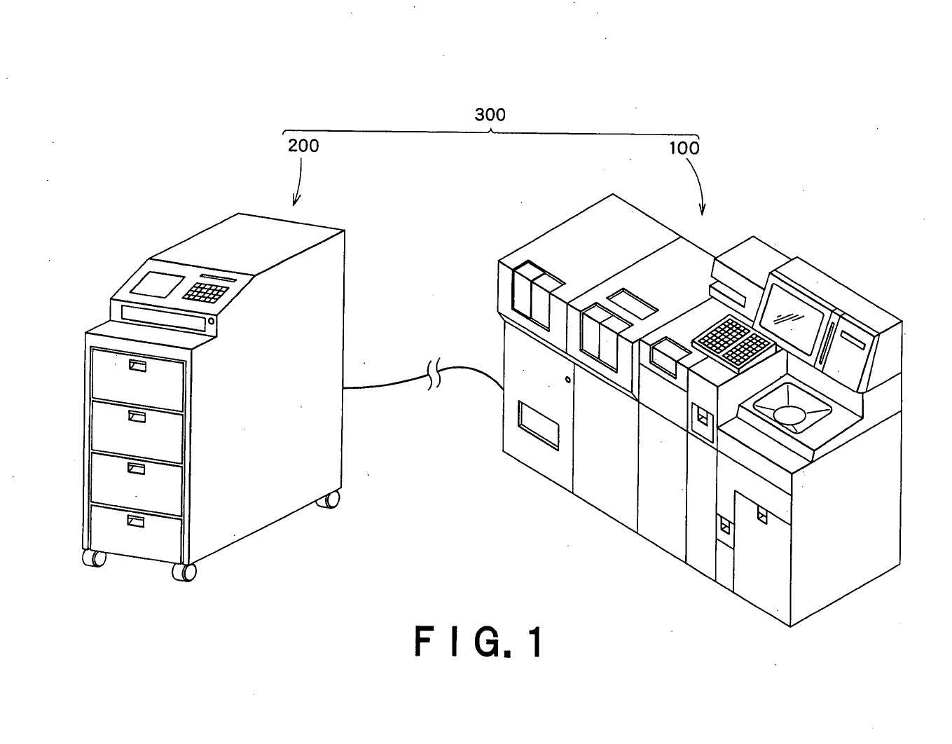

FIG. 1 schematically illustrates one exemplary system related to one embodiment of the present invention. The money management system (or money handling system) 300 includes the teller machine 100 and money management device 200 (also referred to as a “cash bus”), respectively connected to each other so as to be able to communicate with each other. In this case, the teller machine 100 serves as the money management main body (or money handling main body), while the money management device 200 serves as the money management terminal (or money handling terminal). Further, in this case, the teller machine 100 may be referred to as a “host or higher-ranking money management device (or money handling machine),” while the money management device 200 may be referred to as a “sub- or lower-ranking money management device (or money handling machine).” Additionally, a plurality of money management devices 200 may be provided to one teller machine 100, while being respectively connected, by communication, thereto. The communication between the teller machine 100 and the money management device 200 may be either of the wired communication or wireless communication.

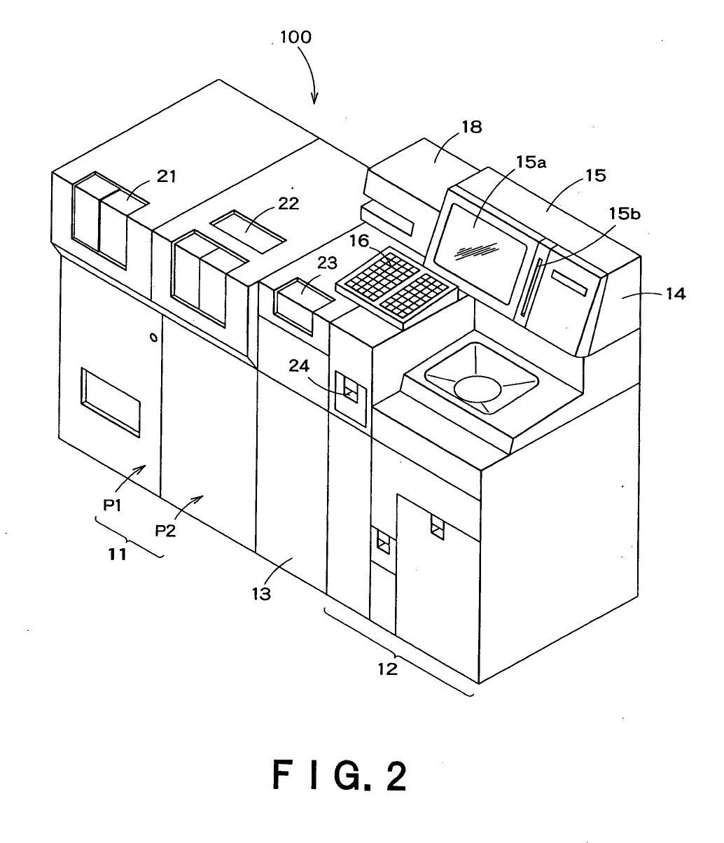

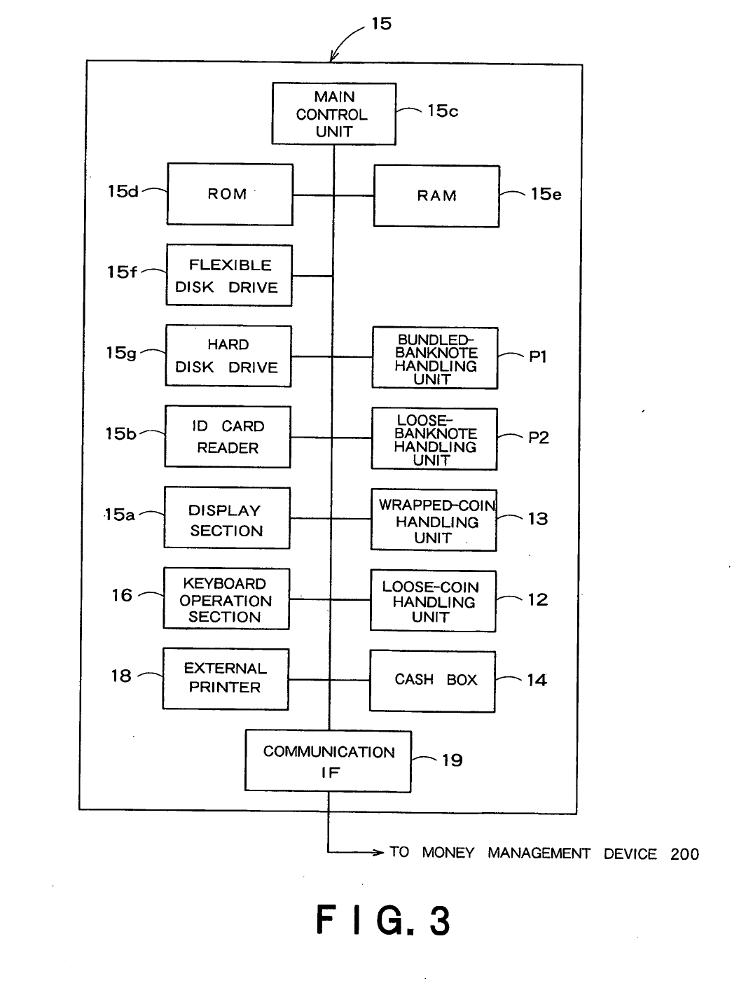

The perspective view of FIG. 2 shows the external appearance of the teller machine 100. The block diagram of FIG. 3 shows one exemplary control system (or functional system) of this teller machine 100.

As shown in FIG. 2, the teller machine 100 includes a banknote handling machine 11 including the bundled-banknote handling unit P1 adapted for handling bundled banknotes (or banknote bundles) and a loose-banknote handling unit P2 adapted for handling loose banknotes, a loose-coin handling unit 12 adapted for handling loose coins, and a wrapped-coin handling unit 13 adapted for handling wrapped coins. In FIG. 2, reference numeral 21 denotes a bundled-banknote outlet provided for dispensing the bundled banknotes, 22 denotes a loose-banknote outlet provided for dispensing the loose banknotes, 23 denotes a wrapped-coin outlet provided for dispensing the wrapped coins, and 24 denotes a loose-coin outlet provided for dispensing the loose coins.

Further, the teller machine 100 includes a stock box 14 provided for depositing stocks, bonds and the like other than the cash, a control unit 15 provided for controlling the entire system of the teller machine 100, a keyboard operation section 16 provided for inputting various instructions to the control unit 15, and an external printer 18 adapted for performing a printing process in accordance with each instruction sent from the control unit 15. The external printer 18 can serve as a receipt issuing device and/or certification printer. In this embodiment, for providing operation information (or process information) to each person permitted to operate the machine or device, a four-digit number corresponding to the operation information is printed on a slip or voucher.

The control unit 15 includes a display section 15a provided as an interface relative to a usual banker and a manager, and an ID card reader 15b adapted for reading the content of each ID card carried by the usual banker and manager. While the ID card reader is used in this embodiment, the present invention is not limited to this aspect. Namely, any other suitable identification unit, such as a publicly-known face-identifying terminal, a device adapted for identifying a vein or veins of a certain finger, or the like, may be used, provided that it can be adequately applied for identifying a certain user.

Further, as shown in FIG. 3, the control unit 15 includes a ROM 15d storing therein various programs and data, a RAM 15e that can serve as a loading area for each program and/or work area upon executing the program, a flexible disk drive 15f adapted for reading and writing data relative to each flexible disk, a hard disk drive 15g provided for storing therein the various programs and data, and a CPU 15c provided for controlling the entire system of the teller machine 100, such as by executing each program stored in the ROM 15d and/or hard disk drive 15g.

In addition, as shown in FIG. 3, the teller machine 100 includes a communication interface (or communication IF) 19 provided for data communication between the teller machine 100 and the money management device 200. With this configuration, the teller machine 100 (or money management main body) and money management device 200 (or money management terminal) can be communicated with each other. For instance, the teller machine 100 and money management device 200 are connected, by communication, with each other, via a wireless LAN, optical LAN or the like.

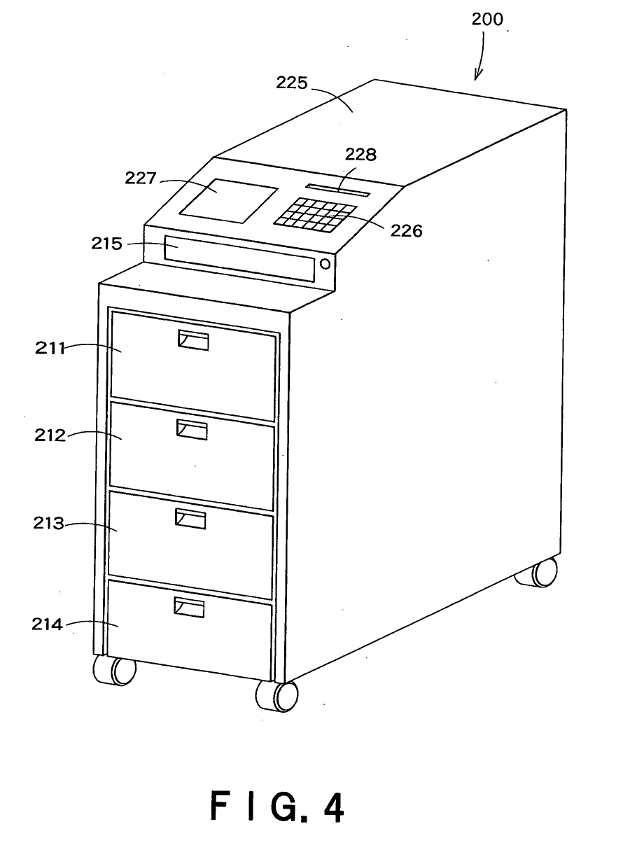

The perspective view of FIG. 4 shows the external appearance of the money management device 200. For instance, as shown in FIG. 4, this money management device 200 includes a first banknote storage drawer 211 provided for storing therein 10,000-yen banknotes, the second banknote storage drawer 212 provided for storing therein the banknotes of the other denominations, a first coin storage drawer 213 provided for storing therein 100-yen coins, 10-yen coins and 1-yen coins, the second coin storage drawer 214 provided for storing therein 500-yen coins, 50-yen coins and 5-yen coins, and the spare storage drawer 215 provided for depositing and storing therein the stocks, bonds and the like other than the cash

Further, this money management device 200 includes the control unit 225 provided for controlling the entire system of the money management device 200, a keyboard operation section 226 provided for inputting the various instructions to the control unit 225, a display section 227 that can serve as an interface relative to the user (e.g., the person in charge of handling the money (usually the banker) and the manager), and an ID card reader 228 adapted for reading the content of each ID card carried by the user that deposits and/or dispenses the money relative to each storing unit.

The content of the ID card, i.e., ID information stored in the ID card, is one aspect of information on the user, while the ID card reader 228 is one aspect of a user-information acquisition unit. While a contact type ID card reader 228 is employed in the example shown in FIG. 4, a non-contact type ID card reader may also be used. In place of using the ID card reader, as is similar to the case of the teller machine 100, any other suitable equipment, such as the face-identifying terminal, device adapted for identifying the vein or veins of a certain finger or the like, may be used.

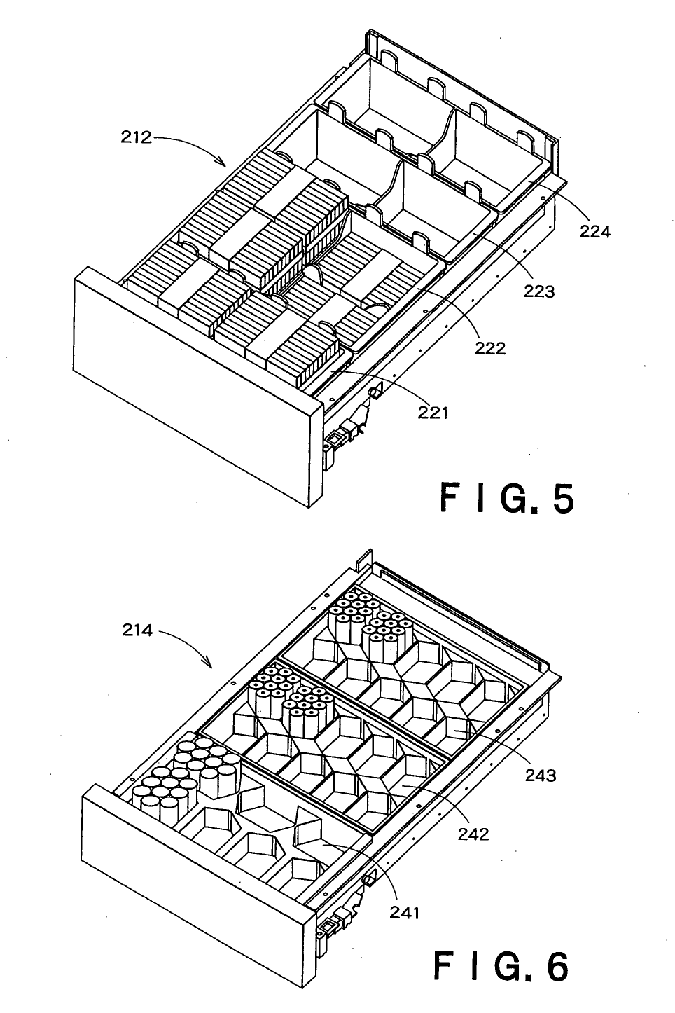

The perspective view of FIG. 5 shows the second banknote storage drawer 212 of the money management device 200. As shown in FIG. 5, several batches of the banknote bundles of three kinds of denominations of money are stored and arranged, in accordance with a certain rule, in the second banknote storage drawer 212. In this example shown in FIG. 5, four banknote storage containers 221 to 224 are arranged in the second banknote storage drawer 212, while the denomination of money of the banknotes to be stored is determined for each container. In this case, several batches of large banknote bundles, each of which is formed of ten batches of the banknote bundles respectively formed of 100 banknotes, may be stored and arranged in each storage container.

The perspective view of FIG. 6 shows the second coin storage drawer 214 of the money management device 200. As shown in FIG. 6, a plurality of wrapped coins or coin rolls of three kinds of denominations of money are stored and arranged, in accordance with a certain rule, in the second coin storage drawer 214. In this example shown in FIG. 6, three coin storage containers 241 to 243 are arranged in the second coin storage drawer 214, while the denomination of money of the coins to be stored is determined for each container.

As a means for measuring the weight of the coins stored in the coin storage container 241, a load cell 261 is provided to a bottom face of the coin storage container 241. Since the load cell is well known to the public, the construction of this load cell 261 is not further described herein. In this embodiment, the load cell 261 is also provided to each of the other coin storage containers 242, 243, as well as provided to each of the banknote storage containers 221 to 224, in the same manner as described above. With this configuration, the weight of the money stored in the respective containers can be measured, for each denomination thereof.

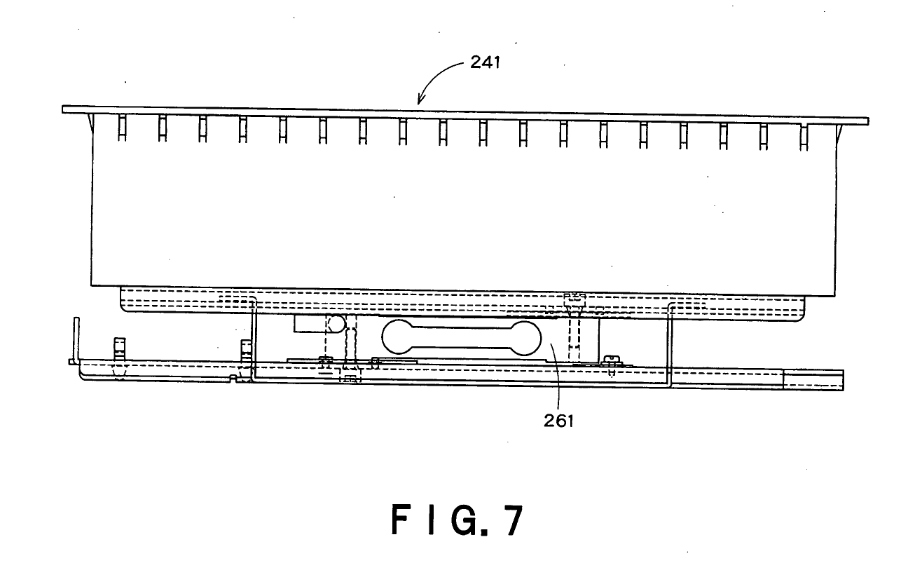

The side view of FIG. 7 schematically illustrates the coin storage container 241 shown in FIG. 6. As shown in FIG. 7, the load cell 261 is provided to the bottom face of the coin storage container 241, as the means for measuring the weight of the coins stored in this coin storage container 241. As described above, since well known to the public, the construction of this load cell 261 is not further discussed herein. Again, as described above, the load cell is also provided to each of the other coin storage containers 242, 243, as well as provided to each of the banknote storage containers 221 to 224, in the same manner as described above. With this configuration, the weight of the money stored in the respective containers can be measured, for each denomination thereof.

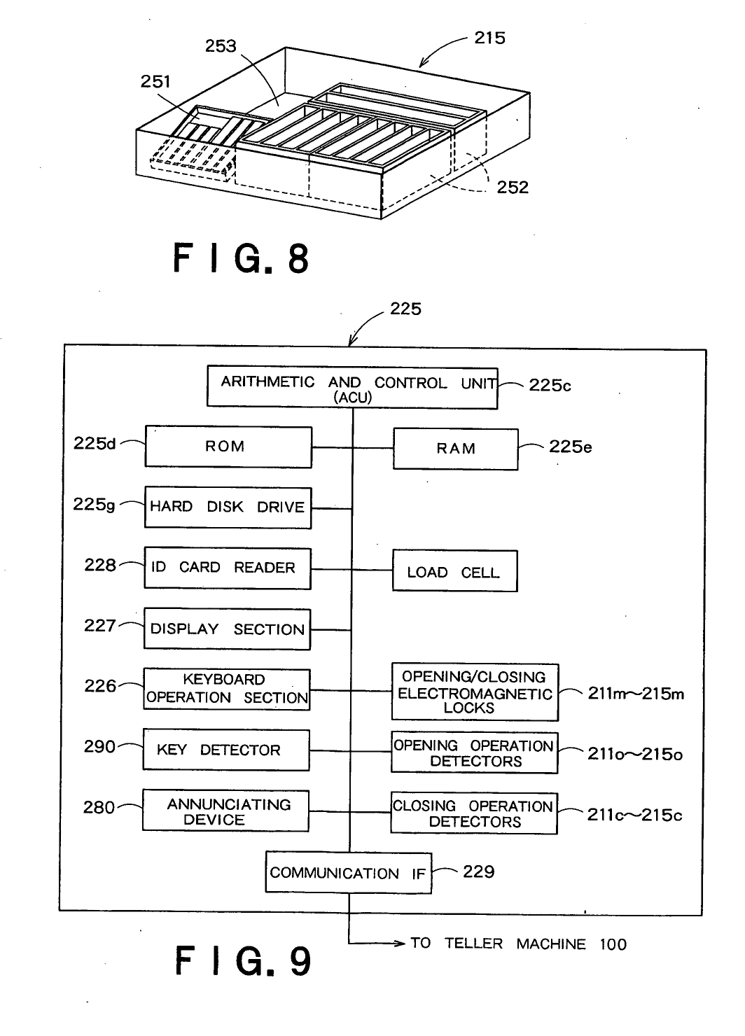

The perspective view of FIG. 8 is provided for showing the spare storing unit (or spare drawer) 215. As shown in FIG. 8, this spare storing unit includes a coin spare storage part 251 and a banknote spare storage part 252, together with an opened space 253 provided for allowing the stocks, bonds and the like other than the cash to be deposited therein.

The block diagram of FIG. 9 illustrates the control system (or functional system) of the control unit 225 of the money management device 200. This control unit 225 includes a ROM 225d storing therein the various programs and data, a RAM 225e that can serve as the loading area for each program and/or work area upon executing the program, a hard disk drive 225g provided for storing therein the various programs and data, and an arithmetic and control unit 225c provided for controlling the entire system of the money management device 200, such as by executing each program stored in the ROM 225d and/or hard disk drive 225g.

The arithmetic and control unit 225c (or operation unit) is connected with each load cell 261 (or weight measuring unit) provided for each corresponding denomination of money. As such, this unit 225c can calculate the amount of money corresponding to the weight of the money stored in each storage container, based on the output of each corresponding load cell 261. Meanwhile, the hard disk drive 225g can serve to store therein information on the transaction and information on the condition of the stock, respectively inputted thereto. Further, this hard disk drive 225g (or memory) can serve to store therein the amount of money calculated by the arithmetic and control unit 225c.

In this embodiment, the ID information (or user information) read by the ID card reader 228 is also stored in the hard disk drive 225g, in a manner corresponding to the calculated amount of money (i.e., the amount of money stored after the deposit/dispense operation).

In this embodiment, a keyboard operation section 226 (or input unit) is provided for inputting the amount of money to be deposited or dispensed relative to each storing unit. Thus, the arithmetic and control unit 225c can reconcile the amount of money calculated from the output of each load cell 261 and the amount of money inputted via the keyboard operation section 226.

Further, as shown in FIG. 9, the money management device 200 includes a communication interface (or communication IF) 229 provided for the data communication between the teller machine 100 and the money management device 200. With this configuration, the money management device 200 (or money management terminal) and teller machine 100 (or money management main body) can be communicated with each other.

Additionally, in this embodiment, the control unit 225 is connected with opening/closing electromagnetic locks 211m to 215m, each provided, as a lock control unit, to each corresponding drawer 211 to 215, such that each drawer 211 to 215 can be switched between an opened state for enabling the deposit/dispense operation for the money and a locked state for preventing the deposit/dispense operation.

In this embodiment, a user matching is provided, as the condition for this switching control. For instance, the ID information (or user information) of the user permitted to control this switching operation is set and stored, in advance, in the hard disk drive 225g. Thereafter, the ID information read by the card reader 228 (or user-information acquisition unit) is compared with the ID information of this permitted person stored in the hard disk drive 225g, by the arithmetic and control unit 225c. Then, only in the case in which the result of this comparison is “Yes”, i.e., only in the case in which the ID information read by the ID card reader 228 corresponds to the ID information set in advance for the permitted user, the control unit 225 controls each of the opening/closing electromagnetic locks 211m to 215m to be brought into the opened state for enabling the storage/take-out process for the money.

In addition to the user matching performed as the above switching control, a matching on the cooperation information may also be employed. While the “cooperation information” usually means the operation information that is set for each deposit/dispense operation and is used as the data on the denomination and quantity of the deposited/dispensed money, it may include the data concerning the procedure of each deposit/dispense operation. For instance, in one specific embodiment of the matching of the cooperation information, the cooperation information set in advance for a permitted operation is transmitted from the teller machine 100 by using a communication function, and stored in the RAM 225e. Meanwhile one four-digit cooperation number corresponding to this cooperation information is inputted, by the user, via the keyboard operation section 226 (or cooperation-information acquisition unit). Thereafter, the inputted four-digit cooperation number is compared with the transmitted and stored cooperation information, by the arithmetic and control unit 225c provided as the operation recognition unit. Then, only in the case in which the result of this comparison is “Yes”, i.e., only in the case in which the inputted four-digit cooperation number corresponds to the transmitted and stored cooperation information on the permitted operation, the control unit 225 controls each of the opening/closing electromagnetic locks 211m to 215m to be brought into the opened state for enabling the deposit/dispense operation or process for the money. Conveniently, in this operation embodiment, each of the opening/closing electromagnetic locks 211m to 215m can be controlled, individually, for each specific deposit/dispense operation. Namely, only the drawer storing therein the money of the denomination to be deposited or dispensed can be selectively switched into the opened state. Furthermore, for preventing the plurality of drawers from being opened, inadvertently, at a time, a further control unit capable of switching each drawer into the opened state, in a preset order, may be employed.

In addition, by utilizing the configuration of this embodiment for allowing the money management device 200 (or money management terminal) and teller machine 100 (money management main body) to be communicated with each other, the following functions and/or aspects can be further implemented.

For instance, by utilizing the above communication function, the control unit 15 of the teller machine 100 (or money management main body) can serve as a money amount remote confirmation unit for confirming and/or reconciling the money amount data on the money management device 200 (or money management terminal). More specifically, the control unit 15 of the teller machine 100 (or money management main body) can serve to control the arithmetic and control unit 225c provided as a reconciling unit, via the communication interface (or communication IF) 19 and communication interface (or communication IF) 229.

Further, the control unit 15 of the teller machine 100 (or money management main body) can also serve to control each of the opening/closing electromagnetic locks 211m to 215m, via the communication interface (or communication IF) 19 and communication interface (or communication IF) 229.

More specifically, the communication interface (or communication IF) 229 can serve as an unlocking signal receiving unit adapted for receiving an unlocking signal for controlling each of the opening/closing electromagnetic locks 211m to 215m (or locking device) to be brought into the opened state. Meanwhile, the control unit 15 of the teller machine 100 (or money management main body) can serve to transmit the unlocking signal to the communication interface (or communication IF) 229, under a predetermined condition, via the communication interface (or communication IF) 19.

Thus, in the case in which each of the opening/closing electromagnetic locks 211m to 215m is controlled on the side of the teller machine 100, a specific condition for controlling such locks can be optionally set and adjusted on the side of the teller machine 100. Therefore, the management on the opening/closing operation for each drawer, i.e., the management on the deposit/dispense operation for the money, can be performed in a well centralized manner.

Preferably, each of the opening/closing electromagnetic locks 211m to 215m is configured to be automatically returned to a locked state, once this electromagnetic lock is brought into the opened state and then the opening/closing operation for the corresponding drawer is performed.

Otherwise, it is preferred that each of the opening/closing electromagnetic locks 211m to 215m is configured to be automatically returned to the locked state, after a predetermined time has passed since this electromagnetic lock was brought into the opened state.

More preferably, the communication interface (or communication IF) 229 can also serve as a locking signal receiving unit adapted for receiving a locking signal for controlling each of the opening/closing electromagnetic locks 211m to 215m (or locking unit) to be brought into the locked state. Meanwhile, the control unit 15 of the teller machine 100 (or money management main body) can serve to transmit the locking signal to the communication interface (or communication IF) 229, under some predetermined condition, via the communication interface (or communication IF) 19.

In this case, it is preferred that the money management device 200 further includes closing operation detectors 211c to 215c, each adapted for detecting the change from the opened state to the closed state of each corresponding drawer 211 to 215. With this configuration, once a detection signal is transmitted via each closing operation detector and then received by the teller machine 100, the locking signal can be transmitted from the teller machine 100. In this way, the control for locking each drawer can be managed in a more centralized manner.

Alternatively, it is preferred that each of the opening/closing electromagnetic locks 211m to 215m is configured to be automatically brought into the locked state, in the case in which this electromagnetic lock is kept in the opened state even after a preset time has passed since this lock was brought into the opened state. More preferably, the money management device 200 further includes opening operation detectors 211o to 215o, each adapted for detecting the change from the closed state to the opened state of each corresponding drawer 211 to 215.

In addition, an annunciating device (or alarm device) 280 is further provided, for outputting an alarm signal when any one of drawer 211 to 215 is kept in the opened state for a given time or longer.

Further, in FIG. 9, a key detector 290 is shown. This key detector 290 is provided as a sensor adapted for detecting the opening and closing operations of each drawer when a power source for the money management device 200 is OFF. Although such a key detector has not been so far known and/or reported at least in this field, this technique is not directly related to the main concept of this invention. Therefore, the further explanation on this key detector is omitted herein.

In the cooperation between the money management device 200 and the teller machine 100, when any one of the storing units becomes full up with the money during the depositing process for the money into the teller machine 100, this depositing process is interrupted even in the middle of the process, while the money of the full storing unit is once transferred to the money management device 200. Then, after the completion of this money transfer operation to the money management device 200, the depositing process can be restarted. Meanwhile, when any one of the storing units becomes empty during the dispensing process for the money from the teller machine 100, this dispensing process is interrupted even in the middle of the process, while the money stored in the money management device 200 is used for refilling the teller machine 100. In this manner, once the refill process with the money is completed, the dispensing process can be restarted.

As described above, in the case in which the money is transferred between the money management device 200 and the teller machine 100 during the deposit/dispense process, the data on the denomination, number and amount of money to be transferred can be respectively transmitted and received therebetween, in order to confirm whether or not the money is correctly transferred.

Now, referring to one exemplary flow chart, the operation in each embodiment of the aforementioned money management system will be described.

### First Embodiment

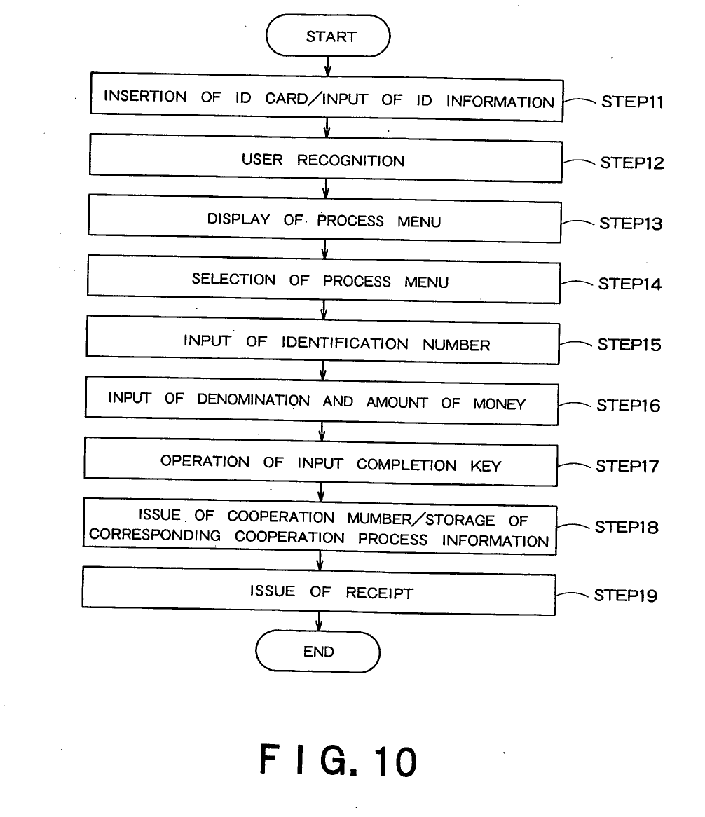

The flow chart of FIG. 10 illustrates one exemplary preparation process for one deposit/dispense operation performed on the side of the teller machine 100. First of all, the ID information of the operator for the teller machine 100 is read by the ID card reader 15b (Step 11). Then, whether or not the operator is permitted to operate the teller machine 100 is checked (Step 12).

As a result, if the operator is recognized as the permitted operator, one operation menu for the teller machine 100 is displayed on the display unit 15a (Step 13). Then, the operator (i.e., the permitted operator) inputs desired process content by using the keyboard operation section 16, while watching the display (Step 14). In this example, the operator selects a cooperation take-out/storage process. Additionally, in this example, input of an identification number is requested for further enhancing the security (Step 15).

After matching of the identification number, the operator (i.e., the permitted operator) inputs details of the deposit/dispense operation by using the keyboard operation section 16 (Step 16). More specifically, the data on the denomination and number of bundles or coin rolls of the money to be deposited or dispensed is inputted. Thereafter, with the operation of an input completion key by the operator, the completion of this input operation is detected (Step 17). Then, the teller machine 100 prepares the cooperation process information (also referred herein as to the “cooperation process cue”), as the operation information including the inputted details of the deposit/dispense operation, and issues the cooperation number (also referred herein as to the “operation number”), as a part of the cooperation process information. Subsequently, the teller machine 100 operates the hard disk 15g to store therein the cooperation process information including the cooperation number and detailed content of an actual deposit/dispense operation corresponding to the cooperation number. Further, if the deposit/dispense operation of this cooperation process information includes the deposit/dispense operation to be performed in the money management device (or cash management device) 200, and if the person in charge of handling the money is authorized to operate the cash management device 200, the teller machine 100 transmits a process open request signal (that will be described later) to the cash management device 200 via a communication line. Thus, in the cash management device 200, the screen for inputting the operation can be skipped up to the screen for inputting the cooperation number. In this case, the cooperation process information is not transmitted to the cash management device 200 (Step 18). Then, the receipt issuing device 18 outputs or prints the certification print including the cooperation number onto the receipt or transaction slip, and then issues the so-printed receipt or transaction slip (Step 19).

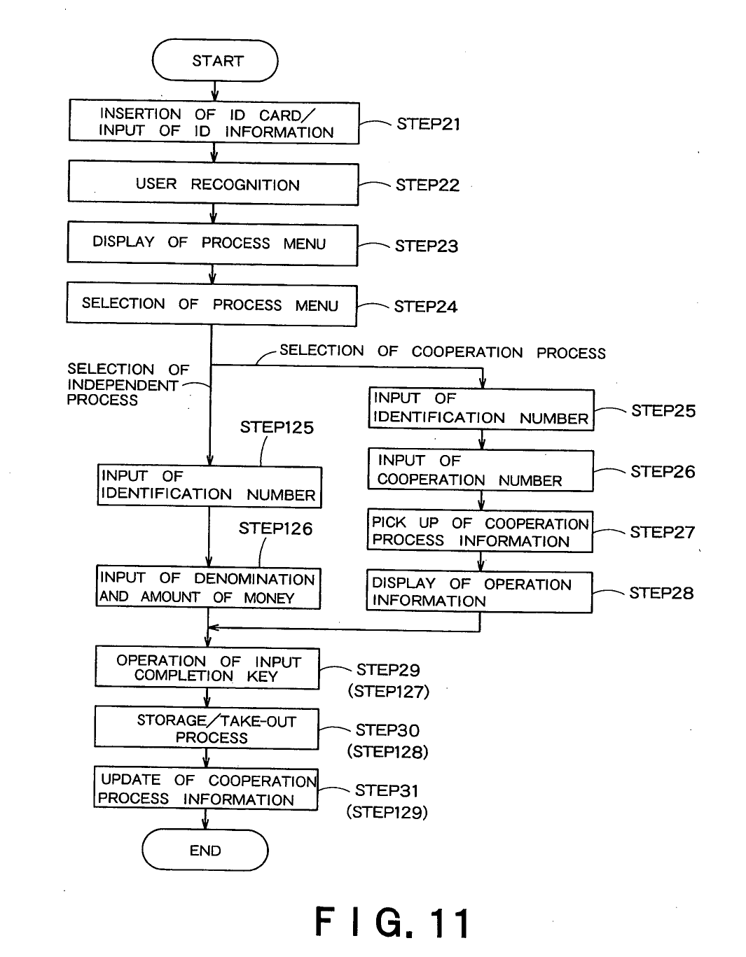

The flow chart of FIG. 11 illustrates another exemplary preparation process for the deposit/dispense operation performed in the money management device 200 First of all, the ID information of the operator for the money management device 200 is read by the ID card reader 228 (Step 21). Then, based on this ID information, whether or not the operator is permitted to operate the money management device 200 is checked (Step 22).

If the operator is the permitted operator, the operation menu for the cash management device 200 is displayed on the display unit 227 (Step 23). Then, the operator (i.e., the permitted operator) inputs the process content via the keyboard operation section 226, while watching the display.

First, the case in which the cooperation process with the teller machine 100 is selected will be described.

In this example, once the cooperation process is selected, the input of the identification number is requested for further enhancing the security (Step 25).

After matching of the identification number, the operator (i.e., the permitted operator) inputs the cooperation number issued from the teller machine 100, by using the keyboard operation section 226 (Step 26).

In this case, each cooperation number is issued, on condition that the inputted ID information of the operator is duly recognized by the teller machine 100 as well as the identification number is correctly inputted. However, in other embodiments, if the operator for the teller machine 100 is also authorized to operate the cash management device 200, only the input of the cooperation number may be requested, with the request for inputting the ID information and identification number being omitted.

In response to the input of the cooperation number, the cash management device 200 makes an inquiry to the teller machine 100. Then, the teller machine 100 searches the cooperation process information, based on the cooperation number, and picks up the detailed information on the take-out/storage operation, i.e., the content of the cooperation process information corresponding to the cooperation number (including the data on the denomination and amount of money to be taken out or stored as well as the data on the opening/closing procedure for each drawer), and thereafter transmits the so-picked-up information to the money management device 200 (Step 27). Then, the cash management device 200 displays a part or all of this information, for confirmation of the operator (Step 28). Once confirmed, the operator can operate the input completion key. In this way, the completion of the preparation for the take-out/storage operation is detected (Step 29).

Thereafter, the storage process or take-out process for the money is performed, based on the details of the take-out/storage operation included in the cooperation process information (Step 30). Then, with input of a signal indicative of the completion of this process from the keyboard operation section 226, the cooperation process information is updated, and the update of this cooperation process information is stored in the hard disk 225g (Step 31). Further, the so-updated cooperation process information is transmitted to the teller machine 100, via the communication line. Thus, the cooperation process information that is already processed can also be updated in the teller machine 100.

Next, the case in which an independent process in the cash management device 200, i.e., a local process in this device 200, not based on the cooperation process information received in advance from the teller machine 100, is selected will be described.

In this example, once this independent or local process is selected, the input of the identification number is requested for further enhancing the security (Step 125). Since the independent process of the cash management device 200 is not based on the cooperation process information received in advance from the teller machine 100, the cooperation process information corresponding to this process is not prepared. Accordingly, unlike the case of the cooperation process based on the cooperation process information received from the teller machine 100, the request for the input of the ID information and identification number cannot be omitted.

Thus, after matching of the identification number, the operator (i.e., the permitted operator) inputs the details of the take-out/storage operation by using the keyboard operation section 22 (Step 126). More specifically, the data on the denomination and number of bundles or coin rolls of the money to be taken out or stored is inputted. Thereafter, with the operation of the input completion key by the operator, the completion of this input operation is detected (Step 127).

Then, the cash management device 200 prepares local process information (also referred herein as to the “local process cue”), as the process information including the inputted details of the take-out/storage operation, and issues a local process number, as a part of the so-prepared local process information, corresponding to this local process information. Subsequently, the cash management device 200 operates the hard disk 225g to store therein the local process information including the local process number and detailed content of an actual take-out/storage operation corresponding to the local process number. Thereafter, the cash management device 200 transmits this local process information to the teller machine 100, via the communication line. At this time, if the communication line is disconnected, the local process information can be temporarily stored in the money management device 200, and then transmitted to the teller machine 100 after the communication line is connected again. Of course, before this transmission of the local process information on the independent process in the cash management device 200, the teller machine 100 has no information on this independent process. Therefore, all of such local information on the independent process will be transmitted, without exception, to the teller machine 100.

Thereafter, the storage process or take-out process for the money is performed, based on the details of the take-out/storage operation included in the local process information (Step 128). In this case, when a signal indicative of the completion of this process is inputted from the keyboard operation section 226, the local process information is updated, and the so-updated local process information is stored in the hard disk 225g (Step 129). Further, the so-updated local process information is transmitted to the teller machine 100, via the communication line. As such, the local process information already stored in the teller machine 100 can also be updated. Similar to the above case, if the communication line is disconnected, the local process information can be temporarily stored in the money management device 200, and then transmitted to the teller machine 100 after the communication line is connected again. Alternatively, if the local process information cannot be transmitted to the teller machine 100 upon the preparation thereof and remains untransmitted, only the so-updated local process information may be transmitted to the teller machine 100 after the completion of the corresponding take-out/storage operation.

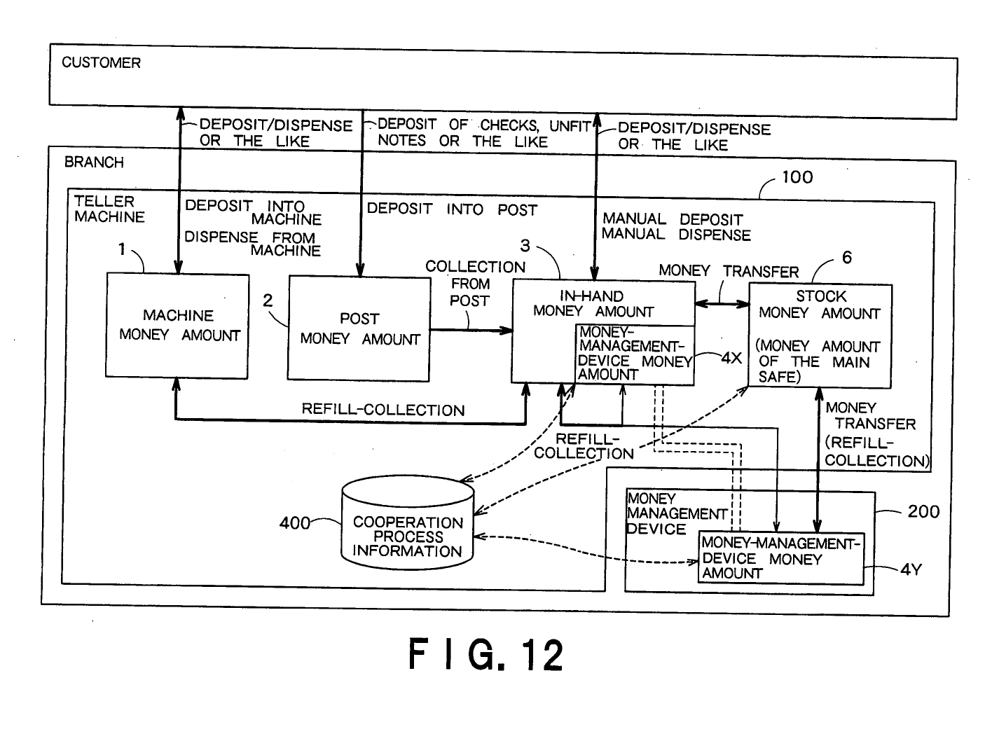

FIG. 12 schematically illustrates one procedure for managing the money amount, according to the money management system and money management method, respectively related to one embodiment of the present invention.

The money management system related to this embodiment of the present invention includes the teller machine 100 and money management device 200, respectively provided to be optionally communicated with each other. For instance, the teller machine 100 and money management device 200 may be always connected with each other, via the wireless LAN or optical LAN, or otherwise may be intermittently connected with each other, via a suitable cable, such as a wired LAN or the like. In the case in which the teller machine 100 and money management device 200 are intermittently connected with each other, the connection between the two devices can be optionally and physically shut off. Accordingly, in this case, the money management device 200 can be optionally moved to be used in any suitable place in the branch of the financial institution. Further, in the case of the connection via the wireless LAN, the money management device 200 can be moved to be used in any suitable place in the branch of the financial institution, while being always connected with the teller machine 100. However, if required, the money management device 200 can manage, independently or solely, the money amount.

Basically, in the money management system and money management method, respectively related to one embodiment of the present invention, the whole management of the money amount in the branch of the financial institution is performed by the teller machine 100. The money amount managed by the teller machine 100 includes the stock money amount 6, machine money amount 1 and in-hand money amount 3, as well as a post money amount 2.

The stock money amount 6 refers to the total amount of money stored in the main safe in the branch of the financial institution. The machine money amount 1 refers to the total amount of money stored in the teller machine 100. The post money amount 2 refers to the total amount of money or the like paper sheets deposited in a post of the teller machine 100, i.e., the aforementioned stock box 14. The money or the like paper sheets related to this post money amount includes the stocks and bonds, such as checks or the like, and unfit banknotes, such as torn or stained banknotes that cannot be dispensed. The in-hand money amount 3 refers to the total amount of money that is manually managed, while being temporarily taken out from the main safe or teller machine 100 during the money transfer process for the funds. In this case, however, the money-management-device money amount 4 (4X, 4Y), i.e., the total amount of money that is stored in the money management device 200, while being allowed to be transferred from this device 200, is also managed, as a part of the in-hand money amount. More specifically, in this money-management-device money amount 4 (4X, 4Y), the money amount 4X is managed, as a part 4X of the in-hand money amount 3 in the teller machine 100, while the money amount 4Y is managed as the money-management-device money amount in the money management device 200 itself. This money-management-device money amount 4Y is optionally inquired about by the teller machine 100. Further, in this case, the money-management-device money amount 4X and money-management-device money amount 4Y are respectively managed to be coincident with each other, by updating the data on both of such money amounts, through the transmission and reception of the cooperation process information between the teller machine 100 and the money management device 200.

The cooperation process information is stored in a process information management database 400 of the teller machine 100, and is optionally updated as needed. Further, the process information management database 400 is stored in, for example, the hard disk drive 15g of the teller machine 100.

In the case in which one deposit/dispense process is performed with a certain customer, this deposit/dispense process is performed by using the money included in the machine money amount or in-hand money amount. For instance, in the case in which the banker deposits the cash received from the customer into the teller machine, the amount of this deposited money is added to the machine money amount. Meanwhile, in the case in which the banker deposits the cash into the money management device, the amount of this deposited money is added to the money-management-device money amount managed as the part of the in-hand money amount. Further, in the case in which the stocks and bonds, such as the checks or the like, are deposited from the customer, and/or in the case in which the unfit banknotes are included in the deposited money, such stocks, bonds and unfit banknotes are deposited into the post, and then managed, as the post money amount. However, once such stocks, bonds and unit banknotes are collected from the post of the teller machine 100, the resultant post money amount will be managed as the part of the in-hand money amount.

When the amount of money stored in the teller machine 100 is less than required, the money will be taken out from the main safe in order to refill the teller machine 100 with the money. Meanwhile, when the amount of money is too much to be all stored in the casher machine 100, such money will be once collected from the teller machine 100 and stored in the main safe. Upon such a money transfer process, the money (or funds) is temporarily managed, as the in-hand money amount.

Meanwhile, when the money stored in the money management device 200 is less than required, the money will be taken out from the main safe in order to supplement the money management device 200 with the money. Or otherwise, when the amount of money is too much to be all stored in the money management device 200, such money will be once collected from the money management device 200 and stored in the main safe, or otherwise managed, at hand, by the person in charge of handling the money, as the in-hand money amount.

For all of the money transfer operations, the money amount is managed by the teller machine 100. Especially, in the case in which the deposit/dispense process or operation, including the storage and take-out processes for the money, is performed in the money management device 200, the cooperation process information, to which the cooperation number is assigned, is prepared by the teller machine 100. Then, the so-prepared cooperation process information is transmitted from the teller machine 100 to the money management device 200, before the take-out/storage operation is performed in the money management device 200. Further, update information on this cooperation process information is transmitted from the money management device 200 to the teller machine 100, after the take-out/storage operation is performed. Thus, the cooperation process information can be matched between the teller machine 100 and the money management device 200, thereby keeping the accurate management on the money amount.

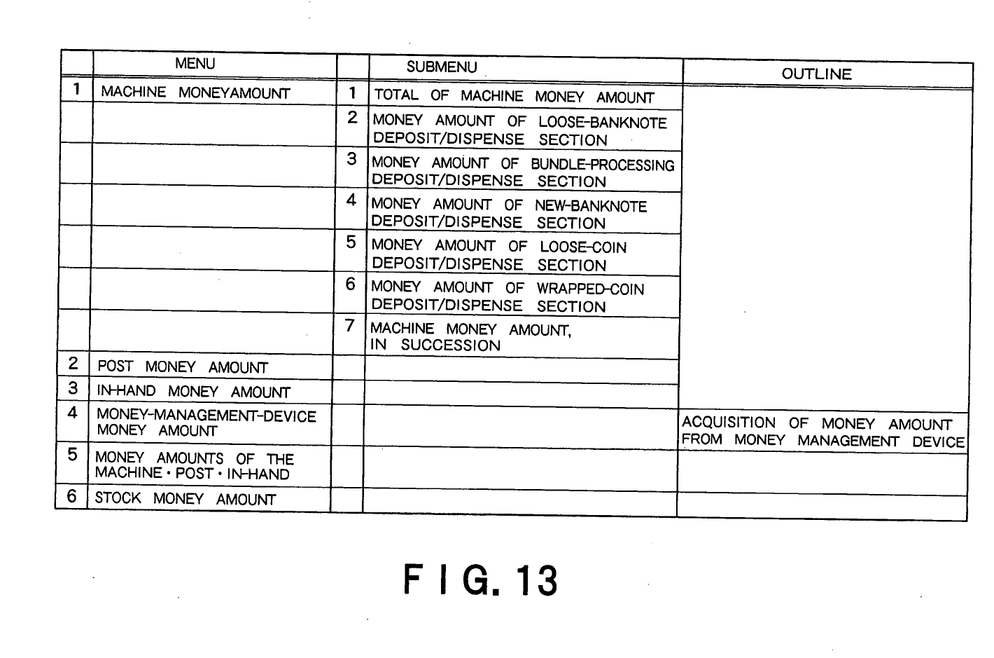

FIG. 13 illustrates one example of the display of the selection menu for displaying each money amount managed by the money management system related to one embodiment of the present invention.

In the menu shown in FIG. 13, “1 Machine money amount”, “2 Post money amount”, “3 In-hand money amount”, “4 Money-management-device money amount”, “5 Machine•post•in-hand money amount”, and “6 Stock money amount” are included, respectively.

The “5 Machine•post•in-hand money amount” designates the total amount of money of the machine money amount, post money amount and in-hand money amount. Each of the machine money amount 1, post money amount 2, in-hand money amount 3, money-management-device money amount 4 and stock money amount 6 is defined as described above.

In a submenu shown in FIG. 13, “1 Total of the machine money amount”, “2 Loose-banknote-deposit/dispense-section money amount”, “3 Bundle-processing-and-dispensing-section money amount”, “4 New-banknote-dispensing-section money amount”, “5 Loose-coin-deposit/dispense-section money amount”, “6 Wrapped-coin-dispensing-section money amount”, and “7 Machine money amount in succession” are included, respectively, as details of the machine money amount 1.

The “1 Total of the machine money amount” designates the total amount of money of the “2 Loose-banknote-deposit/dispense-section money amount”, “3 Bundle-processing-and-dispensing-section money amount”, “4 New-banknote-dispensing-section money amount”, “5 Loose-coin-deposit/dispense-section money amount” and “6 Wrapped-coin-dispensing-section money amount”, and has the same meaning as the “1 Machine money amount” in the menu.

The “2 Loose-banknote-deposit/dispense-section money amount” is the money amount of a loose-banknote deposit/dispense section (or loose-banknote handling unit) 11-P2 located in a banknote deposit/dispense processing machine constituting one part of the teller machine 100. The “3 Bundle-processing-and-dispensing-section money amount” is the money amount of a bundle-processing-and-dispensing section (or bundled-banknote handling unit) 11-P1 located in the banknote deposit/dispense and processing machine constituting one part of the teller machine 100. More specifically, this bundle-processing-and-dispensing section 11-P1 is provided for processing and bundling each batch of one hundred banknotes into one batch of the banknote bundle and then dispensing the so-bundled banknotes. The “4 New-banknote-dispensing-section money amount” is the money amount of a new-banknote-dispensing section located in the banknote deposit/dispense and processing machine constituting one part of the teller machine 100. More specifically, this new-banknote-dispensing section is provided for dispensing only the new banknotes, depending on the demand of each customer.

The “5 Loose-coin-deposit/dispense-section money amount” is the money amount of the loose-coin deposit/dispense section (or loose-coin handling unit) 12 located in a coin deposit/dispense and processing machine constituting another part of the teller machine 100. The “6 Wrapped-coin-dispensing-section money amount” is the money amount of the wrapped-coin dispensing section (or wrapped-coin handling unit) 13 located in the coin deposit/dispense and processing machine constituting another part of the teller machine 100. More specifically, this wrapped-coin dispensing section is provided for wrapping fifty coins into one coin roll and dispensing the so-wrapped coins.

The “7 Machine money amount in succession” is one item of the submenu provided for displaying the “2 Loose-banknote-deposit/dispense-section money amount”, “3 Bundle-arrangement-dispensing-section money amount”, “4 New-banknote-dispensing-section money amount”, “5 Loose-coin-deposit/dispense-section money amount” and “6 Wrapped-coin-dispensing-section money amount”, individually, in succession.

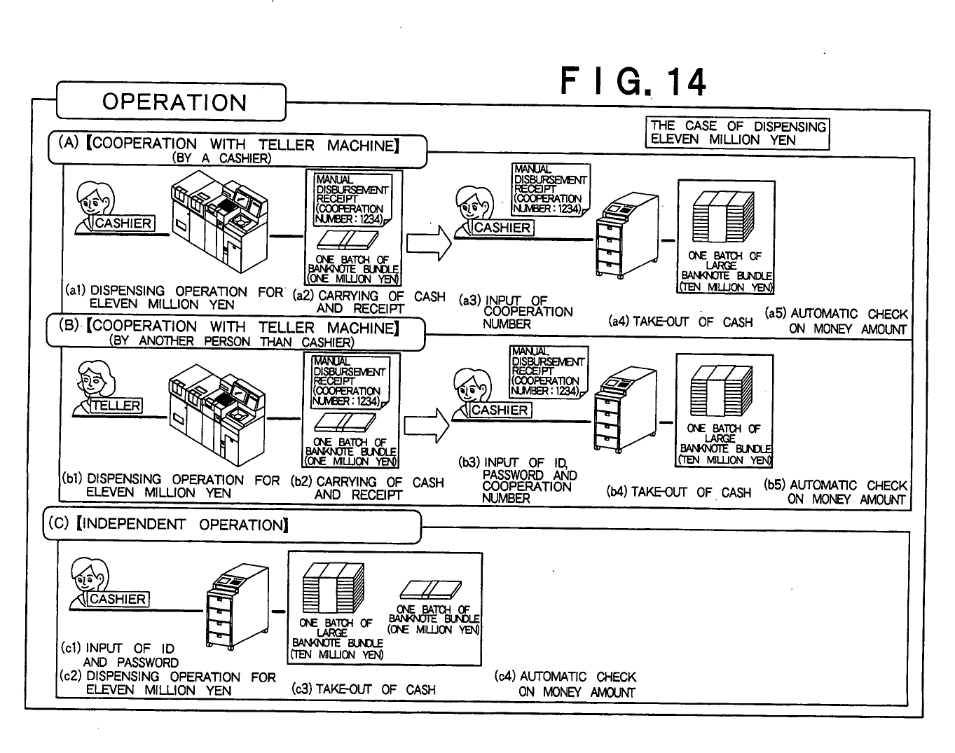

FIG. 14 illustrates one exemplary operational method that can be performed by the money management system and money management method, respectively related to one embodiment of the present invention.

First of all, the terms “person in charge of accounts (or cashier)” and “teller” will be explained. The “person in charge of accounts (or cashier)” refers to a person having a higher-ranking authority that is authorized to carry out all of the deposit/dispense operations using both of the teller machine 100 and money management device 200, respectively constituting the money management system related to one embodiment of this invention. Meanwhile, the “teller” refers to a person (or usual banker) in charge of directly dealing with the customer at a counter or the like place in the branch of the financial institution, and serves as a banker having a lower-ranking authority that is authorized to carry out the deposit/dispense operation for handling the money equal to or less than a preset limit amount thereof by using the teller machine 100.

Irrespectively of the difference in the limit amount of money accepted in each deposit/dispense operation, any of the “person in charge of accounts (or cashier)” and “teller” should have specific ID information and identification number or password, respectively registered at both of the teller machine 100 and money management device 200, in order to operate them.

FIG. 14(A) shows one case, in which a take-out operation (or process) for a total of eleven million yen (in this case, one million yen is taken out from the teller machine 100 and ten million yen is taken out from the money management device 200) is carried out by the same cashier.

First, the cashier (i.e., the person in charge of accounts) inputs the specific ID information and identification number or password to the teller machine 100. Thereafter, this cashier inputs thereto an instruction for “the take-out operation for taking out the total of eleven million yen, wherein one million yen is taken out from the teller machine 100 and ten million yen is taken out from the money management device 200”. Then, the cooperation process information on this take-out operation is prepared, while the cooperation number is assigned to this cooperation process information. Thereafter, this cooperation process information is stored, together with the cooperation number, in the hard disk drive 15g of the teller machine 100. Further, in response to the inquiry from the money management device 200, the cooperation process information is also transmitted to the money management device 200, via the communication line, and then stored in the hard disk drive 225g of the money management device 200.

Thereafter, once the dispensing operation for dispensing the one million yen from the teller machine 100 is started, one one-million-yen banknote bundle is dispensed from the teller machine 100, while a manual disbursement receipt indicating that the inputted dispensing operation (or take-out operation) was partly performed is issued. On this manual disbursement receipt, the cooperation number corresponding to the cooperation process information on the dispensing operation is also printed.

Subsequently, when the cashier inputs the cooperation number to the money management device 200, the money management device 200 requires the transmission of the corresponding cooperation process information from the teller machine 100, based on the inputted cooperation number. Then, after receiving the cooperation process information from the teller machine 100, the money management device 200 displays the operation content (or process content) in the cooperation process information. In this case, the manual disbursement receipt, on which the cooperation number is printed, has been issued, as a result from the input of the ID information and identification number or password, by the cashier, to the teller machine 100. Further, in this case, since the same cashier also carries out the dispensing operation in the money management device 200, only the cooperation number has to be inputted, while the input of the ID information and identification number or password can be omitted. Otherwise, in this money management device 200, only the ID information, or only the ID information and identification number or password may be inputted, while the input of the cooperation number is omitted. In addition, in response to the input of the ID information, the cooperation process information related to the cashier may be displayed, as a list, such that a desired operation can be selected therefrom. This is convenient because of elimination of the need for being always careful not to lose the manual disbursement receipt and/or need for storing the cooperation number. However, for ensuring higher security, the input of the ID information and identification number or password may also be required even in the money management device 200.

Then, in “the take-out operation for taking out the total of eleven million yen, wherein one million yen is taken out from the teller machine 100 and ten million yen is taken out from the money management device 200”, the remaining (or unprocessed) operation for taking out the ten million yen from the money management device 200 is carried out. In this case, the corresponding drawer is unlocked, and one large banknote bundle of ten-million-yen is taken out from the money management device 200. Thereafter, an automatic money amount checking operation is performed in the money management device 200.

In this way, once the operation related to the aforementioned cooperation process information is completed, the cooperation process information is updated and recorded in the hard disk drive 225g of the money management device 200. Thereafter, the so-updated and recorded cooperation process information is also transmitted to the teller machine 100, via the communication line, and then recorded in the hard disk drive 15g of the teller machine 100.

Namely, due to such transmission and reception of the cooperation process information as described above, the cooperation process information can be well matched between the teller machine 100 and the money management device 200. In other words, the cooperation process information can be adequately synchronized between the two devices 100 and 200.

FIG. 14(B) shows another case, in which the dispensing operation for the total of eleven million yen (in this case, one million yen is taken out from the teller machine 100 and ten million yen is taken out from the money management device 200) is carried out by the teller.

First, the teller inputs the specific ID information and identification number or password to the teller machine 100, and then further inputs thereto the instruction for “the take-out operation for taking out the total of eleven million yen, wherein one million yen is taken out from the teller machine 100 and ten million yen is taken out from the money management device 200”. Thereafter, the cooperation process information on this take-out operation (or process) is prepared, while the cooperation number is assigned to this cooperation process information. Then, the cooperation process information is stored, together with the cooperation number, in the hard disk drive 15g of the teller machine 100. Further, in response to the inquiry from the money management device 200, this cooperation process information is also transmitted to the money management device 200, via the communication line, and then stored in the hard disk drive 225g of the money management device 200.

In this case, if the take-out operation for the ten million yen is beyond the authority given to the teller, while the teller can carried out the dispensing operation for the one million yen from the teller machine 100, the operation for taking out the ten million yen from the money management device 200 should be always carried out by the casher. This may be defined, in advance, in the cooperation process information.

Thereafter, once the operation for dispensing the one million yen from the teller machine 100 is started by the teller, one one-million-yen banknote bundle is dispensed from the teller machine 100, while the manual disbursement receipt indicating that the inputted dispensing operation (or take-out operation) was partly performed is issued. On this manual disbursement receipt, the cooperation number corresponding to the cooperation process information on the dispensing operation is also printed.

Subsequently, when the cashier having received a request from the teller inputs the specific ID information and identification number or password to the money management device 200, and then further inputs the cooperation number printed on the manual disbursement receipt to the money management device 200, the money management device 200 requires the transmission of the corresponding cooperation process information from the teller machine 100, based on the inputted cooperation number. Then, after receiving the cooperation process information from the teller machine 100, the money management device 200 displays the operation content (or process content) in the cooperation process information. In this case, because the teller in charge of carrying out the dispensing operation from the teller machine 100 is different from the cashier (or person in charge of accounts), this teller and the cashier have different individual ID information and identification numbers or passwords, respectively. Therefore, for each of the teller and cashier, the input of the ID information and identification number or password cannot be omitted or skipped. However, for each of the teller and cashier, once the ID information is inputted, a list of unprocessed cooperation processes (e.g., the take-out/storage process and the like) related to this teller or cashier can be displayed for allowing a desired cooperation number to be selected.

Then, in “the take-out operation for taking out the total of eleven million yen, wherein one million yen is taken out from the teller machine 100 and ten million yen is taken out from the money management device 200”, the remaining (or unprocessed) operation for taking out the ten million yen from the money management device 200 is carried out. In this case, the corresponding drawer is unlocked, and one large banknote bundle of ten-million-yen is taken out from the money management device 200. Thereafter, the automatic money amount checking operation is performed in the money management device 200.

Once the operation content related to the aforementioned cooperation process information is completed, this cooperation process information is updated and recorded in the hard disk drive 225g of the money management device 200. Then, this updated and recorded cooperation process information is also transmitted to the teller machine 100, via the communication line, and then recorded in the hard disk drive 15g of the teller machine 100.

Namely, due to the transmission and reception of the cooperation process information as described above, the cooperation process information can be well matched between the teller machine 100 and the money management device 200. In other words, the cooperation process information can be adequately synchronized between the two devices 100 and 200.

FIG. 14(C) shows still another case, in which the money management device 200 is operated, independently or solely, and in which the dispensing operation for the eleven million yen from the money management device 200 is carried out by the cashier.

In this case, when the cashier (i.e., the person in charge of accounts) inputs the specific ID information and identification number or password to the money management device 200, and then further inputs thereto an instruction for “the dispensing operation for the eleven million yen from the money management device 200”, the local process information on this dispensing operation is prepared, while the local process number is assigned to this local process information. Then, the local process information is stored, together with the local process number, in the hard disk drive 225g of the money management device 200. Further, at this point of time, if the money management device 200 is connected with the teller machine 100, via the communication line, this local process information is also transmitted to the teller machine 100, and then stored in the hard disk drive 15g of the teller machine 100.

Thereafter, once the operation for taking out the eleven million yen from the money management device 200 is started, one large banknote bundle of ten-million-yen and one banknote bundle of one-million-yen can be taken out, respectively. Then, the automatic money amount checking operation is performed in the money management device 200.

Once the operation related to the aforementioned local process information is completed, the local process information is updated and recorded in the hard disk drive 225g of the money management device 200. In this case, if the money management device 200 is connected with the teller machine 100, via the communication line, the recorded local process information is also transmitted to the teller machine 100 via the communication line, and then stored in the hard disk drive 15g of the teller machine 100. Meanwhile, if the money management device 200 is not connected with the teller machine 100, via the communication line, at the point of time the local process information is prepared, this local process information can be transmitted to the teller machine 100 and stored in the hard disk drive 15g of the teller machine 100, after the device 200 and machine 100 are connected together via the communication line.

The above description is provided for explaining one example of the procedure for the transmission and reception of the cooperation process information, performed by each of the money management system and money management method, respectively related to one embodiment of the present invention. This example is different from another example in part that will be described below, in the procedure for the transmission and reception of the cooperation process information.

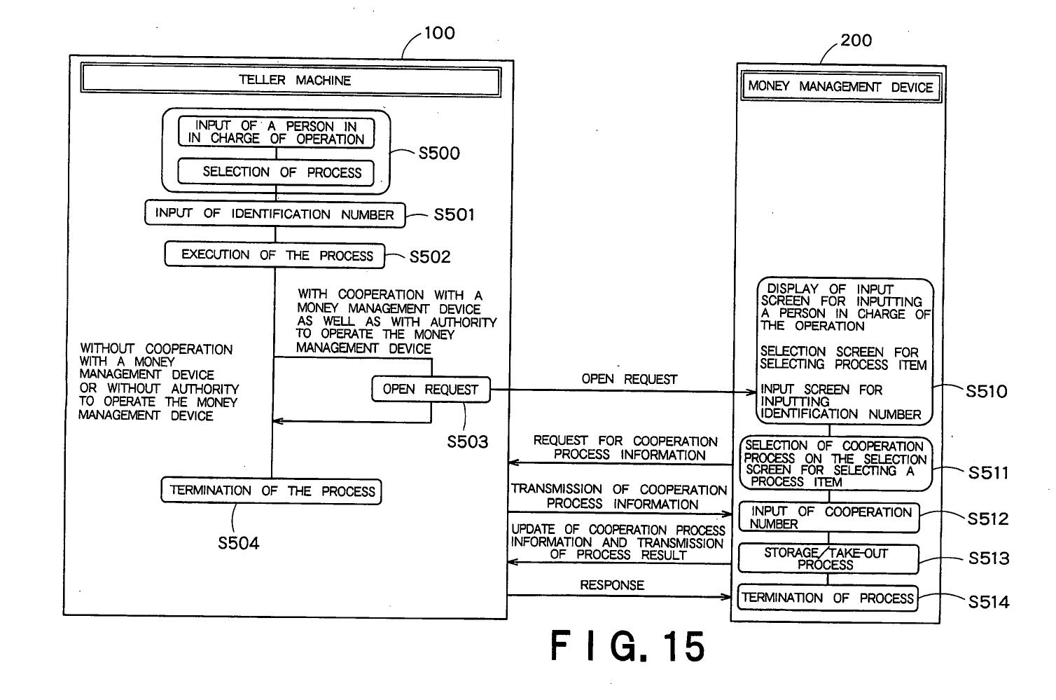

FIG. 15 schematically illustrates the data transmission/reception and procedure for operating this data transmission/reception, between the teller machine 100 and the money management device 200, upon the deposit/dispense operation (or process) in the money management device 200.

Once a person in charge of the deposit/dispense operation (or process) inputs the specific ID information to the teller machine 100, the processes respectively permitted and selectable for this person are displayed, as one list, on the display section 15a of the teller machine 100. Then, the person in charge of the deposit/dispense operation selects and inputs the deposit/dispense operation to be performed, among the displayed processes (Step S500), and further inputs the identification number necessary for this process (Step S501). Then, the cooperation process information related to this deposit/dispense operation is prepared, and the cooperation number is assigned thereto. Thereafter, this cooperation process information is stored, together with the cooperation number, in the hard disk drive 15g of the teller machine 100, and thus the deposit/dispense operation included in the cooperation process information is brought into a state that can be performed (Step S502).

Then, the teller machine 100 checks whether or not the cooperation process information includes the deposit/dispense operation to be performed in cooperation with the money management device 200. More specifically, the teller machine 100 checks whether or not the cooperation process information includes the deposit/dispense operation to be handled in the money management device 200, as well as checks whether or not the person in charge of this deposit/dispense operation is authorized to operate the money management device 200.

If either one of the above conditions is not satisfied, the process related to the cooperation process information is terminated (Step S504). Meanwhile, if the cooperation process information includes the deposit/dispense operation to be performed in cooperation with the money management device 200, and if the person in charge of this deposit/dispense operation is authorized to operate the money management device 200, the teller machine 100 transmits the process open request signal for requesting to start the take-out/storage process included in this cooperation process information, to the money management device 200, via the communication line (Step S503). Then, the certification print is outputted from the teller machine 100, and this process is ended (Step S504).

Once the above process open request signal is transmitted from the teller machine 100, the input operations for the ID and identification number of the person in charge of the operation can be skipped or omitted, in the money management device 200, among the input operations for the ID, identification number of the person in charge of the operation and item of the selected process (Step S510).

When the cooperation process information is selected on a screen for selecting the process items in the money management device 200 (Step S511), the cooperation number of this cooperation process information is brought into a state that can be inputted. By the way, this cooperation process information including the corresponding cooperation number assigned thereto has been prepared, as a result from the input of the ID information and identification number to the teller machine 100 by the person in charge of the operation. Therefore, the operation in the money management device 200 may be started, by inputting only the cooperation number to this device 200, without inputting thereto the ID information and identification number of the person in charge of the operation.

However, for ensuring the higher security, the input of the ID information and identification number of the person in charge of the operation may also be required in the money management device 200 upon the start of the operation (Step S510). In this case, the person in charge of the operation inputs the specific ID information and identification number to the money management device 200 (Step S510), and then selects the cooperation process information on the screen for selecting the process items (Step S511). As a result, the cooperation number of this cooperation process information is brought into the state that can be inputted.

Alternatively, in the money management device 200, only the ID information, or only the ID information and identification number or password may be inputted, in place of inputting the cooperation number. In this case, in response to the input of the ID information or the like, the cooperation process information related to the person in charge of the operation is displayed as one list. This is convenient because of the elimination of the need for being always careful not to lose the receipt including the cooperation number printed thereon and/or need for storing the cooperation number.

After the input of the ID information and identification number, or without the input of the ID information and identification number, when the person in charge of carrying out the operation inputs the cooperation number corresponding to the cooperation process information on the take-out/storage operation to be performed (Step S512), the money management device 200 transmits a cooperation process information request corresponding to the cooperation number, to the teller machine 100. Then, in response to this cooperation process information request, the teller machine 100 transmits the cooperation process information to the money management device 200. In this way, the money management device 200 receives the cooperation process information, and stores this cooperation process information in, for example, the hard disk drive 225g, while displaying the content of the take-out/storage operation included in the same cooperation process information.

Thereafter, due to the selection and input carried out by the person in charge of the displayed take-out/storage operation, the take-out/storage operation is brought into the state that can be performed. Then, after this take-out/storage operation (or process) is performed (Step S513), the automatic money amount checking operation (or automatic reconciling operation) is performed by the money management device 200. As a result, if there is no abnormality in the money-management-device money amount after the deposit/dispense operation, this deposit/dispense operation is normally ended.

Then, the cooperation process information stored in the money management device 200 is updated and recorded therein, after the completion of the operation content concerning this cooperation process information. At this time, this updated and recorded cooperation process information is transmitted, together with the information on the result of this process, to the teller machine 100, via the communication line. Thus, the cooperation process information managed in the teller machine 100 is also updated and recorded therein. Thereafter, when the teller machine 100 transmits information, to the money management device 200, for indicating that the teller machine 100 has received the updated and recorded cooperation process information and information on the process result, a “processed” flag is set for this cooperation process information in the teller machine 100. Meanwhile, once the money management device 200 receives the response from the teller machine 100, the process in the money management device 200 is also ended (Step S514).

Preferably, upon the end of the process in the teller machine 100, the process result is printed, as the certification print, on a certification slip.

After the money management device 200 receives the cooperation process information from the teller machine 100 and then the take-out/storage process related to this cooperation process information is performed and thus this cooperation process information is updated and recorded, if the communication line between the money management device 200 and the teller machine 100 is disconnected at a point of time that the updated and recorded cooperation process information is transmitted from the money management device 200 to the teller machine 100, the money management device 200 may hold such updated and recorded cooperation process information, without immediately transmitting this information, and then transmit this information after the communication line is connected again.

In this manner, one exemplary procedure is provided for the input operation or the like, in regard to the case in which the person in charge of the operation inputs the ID information, identification number or the like, in both of the teller machine 100 and money management device 200, upon the take-out/storage operation in the money management device 200 operated in the money management system and money management method, respectively related to one embodiment of the present invention.

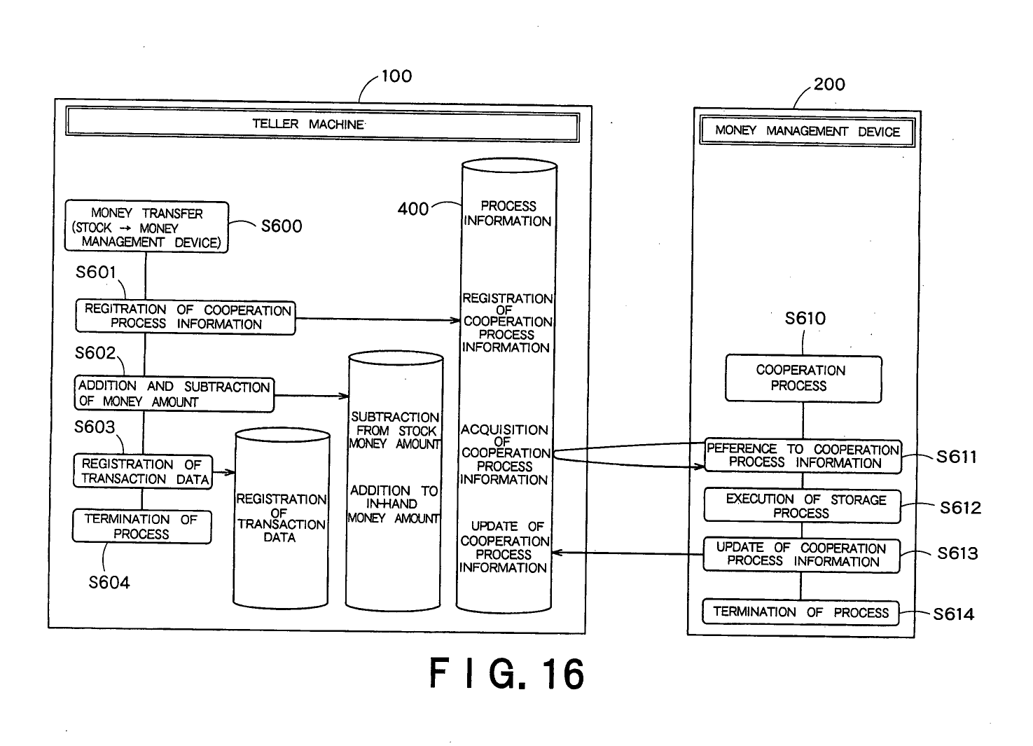

FIG. 16 schematically illustrates each flow for processing various information including the cooperation process information transmitted and received between the teller machine 100 and the money management device 200 in the money management system and money management method, respectively related to one embodiment of the present invention.

The cooperation process information in the money management system and money management method, respectively related to this embodiment of the present invention is registered or stored in the process information management database 400 of the teller machine 100, and then optionally updated as needed.

For instance, in the case of the money transfer process for transferring the funds from the stock of the main safe to the money management device 200 (Step S600), the cooperation process information related to the deposit/dispense operation is prepared and then registered in the process information management database 400, in the teller machine 100 (Step S601). Thereafter, for the management of the money amount associated with this money transfer process for the funds, the teller machine 100 subtracts the amount of money of the transferred funds from the stock money amount of the main safe, and then adds the so-subtracted amount of money, as one part of the in-hand money amount, to the money-management-device money amount (Step S602). Further, the teller machine 100 registers the funds transferred in the above cooperation process, in the process information management database 400, as the transaction data (Step S603). Then, this process in the teller machine 100 is ended (Step S604).

Meanwhile, in this deposit/dispense operation based on the cooperation process information, the depositing process or storage process is performed, as the cooperation process, in the money management device 200 (Step S610). Namely, once receiving the aforementioned process open request signal from the teller machine 100, the money management device 200 requests, obtains and refers to the cooperation process information, in response to the process open request signal (Step S611). Then, based on this cooperation process information, the storage process for the funds (or money) transferred from the stock of the main safe is performed (Step S612). Subsequently, in the money management device 200, the cooperation process information is updated and recorded, after the completion of the operation content (or process content) related to this cooperation process information (Step S613), and then the so-updated and recorded cooperation process information is transmitted to the teller machine 100, via the communication line. At this time, the cooperation process information stored in the process information management database 400 of the teller machine 100 is also updated. Once the updated and recorded cooperation process information is transmitted to the teller machine 100, the cooperation process in the money management device 200 is ended (Step S614).

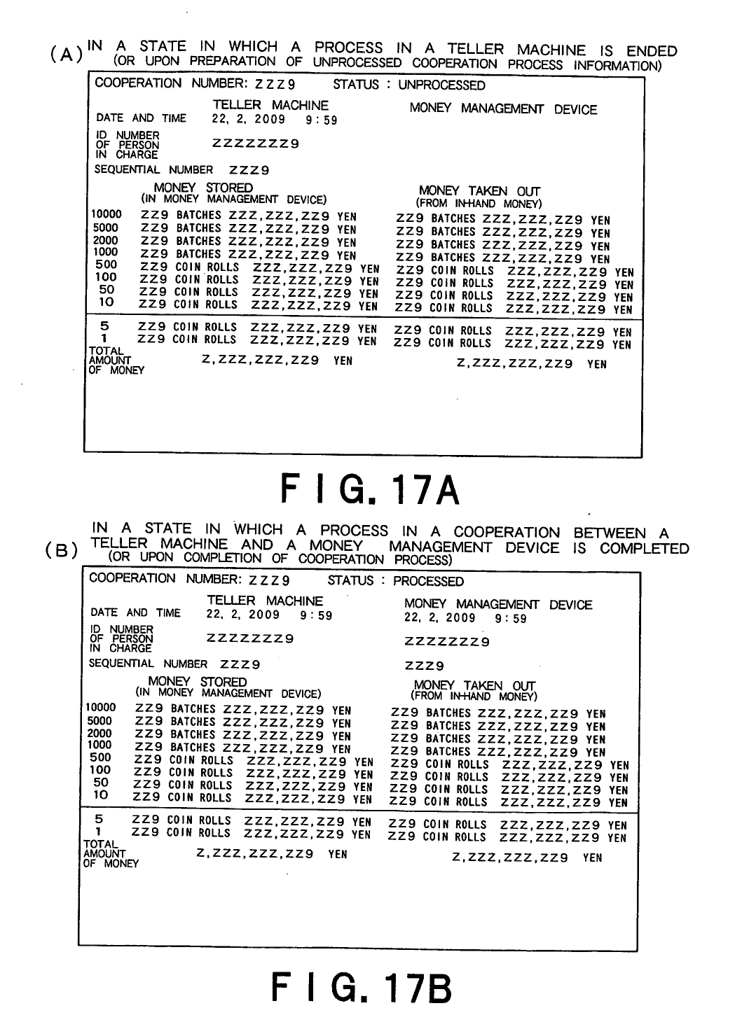

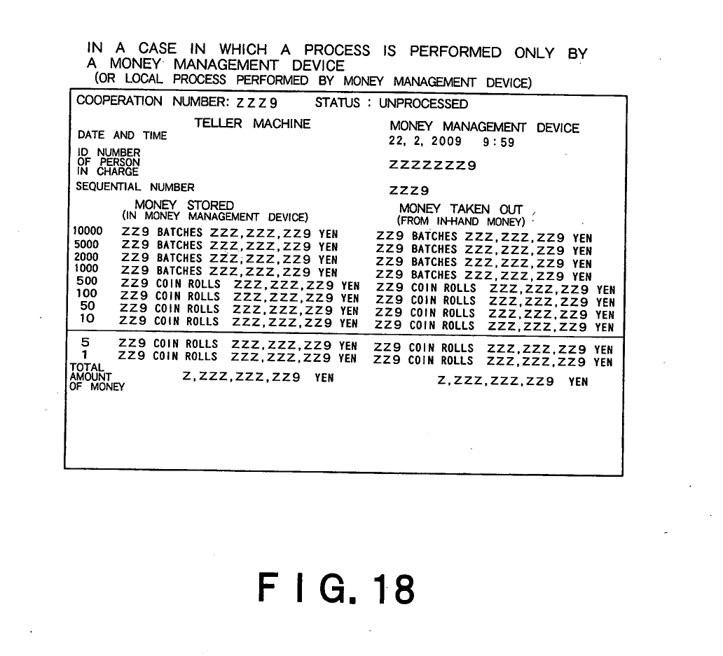

FIGS. 17A through 18 respectively illustrate examples of the content of the cooperation process information prepared and updated in the money management system and money management method, respectively related to one embodiment of the present invention.

First of all, FIG. 17A illustrates one example of the content of the cooperation process information in the case in which the process of the cooperation process information is ended or processed in the teller machine, while being unprocessed in the money management device. Namely, this example indicates that the cooperation process information on the cooperation process including the deposit/dispense operation and take-out/storage operation in the teller machine 100 and money management device 200 is prepared and registered in the teller machine 100. Further, this example indicates that only the deposit/dispense operation in the teller machine 100 is completed, while the take-out/storage operation in the money management device 200 is still unprocessed. In this case, the number of batch of the banknote bundles and the number of the coin rolls, for the respective denominations of the money to be handled in the deposit/dispense operation and take-out/storage operation in the teller machine 100 and money management device 200, are registered, respectively, for each denomination of money. Further, in this case, the date and time on which the deposit/dispense operation was performed in the teller machine 100 as well as the identification number of the person in charge of the operation are shown, respectively. Additionally, in an upper central part of FIG. 17A, an indication of “Unprocessed” is shown for indicating that the storage/take-out operation is still unprocessed.

FIG. 17B illustrates another example of the content of the cooperation process information in the case in which the cooperation process in the teller machine and money management device is completed and in which the cooperation process information is updated. Namely, this example indicates that the deposit/dispense operations in both of the teller machine 100 and money management device 200 registered in the cooperation process information are completed, respectively. Further, this example indicates the date and time on which each deposit/dispense operation was performed as well as indicates the identification number of the person in charge of each operation. Additionally, in an upper central part of FIG. 17B, an indication of “processed” is shown for indicating that the storage/take-out operation is already performed.

FIG. 18 illustrates one example of the content of the local process information prepared for performing the local process performed independently or solely in the money management device, wherein this local process is unprocessed. This example indicates that the local process information on the take-out/storage operation in the money management device 200 is prepared and registered in this device 200, and that the data on this take-out/storage operation prepared in the money management device 200 is transmitted to the teller machine 100. Further, this example indicates that the number of batch of the banknote bundles and the number of the coin rolls, for the respective denominations of the money to be handled in the take-out/storage process in the money management device 200, are registered, respectively, for each denomination of money. In addition, the date and time on which the local operation was performed in the money management device 200 as well as the identification number of the person in charge of the operation, are respectively shown in this example. Furthermore, in this example, the indication of “Unprocessed” is shown for indicating that the certification print is not yet performed in the teller machine 100.

Now, with reference to the above examples, one exemplary procedure for preparing and updating the cooperation process information in the money management system and money management method, respectively related to one embodiment of the present invention, will be described.

In the case in which the cooperation between the teller machine 100 and the money management device 200 is required for the deposit/dispense operation to be performed, the transaction data on this money management device, i.e., the cooperation process information, is prepared and registered in the teller machine 100, as the money-management-device money amount corresponding to a part or all of the money amount data inputted as the in-hand money amount and handled in the money management device 200.

In this procedure, the denomination of money to be handled includes, 10,000-yen, 5,000-yen, 2,000-yen and 1,000-yen, in regard to the banknotes, and further includes 500-yen, 100-yen, 50-yen, 10-yen, 5-yen and 1-yen, in regard to the coins.

In this case, in the money management device 200, the bundled banknotes and wrapped coins are respectively handled, while the loose banknotes and loose coins are not handled.

The unit of the number of the banknotes, for each banknote bundle to be taken out or stored, registered in the cooperation process information is one hundred, while the unit of the number of the coins, for each wrapped coin (or coin roll) to be taken out or stored, registered in the cooperation process information is fifty. For instance, in the case in which the take-out operation (or process) for one hundred and thirty 10,000-yen banknotes and ninety 500-yen coins is registered, one hundred 10,000-yen banknotes and fifty 500-yen coins are first registered, respectively, as the money to be handled in the take-out operation from the money management device 200, while the remaining thirty 10,000-yen banknotes and forty 500-yen coins are not registered, respectively, as the money handled in this take-out operation. Otherwise, in the case in which the dispensing operation (or process) for sixty 5,000-yen banknotes and fifty 1,000-yen banknotes is registered, there is “no” dispensing operation that can be registered as the take-out operation from the money management device 200.

Preferably, only the person in charge of the operation that is “permitted” to operate the money management device 200 can select either of “In-hand money amount operation” or “Money-management-device money amount operation”, upon certification for the in-hand money amount operation. Further, it is preferred that the person in charge of the operation that is “not permitted” to operate the money management device 200 has to carry out the registration of the “Money-management-device money amount operation”, as the cooperation process to be performed in cooperation with another person in charge of the operation that is permitted to operate the money management device 200. Namely, on this condition, the person not permitted to operate the money management device 200 can also carry out the deposit/dispense operation in the money management device 200.

Further, in the teller machine 100, the cooperation number corresponding to the cooperation process information is printed on a printed slip of the cooperation process information, such as the certification slip (or receipt) or the like, issued upon certification for the cooperation process including the take-out/storage operation in the money management device 200.

Upon the certification for the cooperation process, i.e., upon the preparation and registration of the cooperation process information, the money-management-device money amount stored, at this point of time, in the teller machine 100 is checked to confirm whether or not the amount of the transferred money, as a result of performing the deposit/dispense operation to be certified, will exceed the capacity of the money management device 200, for each denomination of money. In one example in which the operation includes a certain denomination of money that will exceed the capacity of the money management device 200, it is preferred that the deposit/dispense operation for the denomination of money that will exceed the capacity is excluded. Namely, in this case, the certification for the cooperation process is provided for only the deposit/dispense operation for each denomination that can be handled within the capacity, and then the cooperation process information is prepared and registered, based on this certification.

For instance, in the case in which the capacity of the money management device 200 corresponds to three hundred batches of the 10,000-yen banknote bundles and three hundred coin rolls of the 500-yen coins and in which the operation certification for the cooperation process is performed for the depositing process for four hundred and fifty batches of 10,000-yen banknote bundles as well as for the depositing process for one hundred coin rolls of 500-yen coins, the depositing process for the four hundred fifty batches of ten-thousand-yen banknote bundles is excluded from the operation certification for the cooperation process, while only the depositing process for one hundred coin rolls of 500-yen coins can receive the operation certification for the cooperation process. Thereafter, the cooperation process information is prepared and registered, based on this operation certification.

Meanwhile, the storage/take-out operation for the denomination of money excluded from the operation certification for the cooperation process because of exceeding the capacity is displayed on a confirmation screen, upon the operation certification for the cooperation process, in order to receive input for confirmation or selection on whether or not the operation certification for the cooperation process may be provided for only the take-out/storage operation for another denomination (or denominations) than the excluded denomination. Further, in the case in which the denomination of money exceeding the capacity of the money management device 200 is present, and in which the input of the operation certification for the cooperation process is carried out by the person in charge of the operation that is “not permitted” to operate the money management device 200, an operation for rendering the operation certification unpermitted may be continued, without displaying the checking screen.

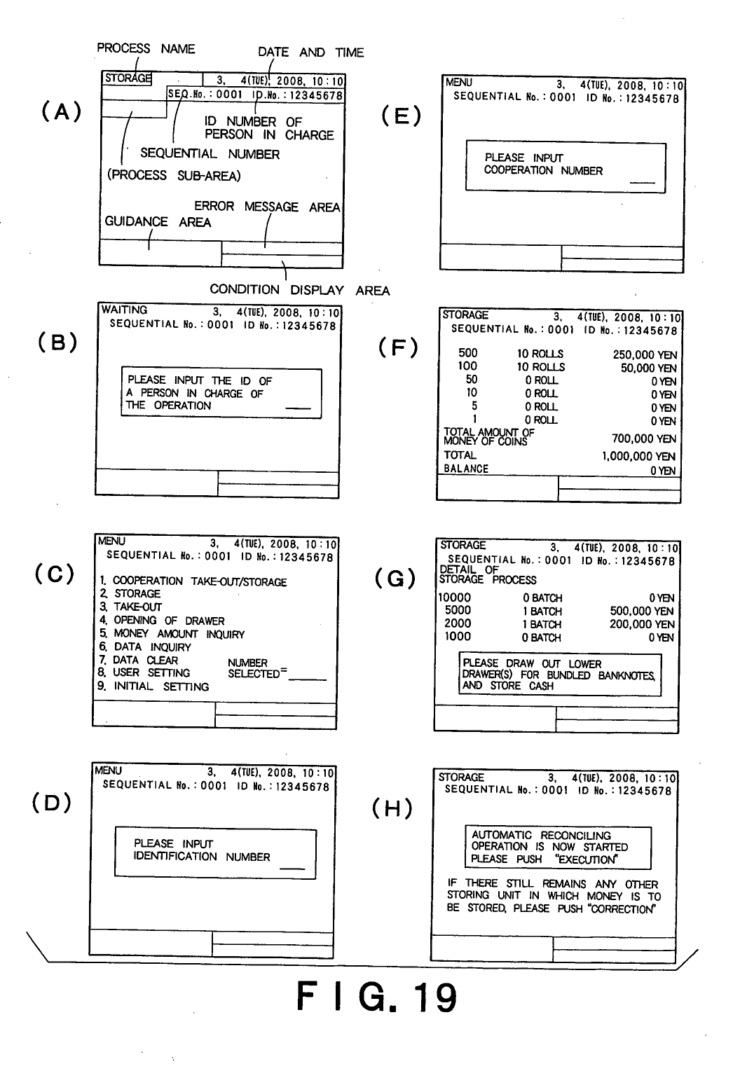

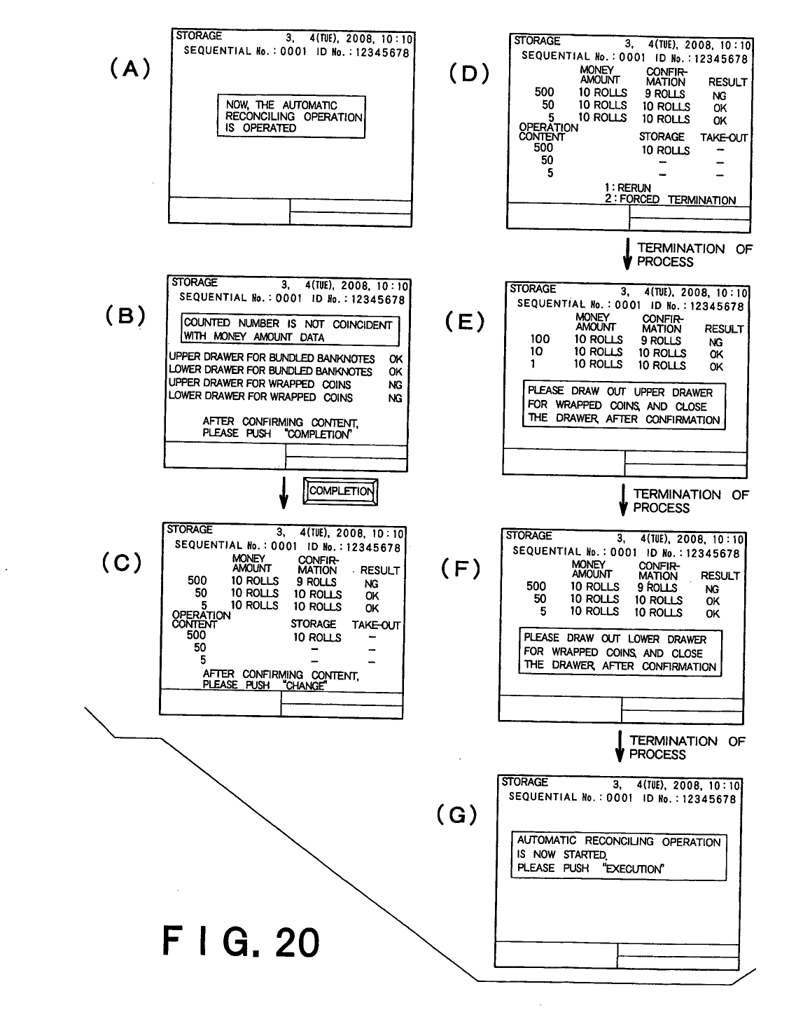

FIGS. 19A through 20G respectively illustrate the examples of the screen display in the money management device 200, in the case of performing the cooperation process between the teller machine 100 and the money management device 200.

FIG. 19A shows one construction of the display screen of the money management device 200. In this screen, the name of the process performed (or process name), such as the storage process or the like, the date and time, one of sequential numbers corresponding to the process performed, and the number of the person in charge of the process are displayed, respectively. In addition, a process sub-area, a guidance area, an error message area and a condition display area are respectively provided in the screen.

FIG. 19B shows a state of waiting for the input of the ID of the person in charge of the operation (or process). Once the ID of the person in charge of the operation is inputted, as shown in FIG. 19C, a menu selection screen is displayed, on which the operations that can be respectively performed in the money management device 200 are displayed, as one list. For instance, when “Cooperation take-out/storage” is selected on this menu selection screen, the input of the identification number of the person in charge of the operation is requested. FIG. 19D shows a state of waiting for the input of the identification number.

If a correct identification number is inputted and the person in charge of the operation is authorized to carry out the “Cooperation take-out/storage”, this operation or process is started. Then, as shown in FIG. 19E, a state of waiting for the input of the cooperation number is displayed. Once the cooperation number is inputted, the money management device 200 obtains the cooperation process information corresponding to the inputted cooperation number, from the process information management database 400 of the teller machine 100. However, if the cooperation process information corresponding to the inputted cooperation number is not present, or if the storage/take-out operation related to the cooperation process information corresponding to the inputted cooperation number is already processed, this process or operation is not performed.

Further, at the point of time that the cooperation process information is obtained, the money management device 200 checks the money-management-device money amount, in order to confirm whether or not the amount of the transferred money, as a result of performing the deposit/dispense operation of the cooperation process information, will exceed the capacity of the money management device 200, for each denomination of money. If this operation includes the denomination of money exceeding the capacity of the money management device 200, an error message is displayed. Meanwhile, if there is no denomination of money exceeding the capacity of the money management device 200, the procedure for this operation goes to the next step.

Further, if the person in charge of operating the teller machine 100 is also authorized to operate the money management device 200, this person can move to the place in which the money management device 200 is located, immediately after operating the teller machine 100, in order to carry out the operation or process, for which the aforementioned process open request is already received from the teller machine 100. In this case, the procedure of this operation can directly goes to the state of waiting for the input of the cooperation number, while omitting all of the input of the ID of the person in charge of the operation, the input of the process selection, and the input of the identification number.

Once the cooperation process information corresponding to the inputted cooperation number is obtained, the content of the take-out/storage operation related to this cooperation process information is displayed, as shown in FIGS. 19F and 19G. On the display screen of FIG. 19F, the number of the coin rolls to be stored in the money management device 200 is displayed, for each denomination of money. Further, on the display screen of FIG. 19G, the number of batch of the banknote bundles to be stored in the money management device 200 is displayed, for each denomination of money. Preferably, the display screen of FIG. 19F and display screen of FIG. 19G can be switched alternately each time a “Switching” key of the keyboard operation section 226 of the money management device 200 is pushed down.

Once the content of the take-out/storage operation related to the cooperation process information is confirmed on the respective display screens of FIGS. 19F and 19G, a “Completion” key is pushed down, twice, as input for the confirmation. In this way, the process content to be performed is confirmed and accepted.

Once the process content is determined, the money management device 200 is brought into a state that can perform the take-out/storage operation (in this case, the storage process). Namely, the storing unit for each designated denomination of money is unlocked, and an indication or message that the take-out/storage operation can be performed is displayed on a lower central part of the display screen of FIG. 19G. In the case of unlocking the plurality of storing units, the order of priority can be set for each unlocking operation.

In this manner, once the take-out/storage operation (in this case, the storage process) is completed for all of the designated denominations, a state of waiting for execution of the automatic reconciling operation is displayed, as shown in FIG. 19H. At this time, if there still remains “any other storing unit” in which the money is to be stored, as displayed in a lower central part of the display screen of FIG. 19H, such a storing unit can be unlocked by pushing down a “Correction” key. In this way, the money can also be stored in “any other storing unit”.

Thereafter, when an “Execution” key is pushed down, the automatic reconciling operation is started.

In this automatic reconciling operation, the weight measurement is first carried out for each denomination of money, and then the number of batch of the banknote bundles and the number of the coin rolls, for each denomination of money, are respectively counted. Thereafter, the so-counted numbers are compared, respectively, with the data on the money-management-device money amount. If the counted numbers respectively correspond to the money amount data, this operation is normally ended. Then, the display screen is changed into the menu selection screen or screen for displaying the waiting state. FIG. 20A shows one example of the screen display during the execution of the automatic reconciling operation.

Meanwhile, if the result of the above automatic reconciling operation shows that the counted numbers do not correspond to the money amount data, an indication of “OK (i.e., normal)” or “NG (i.e., abnormal)” about this reconciling result is displayed for each storing unit, as shown in FIG. 20B. At this point of time, when the “Completion” key is pushed down, the money amount and weight measurement result, for each denomination of money, are respectively displayed, for each abnormal storing unit, as shown in FIGS. 20C and 20D. Preferably, the display screens of FIG. 20C and FIG. 20D can be switched alternately each time the “Switching” key is pushed down.

Then, on the display screens of FIGS. 20E and 20F, one indication or message is displayed for urging the operator to open each storing unit of the abnormal checking result (NG) and check the money stored therein with eyes.

Finally, on the display screen of FIG. 20G, a state of waiting for selecting either of forced termination or restart of the automatic reconciling operation is displayed. When the restart of the automatic reconciling operation is selected, the automatic reconciling operation is performed again, from the weight measurement for each denomination of money (as shown in FIG. 20A). Meanwhile, when the forced termination is selected by using the keyboard operation section 226, the input of the ID and identification number of a certain person that approves the forced termination is requested. Once the ID and identification number of that person are inputted, the process is forcedly terminated, and then the display screen is changed into the menu selection screen.

Now, the local process performed, independently or solely, in the money management device 200 will be described. First of all, an open process is carried out before the local process is performed. Namely, when the ID of the person in charge of the operation is inputted to the money management device 200 that has been brought into the state of waiting for the input of the ID of the person in charge of the operation, the display screen is changed into the menu selection screen, on which the operations that can be performed in the money management device 200 are displayed as one list.

For instance, when an item of “Storage” is selected on this menu selection screen, the input of the identification number of the person in charge of the operation is requested. As a result, if the correct identification number is inputted and the person in charge of the operation is authorized to carry out the “storage” operation, this process is started.

Then, the total amount of money to be stored is inputted, while the related denomination (or denominations) of money is selected. Thereafter, the number of batch of the banknote bundles and the number of the coin rolls to be respectively stored are inputted. Then, the money management device 200 checks the money-management-device money amount at this point of time, in order to confirm whether or not the amount of the transferred money, as a result of performing the inputted storage operation, will exceed the capacity of the money management device 200, for each denomination of money. If there is any denomination of money that will exceed the capacity of the money management device 200, the input for this process is not accepted, while the error message is displayed.

Meanwhile, if there is no denomination of money that will exceed the capacity of the money management device 200, the push down of the “Completion” key is requested. Then, once the “Completion” key is pushed down, the money management device 200 checks whether or not the inputted total amount of money is coincident with the total amount of money corresponding to the number of batch of the banknote bundles and the number of the coin rolls, already set, for each denomination of money, in the case in which the total amount of money is inputted and is set. If not coincident, the input for the “Completion” is not accepted, while the error message is displayed. Meanwhile, if coincident, the push down of the “Completion” key is requested again. Then, once the “Completion” key is pushed down again, the process is accepted, and the procedure for this operation goes to the next step.

Once the process is accepted, the money management device 200 is brought into the state that can perform the take-out/storage operation (in this case, the storage process). Namely, each storing unit for the designated denomination of money is unlocked, and then the indication or message that the take-out/storage operation can be performed is displayed on the display screen. In the case of unlocking the plurality of storing units, the order of priority can be set for each unlocking operation.

Once the take-out/storage operation (in this case, the storage process) for all of the designated denominations of money is completed, the money management device 200 is brought into a state of waiting for the automatic reconciling operation. At this time, if there still remains “any other storing unit” in which the money is to be stored, such a storing unit can be unlocked by pushing down the “Correction” key. In this way, the money can also be stored in “any other storing unit”. Thereafter, when the “Execution” key is pushed down, the automatic reconciling operation is started.

In this automatic reconciling operation, the weight measurement for each denomination of money is first carried out, and then the number of batch of banknote bundles and the number of the coin rolls, for each denomination of money, are respectively counted. Thereafter, the so-counted numbers are compared, respectively, with the data on the money-management-device money amount. If the counted numbers respectively correspond to the money amount data, this operation is normally ended. Then, the display screen is changed into the menu selection screen or screen for displaying the waiting state.

Meanwhile, if the result of the above automatic reconciling operation shows that the counted numbers do not correspond to the money amount data, the indication of “OK (i.e., normal)” or “NG (i.e., abnormal)” about this checking result is displayed for each storing unit. When the “Completion” key is pushed down, the money amount and weight measurement result, for each denomination of money, are respectively displayed, for each abnormal storing unit. Preferably, the display screens for this operation or process can be alternately switched each time the “Switching” key is pushed down, if there are plurality of display screens showing the result.

Then, the indication for urging the operator to open each storing unit of the abnormal reconciling result (NG) and check the money stored therein with eyes is displayed. Finally, the state of waiting for the selection of the forced termination or restart of the automatic reconciling operation is displayed. When the restart of the automatic reconciling operation is selected, the automatic reconciling operation is performed again, from the weight measurement for each denomination of money. Meanwhile, when the forced termination is selected, the input of the ID and identification number of the person that approves the forced termination is requested. Once the ID and identification number of that person are inputted, the process is forcedly terminated, and then the display screen is changed into the menu selection screen.

Now, one exemplary procedure for tracking a calculation error in the money management system and money management method, respectively related to one embodiment of the present invention, will be described. As used herein, the “calculation error” means the process or operation that is registered at the teller machine 100, while being not completed in the money management device 200.

In this calculation-error tracking operation, whether or not the transaction totalization result in the money management device 200 is matched with the transaction totalization result in the teller machine 100, i.e., whether or not there is any cooperation process information remaining unprocessed, is confirmed, on the basis of a simplified total amount of money of the money management device 200.

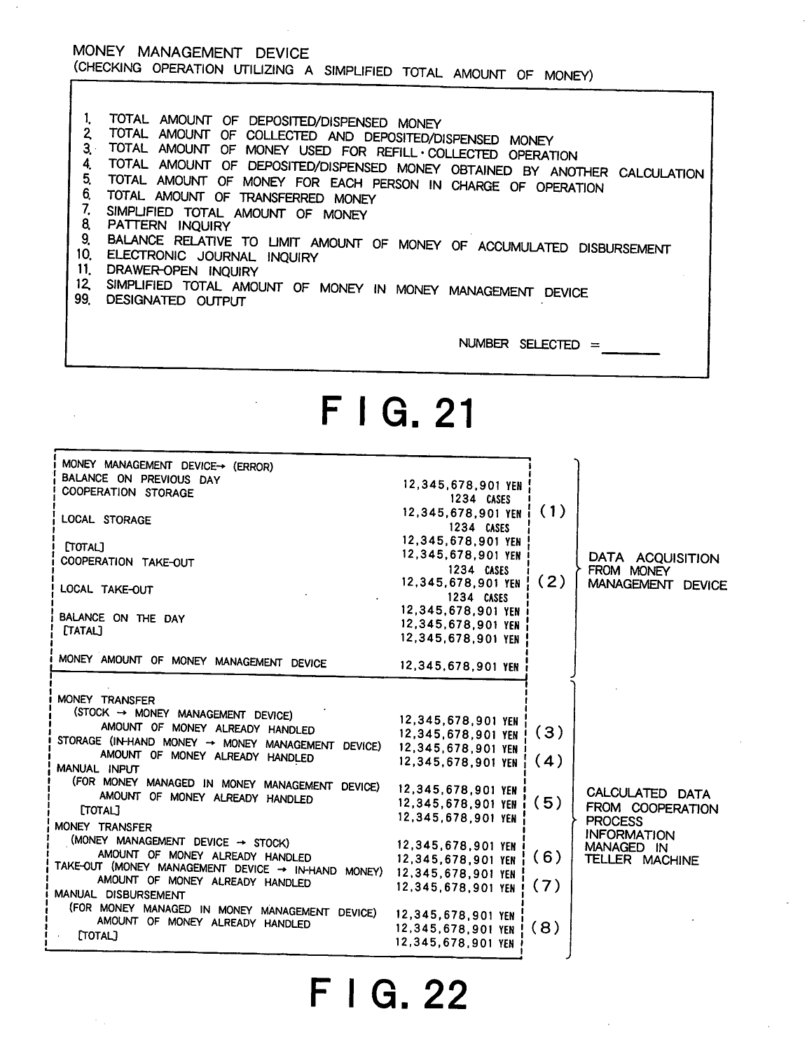

FIG. 21 illustrates one example of the screen display on the menu selection screen of the money management device 200. For instance, for the calculation-error tracking operation, an indication or item of “12. Simplified total amount of money of the money management device” is first selected on the menu selection screen.

FIG. 22 illustrates one example of the data content of the simplified total amount of money obtained from the money management device 200 as well as illustrates one example of the content of the transaction totalization result calculated on the basis of the cooperation process information managed in the teller machine.

In the example of the data content of the simplified total amount of money obtained from the money management device 200, (1) the total amount of money of a cooperation storage (or depositing) process and (2) the total amount of money of a cooperation take-out (or dispensing) process are included, respectively.

Meanwhile, the example of the content of the transaction totalization result calculated from the cooperation process information managed in the teller machine includes (3) the amount of the processed (or handled) money that has been handled in the money transfer operation from the stock (i.e., the money amount of the main safe) to the money management device, (4) the amount of the processed money that has been handled in the storage process for the funds from the in-hand money (i.e., the in-hand money amount) to the money management device, (5) the amount of the processed money that has been handled in the storage process manually inputted to the money management device, (6) the amount of the processed money that has been handled in the money transfer operation from the money management device to the stock (i.e., the money amount of the main safe), (7) the amount of the processed money that has been handled in the take-out process for the funds from the money management device to the in-hand money (i.e., the in-hand money amount), and (8) the total amount of the processed money that has been handled in the take-out process manually inputted to the money management device.

Namely, by comparing the data content of the simplified total amount of money obtained from the money management device 200, with the content of the transaction totalization result calculated on the basis of the cooperation process information managed by the teller machine, whether or not the two contents are matched with each other, i.e., whether or not all of the cooperation processes are already processed, can be confirmed.

If all of the cooperation processes are already processed, the following two equations, “(1)=(3)+(4)+(5)” and “(2)=(6)+(7)+(8)”, are established, respectively.

Meanwhile, if one or both of the two equations is not established, it can be seen that there is any cooperation process remaining unprocessed. In this way, by making the inquiry about the transaction history of the money management device 200, the unprocessed deposit/dispense operation related to the cooperation process information of each cooperation number can be checked. Further, if required, a certain deposit/dispense operation, i.e., a certain storage/take-out process, may be performed in the money management device 200.

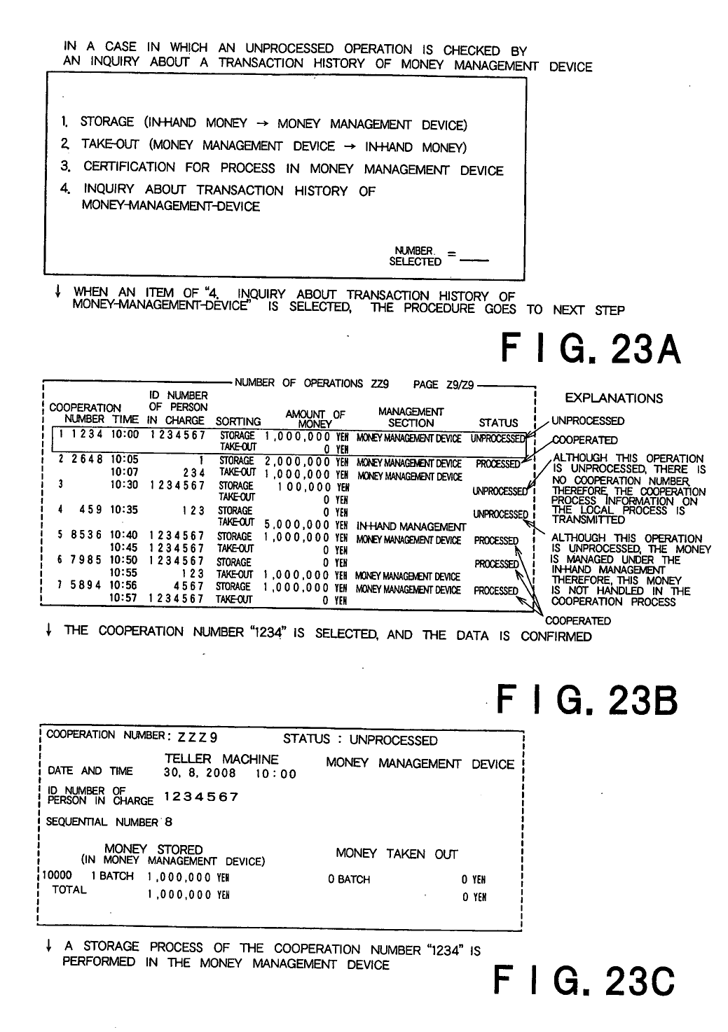

FIGS. 23A through 23C respectively illustrate typical examples of the screen display, upon checking each unprocessed operation, based on the inquiry about the transaction history of the money management device 200.

When an indication of “4. Inquiry about the transaction history of the money-management-device” is selected on the menu selection screen shown in FIG. 23A, the inquiry is made to the money management device 200 about the transaction history thereof, and then a transaction history inquiry screen for the money management device 200 is displayed as shown in FIG. 23B.

From this transaction history inquiry screen shown in FIG. 23B, it can be seen that the storage process designated by “1” and having the cooperation number “1234” is unprocessed. Although the storage process designated by “3” is unprocessed, the cooperation number is not assigned thereto. Namely, the process information on this storage process designated by “3” is the local process information concerning the local process performed, independently or solely, by the money management device 200, and this storage process itself is already ended. In addition, the transmission of this local process information to the teller machine 100 has also been completed. However, the certification print for this local process information in the teller machine 100 is not yet completed. Therefore, for this storage process designated by “3”, the indication of “Unprocessed” will be changed into “Processed”, only by performing the certification print in the teller machine 100. While the take-out process designated by “4” and having the cooperation number “459” is also unprocessed, this process is related to the in-hand money or funds. Therefore, this take-out process is not the process that is to be performed in cooperation with the teller machine 100. Further, it can be seen that the other money transfer (or take-out/storage) processes are all processed.

Accordingly, the money transfer process that is to be performed in the money management device 200 can be recognized as the cooperation process designated by “1” and having the cooperation number “1234”. Therefore, by performing this cooperation process, as well as by transmitting and receiving the cooperation process information, for which the transmission and reception has not been completed, between the teller machine 100 and the money management device 200, the calculation error can be eliminated.

As described above, according to the money management system and money management method, respectively related to one embodiment of the present invention, the money management device 200 constituting the money management system, together with the teller machine 100, can be optionally moved to be used in any suitable place in the branch of the financial institution, by disconnecting the communication line between the two devices 100, 200. Further, the cooperation process information on the deposit/dispense operation related to both of the teller machine 100 and money management device 200 can be transmitted and received between the teller machine 100 and the money management device 200, upon the connection of the communication line between the two devices 100, 200. Therefore, the teller machine 100 can also accurately manage the in-hand money amount including the money-management-device money amount, in addition to the stock money amount, machine money amount and post money amount. As such, significantly accurate and centralized management of the money amount of the whole system of each branch of the financial institution, such as the bank or the like, can be achieved. Accordingly, the time and labor required for calculating the money upon the closing balance and/or reconciling operation can be substantially saved, thereby achieving a significantly low-cost business management.

As described above, the teller machine 100 and money management device 200 can be optionally connected relative to each other at any suitable time and place, via the communication line, in order to allow the cooperation process information to be transmitted and received therebetween. Therefore, the teller machine 100 can perform substantially accurate management on the condition of each cooperation process as well as on each related money amount, by updating the cooperation process information into the newest information, each time the cooperation process information is transmitted and received. Although, in the above embodiment, the cooperation process information transmitted from the money management device 200 has been described as the information to be stored in the memory, such as the hard disk drive 15g or the like, of the teller machine 100, the cooperation process information may be held or stored in the money management device 200, without being stored in the memory of the teller machine 100. In this case, the teller machine 100 can utilize such cooperation process information held in the money management device 200, only when this teller machine 100 makes an inquiry to the money management device 200 about the information.

Besides, in the money management device 200, only the ID information, or only the ID information and identification number or password may be inputted, while omitting the input of the cooperation number. In this case, in response to, the input of the ID information, the cooperation process information related to the person in charge of the operation is displayed as one list. This is convenient because of the elimination of the need for being always careful not to lose the receipt or certification slip having the cooperation number printed thereon and/or need for storing the cooperation number. Further, in this case, because the cooperation process information related to the person in charge of the operation can be displayed as one list, by only inputting the ID information of this person, such as by inserting the ID card or the like, the operation for each process can be significantly facilitated, even when several cooperation processes are respectively in the waiting state in the money management device 200 and/or when such processes are respectively performed in the money management device 200 in a different order from the order set in the teller machine 100. Further, even in the case in which there are a plurality of cooperation numbers and cooperation process information respectively corresponding to the same ID information, if the amount of money related to each of such cooperation numbers and cooperation process information, as well as the time of each registration or time of each process in the teller machine 100 can be displayed on the screen, the selection of each process can be substantially facilitated.

Additionally, by managing each money transfer process in both of the teller machine 100 and money management device 200 on the basis of the cooperation process information, the deposit/dispense process in the teller machine 100 and the storage/take-out process in the money management device 200, respectively set in the same cooperation process information, can also be performed separately by different persons respectively in charge of the operation. This is very convenient. For instance, the time required for the completion of the above money transfer processes in both of the teller machine 100 and money management device 200 can be significantly saved, as compared with the case in which both of such money transfer processes have to be performed by one person in charge of the operation. Ideally, both of such money transfer processes can be completed at substantially the same time.

Usually, the cooperation process for the deposit/dispense operation performed by the teller machine 100 and money management device 200 based on the cooperation process information often occurs on every business day in each branch of the financial institution. As such, each time the cooperation process occurs, the cooperation process information is prepared and registered in order to perform the cooperation process.

However, it is possible that the cooperation process set in the prepared and registered cooperation process information is left unprocessed inadvertently, and/or that unnecessary cooperation process information is mistakenly prepared and registered.

Further, it is also possible that an undesired time lag occurs between an actual deposit/dispense operation and the data input, in each of the teller machine 100 and money management device 200, even in the case in which the cooperation process set in the prepared and registered cooperation process information is performed appropriately.

Accordingly, in order to carry out the accurate management on the money amount for each branch of the financial institution, it is necessary to adequately address such inconvenience.

Usually, in each branch of the financial institution, the manager carries out a closing balance and totalization for the deposit/dispense processes, for each day or predetermined days, at each point of time that all of the deposit/dispense processes, for each day or predetermined days, are ended. Then, the manager prepares a deposit/dispense totalization table, and confirms whether or not a numerical value of the data is coincident with an actual money amount. Thereafter, the manager informs a financial head office of the result of the management of the money amount, and then carries out the data clear process for the deposit/dispense processes for each day or predetermined days.

Now, one exemplary operational procedure for carrying out the well centralized management for checking whether or not the deposit/dispense operation was securely performed in the cooperation process between the teller machine 100 and money management device 200, in the money management system and money management method respectively related to one embodiment of the present invention, by using the teller machine 100 of the money management system, will be described. Namely, one typical procedure for detecting and managing the unprocessed cooperation process, upon the closing balance operation in the money management system and money management method, respectively related to one embodiment of the present invention, will be discussed.

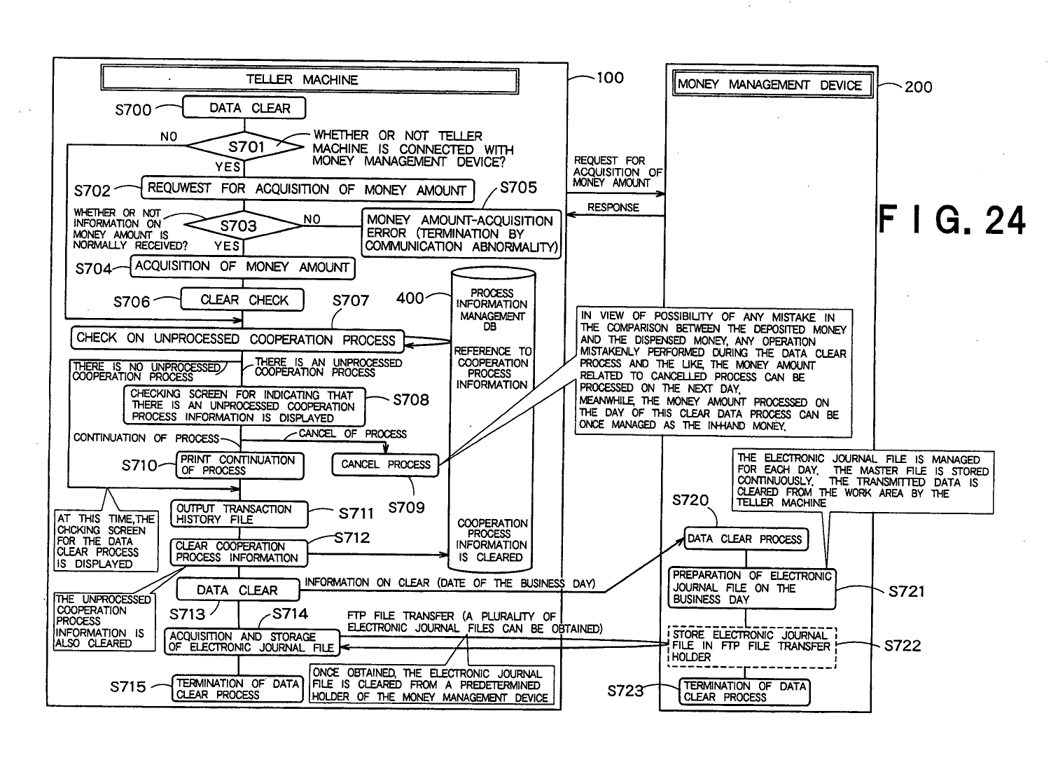

FIG. 24 schematically illustrates one procedure for the data clear process upon the closing balance operation in the money management system and money management method, respectively related to one embodiment of the present invention.

When the data clear process is selected in the teller machine 100 (Step S700), and if the teller machine 100 is set to be “connected” with the money management device 200 (Step S701), the teller machine 100 transmits a money amount-acquisition request signal to the money management device 200 in order to obtain the money amount data (Step S702). Then, in response to this request signal, the money management device 200 transmits the newest money-management-device money amount to the teller machine 100. When normally receiving this money-management-device money amount (Step S703), the teller machine 100 obtains the newest money-management-device money amount (Step S704).

If some abnormality in the communication occurs during this transmission and reception for the money amount-acquisition request signal and newest money-management-device money amount, between the teller machine 100 and the money management device 200, a money amount-data-acquisition error is generated (Step S705). Then, the process cannot be continued any longer, and is thus terminated because of the communication abnormality.

Meanwhile, if the newest money-management-device money amount can be normally obtained from the money management device 200, the teller machine 100 performs a clear check as follows (Step S706).

Namely, upon this clear check, the teller machine 100 checks whether or not any one of the machine money amount, post money amount and money-management-device money amount exceeds a limit amount of money that can remain. In this case, the teller machine 100 first performs a money amount limit check on the money management device 200. Namely, in this checking operation, the teller machine 100 checks whether or not the newest money-management-device money amount exceeds the limit amount of money that can remain in the money management device 200. Then, in addition to the money amount limit check on the money-management-device money amount, the teller machine 100 also performs the money amount limit check on the machine money amount as well as on the post money amount. Namely, the teller machine 100 checks whether or not the machine money amount or post money amount exceeds the limit amount of money that can remain.

As a result of this clear check, if any one of the money-management-device money amount, machine money amount and post money amount exceeds the limit amount of money that can remain, the money of such a money amount should be transferred to the main safe in order to adequately reduce this money amount to be equal to or smaller than the limit amount of money that can remain. Therefore, the data clear process cannot be continued any longer, and is hence stopped.

After the clear check in the teller machine 100 is ended (Step S706) or when the data clear process is selected in the teller machine 100 (Step S700), and if the teller machine 100 is set to be “disconnected” from the money management device 200 (Step S701), the teller machine 100 searches and refers to the cooperation process information registered in the process information management database 400 provided to this teller machine 100, and checks the presence or absence of any cooperation process information including the cooperation process that is already set and still remaining unprocessed, or checks the process condition of each of the cooperation process information (Step S707).

Of course, when the data clear process is selected in the teller machine 100 (Step S700), and if the teller machine 100 is set to be “disconnected” from the money management device 200 (Step S701), the teller machine 100 does not perform the acquisition of the money-management-device money amount from the money management device 200.

As a result of the above check on the process condition of each of the cooperation process information, if the unprocessed cooperation process information is present, the checking screen for indicating the presence of the unprocessed cooperation process information is displayed (Step S708). Thus, the selection and input of either of continuation or cancel of the data clear process can be received on this checking screen.

If the data clear process is cancelled, the data clear process about to be performed is stopped. In this case, however, it is preferred to inspect whether or not the unprocessed cooperation process information is attributable to some mismatch between the deposited money and the dispensed money, or attributable to the cooperation process information mistakenly processed, or the like. Further, in this case, if the unprocessed cooperation process is in a state that can be immediately performed, this cooperation process may be performed immediately, and thereafter the data clear process may be performed later again. Meanwhile, if the unprocessed cooperation process is in a state that cannot be performed immediately (e.g., on the day of this data clear process), this cooperation process may be performed on the next day. Preferably, in the case in which the unprocessed cooperation process is performed on the next day and in which the data clear process is performed again, the money amount related to such an unprocessed cooperation process is included in the in-hand money amount.

Thus, in the money management system and money management method respectively related to one embodiment of the present invention, the unprocessed cooperation process can be securely checked and performed, without being left indefinitely unprocessed.

Meanwhile, if it is found that the unprocessed cooperation process is attributable to the cooperation process information mistakenly prepared and registered, and is thus unproblematic to further continuation of the data clear process, the continuation of this data clear process is selected. Then, “Continuation print”, indicating that the data clear process is forcedly continued although the unprocessed cooperation process is present, is outputted, as a certification print, onto a journal on which the result of the respective deposit/dispense processes for the day of this data clear process is printed (Step S710). Then, after this printing process, the data clear process is continued.

In the case in which there is no unprocessed cooperation process information, and thus the data clear process is continued, or in the case in which the data clear process is forcedly continued although the unprocessed cooperation process information is present, a transaction history file is outputted (Step S711). Once this transaction history file is outputted, the cooperation process information for the day of this data clear process, including the unprocessed cooperation process information, is cleared from the process information management database 400 (Step S712). Thus, this cooperation process information is brought into a data clear state or status (Step S713). Then, a simplified print process is performed for recording that the data clear process was performed. Further, in the case in which the teller machine 100 is set to be “connected” with the money management device 200, the teller machine 100 transmits data clear information, as a data clear request, for indicating that the cooperation process information in the process information management database 400 of teller machine 100 is brought into the data clear state, to the money management device 200. In this case, the date of the day of this data clear process is added, as business day information, to the data clear information.

Meanwhile, once receiving the data clear information (or data clear request) from the teller machine 100, the money management device 200 also starts the data clear process (Step S720). Namely, the money management device 200 prepares the electronic journal file for the storage/take-out process performed in this money management device 200, on the business day of the data clear process, in order to determine the electronic journal file (or transaction history file) for the day of this data clear process (Step S721). Then, the so-determined electronic journal file is stored in a predetermined master file holder, while being stored in an FTP file transfer holder provided for transferring this file to the teller machine 100 (Step S722). In this way, once the teller machine 100 obtains the electronic journal file from the FTP file transfer holder and stores this file in the hard disk drive 15g (Step S714), the teller machine 100 clears the electronic journal file, by remote control, from the FTP file transfer holder of the money management device 200. Thus, the data clear process in the money management device 200 is ended (Step S723), while the data clear process in the teller machine 100 is also ended (Step S715).

Thereafter, the date of the next business day is displayed on a next-business-day confirmation screen of the teller machine 100, for confirmation of the next business day. If the date is correct, the indication of “Yes” is selected and received, and then this checking process is ended. Meanwhile, if the date is not correct, a correct date is inputted and received, and then the checking process is ended.

A master of each electronic journal file prepared in the money management device 200 is managed, for each date, and stored in the predetermined master file holder of the hard disk drive 225g. This master file is continuously stored and managed, even after the electronic journal file in the FTP file transfer holder is cleared. The storage period of this master file is determined, based on the settings of the teller machine 100. For instance, this master file may be continuously stored and managed as long as the hard ware constituting the money management device 200 can store it therein. Otherwise, completely different file storage periods may be set, respectively, for both of the teller machine 100 and money management device 200.

Further, each electronic journal file that is prepared in the money management device 200 and stored in the FTP file transfer holder, as the electronic journal file that will be transferred to the teller machine 100, may also be stored in the holder, as an unobtained file, for a predetermined period of time, for example, at most 300 days or so. This is because there is a risk that an error may occur upon acquisition of the file, for example, at a communication terminal or the like, in the teller machine 100. Further, this continuous storage of each unobtained electronic journal file in the FTP file transfer holder, for such a predetermined period of time as described above, can allow the teller machine 100 to securely obtain the electronic journal file from the FTP file transfer holder of the money management device 200. Namely, even if the teller machine 100 fails to obtain the electronic journal file, on the day of the storage of this electronic journal file in the FTP file transfer holder, because of some inconvenience in the communication condition or the like, the teller machine 100 can obtain such an unobtained electronic journal file stored in the FTP file transfer holder, upon the data clear process for the next day or later, together with the other unobtained electronic journal files for the next business day.

If the acquisition of the electronic journal file is ended abnormally, the teller machine 100 outputs an electronic-journal-file-acquisition-NG continuation print, as the certification print, and then continues the process. Further, if the teller machine 100 is set to be “disconnected” from the money management device 200, the acquisition of the electronic journal files is not performed.

Preferably, the content of each electronic journal of the money management device 200 obtained by the teller machine 100 due to FTP file transfer can be optionally referred to or printed by performing, for example, a “Data inquiry” process and an “Electronic journal inquiry” process, in succession, in the teller machine 100.

However, if the electronic journal to be searched cannot be found out by performing the electronic journal inquiry in the casher machine 100, the teller machine 100 searches the predetermined master holder of the money management device 200, via the communication line, in order to obtain this electronic journal.

By the way, if the business day designated upon the electronic journal inquiry in the teller machine 100 is the day of this inquiry, the electronic journal that has been already obtained from the money management device 200 is not always the newest one. Therefore, for each electronic journal inquiry, the electronic journal that can be considered as the newest one at each point of time should be obtained, without exception, from the money management device 200.

The electronic journal inquiry for the day of this inquiry is performed, for example, for checking whether or not the deposit/dispense process scheduled to be performed on the business day of this inquiry has been already performed at a certain point of time. Further, in the case in which the money management system includes one teller machine 100 and the plurality of money management devices 200, the electronic journal inquiry for the day of this inquiry can also be utilized, in order to collectively manage and refer to similar files, respectively managed in the plurality of money management device 200.

Now, one exemplary procedure for obtaining the electronic journal file upon each electronic journal inquiry in the teller machine 100 in the money management system and money management device, respectively related to one embodiment of the present invention, will be described.

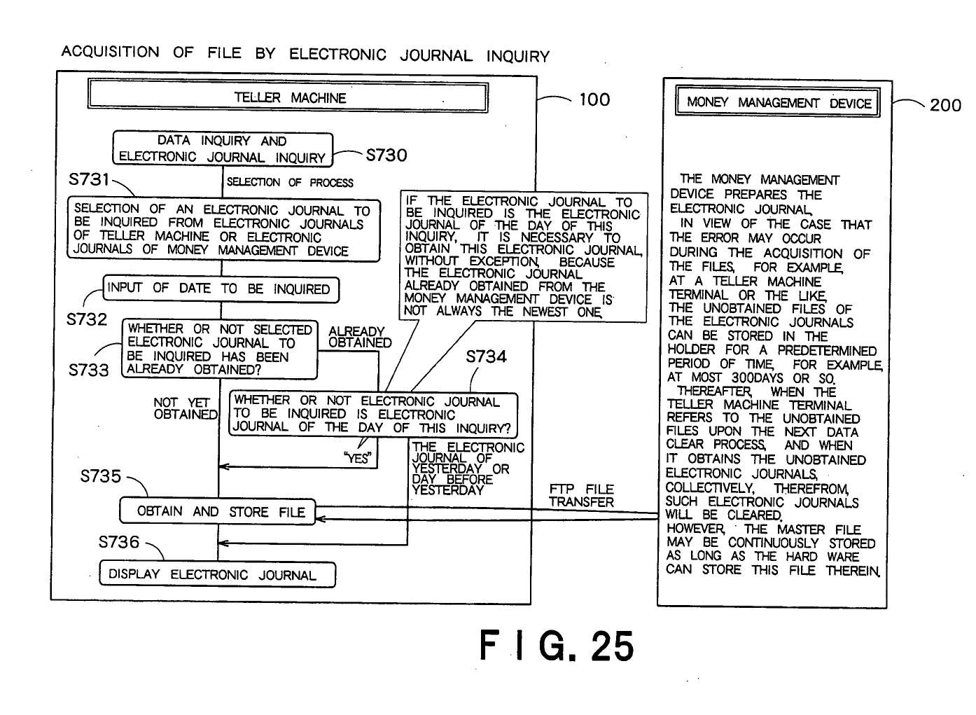

FIG. 25 schematically illustrates the procedure for obtaining the electronic journal file upon each electronic journal inquiry in the teller machine 100 in the money management system and money management method, respectively related to one embodiment of the present invention.

First, in the teller machine 100, the indications of “Data inquiry” and “Electronic journal inquiry” are selected, in succession, from the menu, in order to select the electronic journal inquiry process (Step S730).

After the electronic journal inquiry process is selected, the electronic journal to be inquired is selected from the electronic journals of the teller machine 100 or electronic journals of the money management device 200 (Step S731).

After the electronic journal to be inquired is selected, the date to be inquired is inputted (Step S732).

Thereafter, whether or not the selected electronic journal to be inquired has been already obtained is recognized (Step S733).

Namely, if the selected electronic journal to be inquired is included in the electronic journals of the teller machine 100, such an electronic journal is always recorded and stored in the teller machine 100, and thus can be recognized as one already obtained. However, in the case in which the selected electronic journal to be inquired is included in the electronic journals of the money management device 200, such an electronic journal is not always obtained and stored in the teller machine 100. Therefore, at this point of time, it is necessary to recognize whether or not the selected electronic journal to be inquired has been already obtained in the teller machine 100.

If the selected electronic journal to be inquired is already obtained in the teller machine 100, whether or not this electronic journal to be inquired is the electronic journal for the day of this inquiry is further recognized, based on the inputted date (Step S734).

As a result, if the selected electronic journal to be inquired is the electronic journal obtained on the previous day or before, this electronic journal should be already obtained in the teller machine 100, irrespectively of whether this electronic journal is included in the electronic journals of the teller machine 100 or included in the electronic journals of the money management device 200. Therefore, the teller machine 100 displays this electronic journal (Step S736).

Meanwhile, if the selected electronic journal to be inquired is included in the electronic journals of the money management device 200, and is the electronic journal for the day of this inquiry, the electronic journal that can be considered or regarded as the newest one, at this point of time, should be obtained, without exception, from the money management device 200, and stored in the casher machine 100 (Step S735). This is because the electronic journal that has been already obtained from the money management device 200 is not always the newest one. Then, the electronic journal that can be considered as the newest one is displayed (Step S736).

In the case in which the electronic journal to be inquired is included in the electronic journals of the teller machine 100, this electronic journal stored in the teller machine 100 is the electronic journal of the newest version or last version, irrespectively of whether this electronic journal is the electronic journal for the day of this inquiry or electronic journal for the previous day or before. Therefore, this electronic journal is displayed (Step S736).

Now, alteration of the status of the cooperation process information will be described. In regard to the cooperation process information, it is sometimes necessary to alter the status of this information after the preparation and registration thereof. Thus, one example of this status alteration will be described.

In the case of storing the money into the money management device 200, the unit of the number of the banknotes, for each banknote bundle, is one hundred, while the unit of the number of the coins, for each coin roll or wrapped coin, is fifty. Therefore, in the case of the storage process for the banknotes, the banknotes are deposited or stored in the money management device 200, as one batch of banknote bundle, each time the number of the banknotes reaches one hundred. Meanwhile, in the case of the storage process for the coins, the coins are deposited or stored in the money management device 200, as one coin roll or wrapped coin, each time the number of the coins reaches fifty.

Therefore, depending on a certain denomination and/or amount of money upon the storage process, a part or all of the money cannot be stored in the money management device 200. In this case, the money that cannot be stored in the money management device 200 can be held as the money manually managed, and thus the storage process for storing such money into the money management device 200 will remain as the unprocessed operation.

Further, in some cases, one person in charge of the operation that is not authorized to operate the money management device 200 prepares and registers the cooperation process information including the storage/take-out process in the money management device 200. However, in such a case, another person that is authorized to operate the money management device 200 will be forcedly set as the person in charge of actually carrying out this storage/take-out process in the money management device 200. In this case, if it is desired later to handle the money related to this deposit/dispense (or storage/take-out) process, as the money manually managed, it is necessary to alter the status of the cooperation process information.

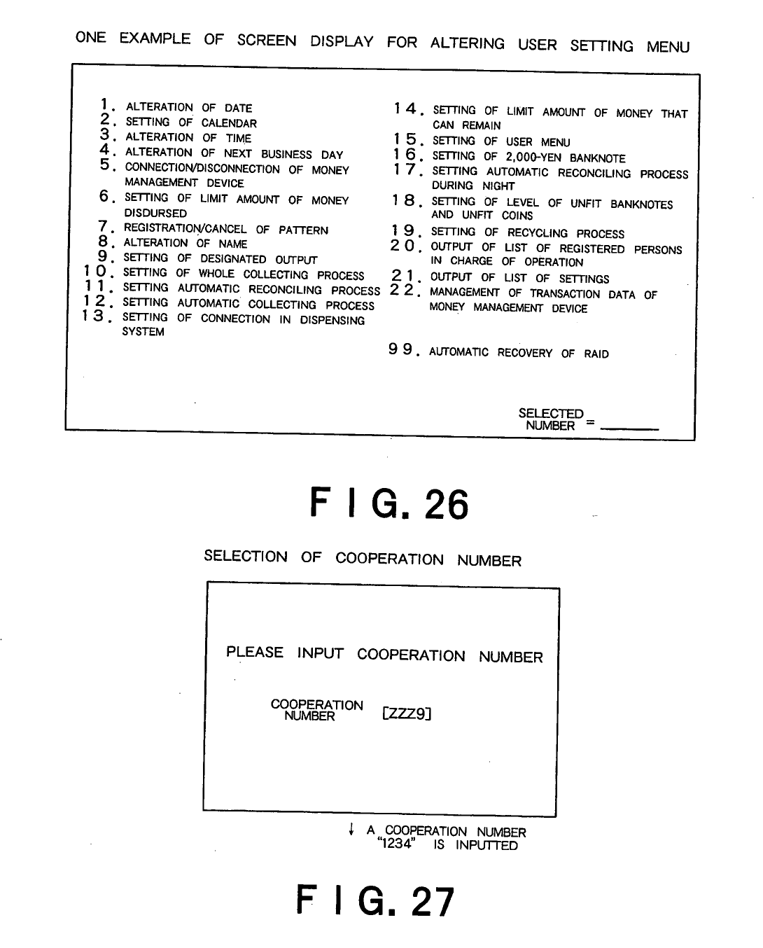

FIG. 26 illustrates one example of the screen display of the user setting menu for altering the settings.

For instance, in the example of the screen display shown in FIG. 26, an item or indication of “Money management device transaction data” is designated by selection numeral 22. Namely, if it is desired to alter the status of the cooperation process information including the deposit/dispense process of the money management device 200, this selection number 22 is inputted.

FIG. 27 illustrates one example of the screen display for receiving the input of each cooperation number for specifying the cooperation process information to be altered in the status.

In order to alter the status of the cooperation process information, the item of “Money management device transaction data” designated by the selection numeral 22 in FIG. 26 is selected from the user setting menu provided for altering the settings. Then, a cooperation number input screen as shown in FIG. 27 is displayed for receiving the input of the cooperation number for specifying the cooperation process information to be altered in the status.

For instance, in regard to the cooperation process information of the cooperation number “1234”, assume that this cooperation process information, concerning the storage (or depositing) process for storing the money, e.g., one million yen, into the money management device 200, is first prepared and registered, and then it is desired to alter the mode for handling this one-million-yen money, from the mode for handling the money by the money management device into the mode for handling the money under manual management. Namely, with respect to this alteration of the handling mode, the case in which the status of this cooperation process information is altered, from the “Unprocessed” status to the “Processed” status, will be described, by way of example.

Once the cooperation number “1234” is inputted on the cooperation number input screen shown in FIG. 27, the cooperation process information corresponding to this cooperation number “1234” is searched, and then the content of this cooperation process information is displayed on the screen.

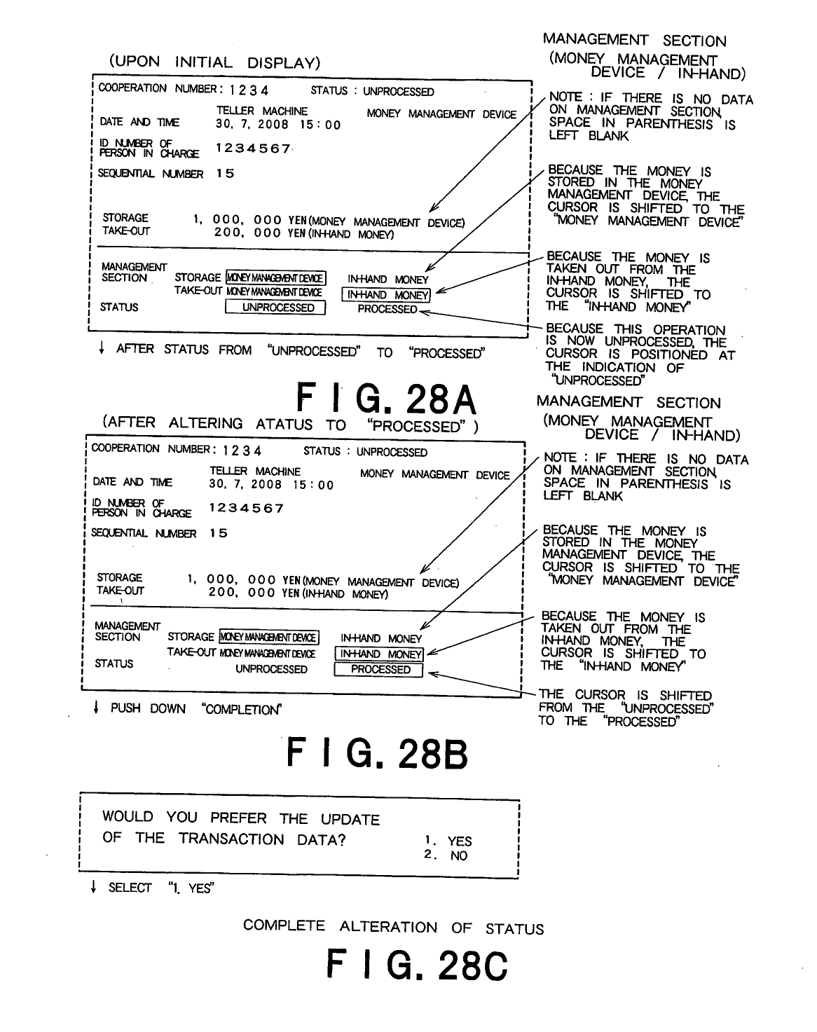

FIGS. 28A through 28C are respectively provided for illustrating one example of the screen display of the cooperation process information (FIGS. 28A and 28B) and another example of the screen display for confirming the status alteration of the cooperation process information (FIG. 28C). More specifically, FIG. 28A shows one example of the screen display of the cooperation process information before the status alteration, i.e., the screen display of an initial state or status of this information. FIG. 28B shows one example of the screen display of the cooperation process information after the cursor position is shifted, for the status alteration, from the item of “Unprocessed” to the item of “Processed”. Further, FIG. 28C shows one example of the screen display for confirming the status alteration of the cooperation process information.

As shown in FIG. 28A, each section for managing or handling the money related to the deposit/dispense operation and set in the cooperation process information, and each status, i.e., the “Unprocessed” status or “Processed” status, are respectively displayed by using the cursor, as the content currently registered. In this example, the section for managing or handling the money (in this case, one million yen) in the storage process is the “Money management device”, while the section for managing or handling the money (in this case, two hundred thousand yen) in the take-out process is “In-hand (money or management)”. Further, in this case, the state of the take-out/storage process for the money is indicated as “Unprocessed”.

Then, in this example of the screen display of the cooperation process information, the cursor that has been so far positioned at the status item of “Unprocessed” is shifted to the status item of “Processed”, as shown in FIG. 28B, in order to alter the management for the one million yen that has been scheduled to be stored in the money management device 200, from the management under the money management device to the manual management.

Thereafter, when the “Completion” key is pushed down, the confirmation screen for confirming the alteration or update of the status of the cooperation process information is displayed, as shown in FIG. 28C. In this case, if the item of “1. Yes” is selected and inputted, the status alteration for the cooperation process information of the cooperation number “1234” is completed.

In this manner, the management or handling for the one million yen that has been set in the cooperation process information of the cooperation number “1234” can be altered from the management under the money management device to the manual management.

The above operations as respectively described with reference to FIG. 26˜FIGS. 28A through 28C and the screen displays as respectively shown in FIG. 26˜FIGS. 28A through 28C can be all performed in the teller machine 100 or money management device 200.

### Second Embodiment

The second embodiment is related to the money transfer operation between the money management device 200 and the main safe, as well as related to the money transfer operation between the money management device 200 and the in-hand money of the banker. Now, referring again to FIG. 12, this second embodiment will be described.

As described above, when the amount of money stored in the teller machine 100 is less than required, the money will be taken out from the main safe in order to refill the teller machine 100 with the money. Meanwhile, when the amount of money is too much to be all stored in the casher machine 100, such money will be once collected from the teller machine 100 and stored in the main safe. In the case of collecting the cash from the teller machine 100, the money amount of the funds is shifted from the machine money amount to the stock money amount, via the in-hand money amount. Meanwhile, in the case of refilling the teller machine 100 with the cash, the money amount of the funds is shifted from the stock money amount to the machine money amount, via the in-hand money amount.

Alternatively, in the case in which the amount of money stored in the teller machine 100 is less than required, the money may be taken out from the money management device 200 in order to refill the teller machine 100 with the money. Meanwhile, in the case in which the amount of money is too much to be all deposited into the casher machine 100, such money may be collected from the teller machine 100 and stored in the money management device 200. In either case, the transferred money is once managed as the “In-hand money of the banker”. Accordingly, in the case of collecting the cash from the teller machine 100, the money amount is once shifted from the machine money amount to the in-hand money amount, and then shifted from the in-hand money amount to the money-management-device money amount. Meanwhile, in the case of refilling the teller machine 100 with the cash, the money amount is once shifted from the money-management-device money amount to the in-hand money amount, and then shifted from the in-hand money amount to the machine money amount. Namely, in the above cases, the money is once transferred via the in-hand money amount. However, if required, this money transfer operation via the in-hand money amount may be omitted or eliminated.

Further, when the amount of money stored in the money management device 200 is less than required, the money will be taken out from the main safe in order to refill the money management device 200 with the money. Otherwise, this money management device 200 may be refilled with the money from the in-hand money amount. Meanwhile, when the amount of money is too much to be all deposited into the money management device 200, such money will be collected from the money management device 200 and stored in the main safe. Otherwise, such money may be managed as the in-hand money amount. In this case, the in-hand money amount and the other money amounts are not changed, respectively.

As described above, in all of the money transfer operations for the funds, each money amount is managed by the teller machine 100. Namely, the teller machine 100 can serve to manage the machine money amount thereof, post money amount and stock money amount in the safe, as well as can collectively manage the in-hand money amount including the money amount of the in-hand money of the banker and the money-management-device money amount.

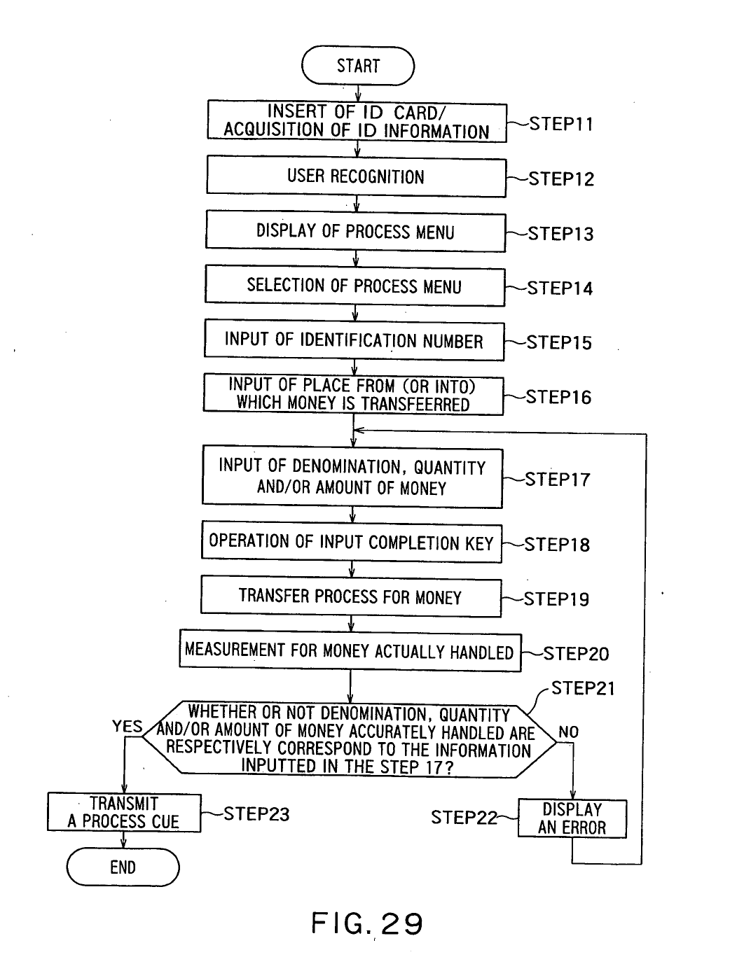

Next, referring to the flow chart of FIG. 29, one example of the operation of the money handling system related to this embodiment will be described.

In this case, the operator for the money management device 200 may be either of the person in charge of accounts (i.e., the cashier) or usual banker (i.e., the teller). As used herein, the “person in charge of accounts (or cashier)” refers to the person having the higher-ranking authority that is authorized to carry out all of the deposit/dispense operations using both of the teller machine 100 and money management device 200. Meanwhile, the “usual banker (or teller)” refers to the person in charge of directly dealing with the customer at the teller or the like place in the branch of the financial institution, and serves as the banker having the lower-ranking authority that is authorized to carry out the deposit/dispense operation for handling the money equal to or less than a given limit amount thereof by using only the teller machine 100.

Hereinafter, the operation in the case in which the operator for the money management device 200 is the banker will be described.

### (Refill Process)

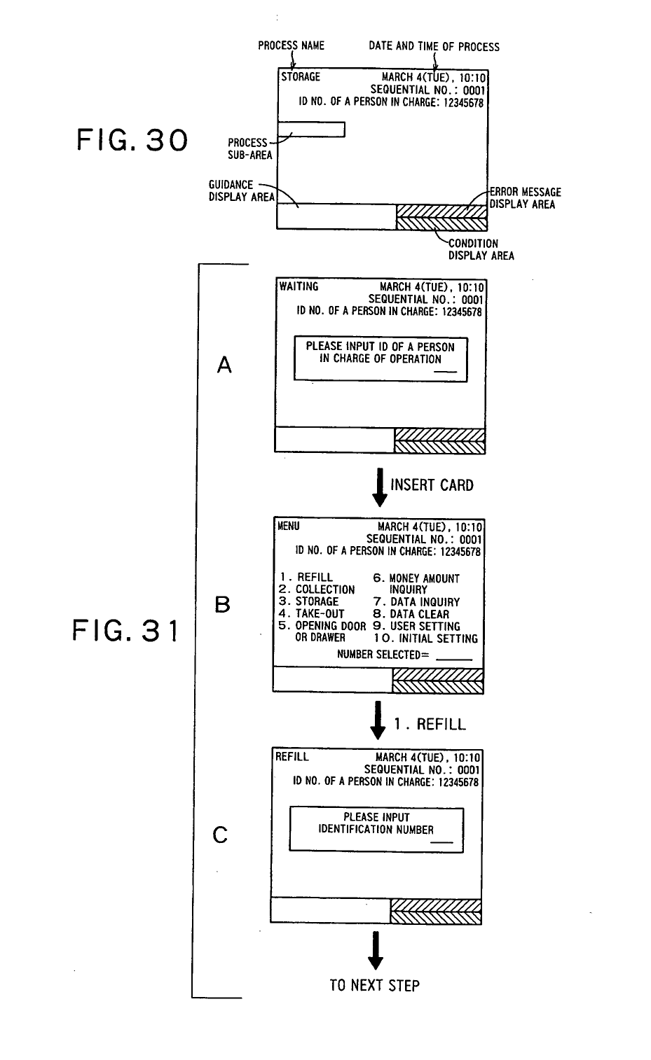

The flow chart of FIG. 29 illustrates one example of the deposit/dispense process performed in the money management device 200. Further, FIG. 30 and FIGS. 31A through 32D respectively show the screen displayed on the display section 227 of the money management device 200.

First, referring to FIG. 30, each part of the display section 227 of the money management device 200 will be described. Namely, in an upper part of this display section 227, “Process name”, “Date and time of the process”, “Sequential number”, “Number of the person in charge of the process” and “Process sub-area” are displayed, respectively. The sequential number is provided, as one of sequential numbers incremented or counted up each time a new process is started in a series of processes, for indicating the number of times of the deposit/dispense processes that have been so far performed. The process sub-area is provided for indicating the details of each process in the series of processes. Further, in a lower part of the display section 227, the “Guidance display area” for guiding each operation, “Error message area” and “Condition display area” for displaying the information on the process during the operation are provided, respectively. Additionally, in a middle part of the display section 227, the main contents, such as the menu, guidance, denomination of money, quantity and/or amount of money and the like, can be displayed, respectively. The condition display area is provided for indicating the condition of the money management device 200, in the case in which the “Error” is displayed, or the like.

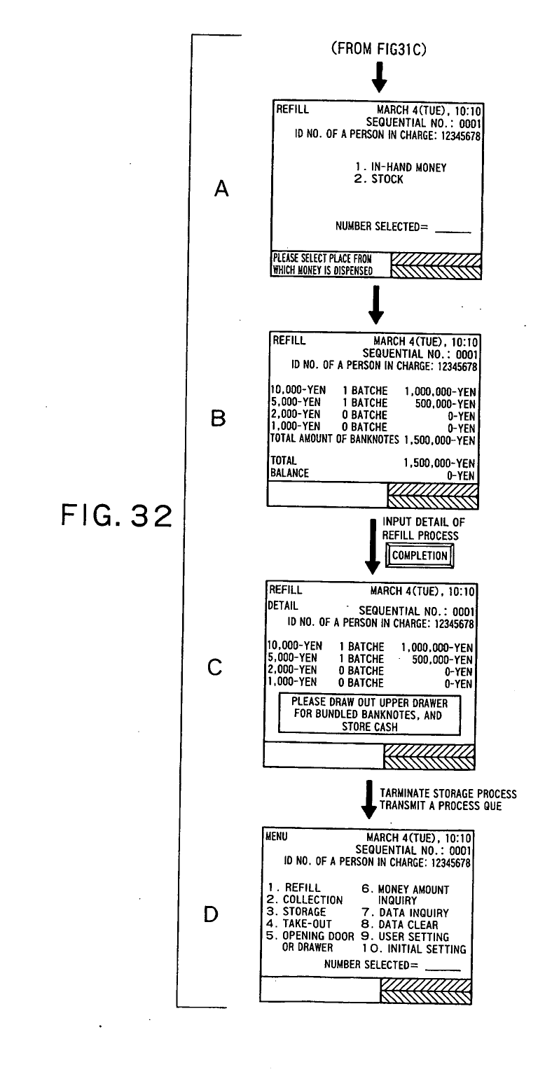

Next, referring to each step of FIG. 29 as well as to each screen display of FIGS. 31A through 32D, the operation of the money management device 200 will be described.

Initially, the display section 227 is in a state as shown in FIG. 31A. In this state, when the banker inserts the ID card through the ID card reader 228, the ID information on this banker is read by the ID card reader 228 in the money management device 200 (Step 11 in FIG. 29). Then, based on this ID information, whether or not the banker is the person that is permitted to operate the money management device 200 is recognized (Step 12).

If this banker is the person permitted to operate the money management device 200, the operation menu shown in FIG. 31B is displayed on the display section 227 (Step 13). Then, while watching this display, the banker inputs the process content by using the keyboard operation section 226 (Step 14). In this case, an item of “1. Refill” shown in FIG. 31B indicates a process for refilling the money management device 200 with the money from the “In-hand money of the banker” or “stock (i.e., the main safe)”, and an item of “2. Collection” indicates a process for collecting the money from the money management device 200 into the “In-hand money of the banker” or “Stock (i.e., the main safe)”. Further, an item of “3. Storage” indicates a process for storing the money deposited from the customer into the money management device 200, and an item of “4. Take-out” indicates a process for taking out the money from the money management device 200 in order to disburse the money to the customer.

For instance, when the amount of money stored in the money management device 200 is less than required, the banker selects the item of “1. Refill”. Alternatively, when the amount of money is too much to be all deposited into the money management device 200, the banker selects the item of “2. Collection”. Further, in the case in which the banker receives the money from the customer at the counter and then stores this money into the money management device 200, the banker selects the item of “3. Storage”. Contrary, in the case in which the banker takes out the money from the money management device 200 in order to dispense the money to the customer at the counter, the banker selects the item of “4. Take-out”.

Because the other items of “5 to 10” in the operational menu displayed in FIG. 31B are not directly related to the present invention, the description on such items is now omitted.

In the Step 14 of FIG. 29, the banker selects any one of the items of “1 to 4” in the operational menu. In this case, as shown in FIGS. 31B and 31C, the item of “1. Refill” is selected. Namely, in this embodiment, the process for refilling the money management device 200 with the money from the in-hand money of the banker or stock (i.e., the main safe) is performed.

Further, in the screen of FIG. 31C, the banker inputs the identification number for enhancing the security (Step 15).

Once the identification number is checked, the banker selects the place or section from which the money is dispensed (or place or section from which the money is used for the refill process), by using the keyboard operation section 226 (Step 16). In this case, as shown in FIG. 32A, the place from which the money is dispensed is either one of the “1. In-hand money” or “2. Stock”. In the case of refilling the money management device 200 with the money from the main safe, the banker selects the item of “2. Stock”. Meanwhile, in the case of refilling the money management device 200 with the money from the “In-hand money of the banker”, the banker selects the item of “1. In-hand money”.

It is noted that the items of “1. In-hand money” and “In-hand money of the banker” in the displayed menu respectively refer to the money handled and managed, at hand, by the banker. As described above with reference to FIG. 12, the “In-hand money amount” includes not only the money amount of the “In-hand money of the banker” but also the money-management-device money amount. Accordingly, it should be noted that the “1. In-hand” and “In-hand money of the banker” in the displayed menu are respectively different, in a sense, from the “In-hand money amount” shown in FIG. 8.

Thereafter, the banker inputs the details of the deposit/dispense operation, by using the keyboard operation section 226 (Step 17). More specifically, as shown in FIG. 32B, the data on the denomination of money and the number of the bundles (or coin rolls) to be deposited and/or dispensed are inputted, respectively. While only the information on the banknotes is displayed in FIG. 32B, the information on the coins may be added in the case in which the coins are also handled.

Thereafter, when the banker pushes down the input completion key, the completion of the input operation is detected, (Step 18). In this way, once this input operation is completed, guidance for guiding the operator (i.e., the banker) to refill the money management device 200 with the cash is displayed as shown in FIG. 32C, and then each related drawer or door in this money management device 200 is automatically opened.

Then, the banker refills the money management device 200 with the money, in accordance with the details (i.e., the denomination of money and number of bundles or coin rolls) of the deposit/dispense operation inputted in the Step 17 (Step 19). As used herein, a sign of “.” indicates “and”, while a sign of “/” denotes “or”. The banker refills the money management device 200 with the money, based on the inputted denomination or denominations as well as on the inputted quantity of the money. At this time, if the banker selects the item of “2. Stock” in the above Step 16, the banker dispenses the money from the main safe, and refills the money management device 200 with the dispensed money. Meanwhile, if the banker selects the item of “1. In-hand” in the Step 16, the banker refills the money management device 200 with the money of the “In-hand money of the banker”.

Then, the weight of the money actually refilled is measured on the load cell 261 of the money management device 200 (Step 20). For instance, this weight measurement for the money is started, in response to the closing operation for each drawer or door by the operator, after this drawer is refilled with the money. Namely, when each of the closing balance operation detectors 211c to 215c detects the closing balance operation for each corresponding door or drawer, the weight measurement for the money is started. Of course, in this case, since the money management device 200 can serve to automatically measure the money, it is not necessary for the banker to be directly concerned with this measurement. Otherwise, this measurement for the money may be performed, when the banker pushes down a proper key of the keyboard operation section 226.

More specifically, the weight measurement for the money can be performed by subtracting a measurement value obtained before each door or drawer of the money management device 200 is opened, from the measurement value obtained after this door or drawer is closed. Each measurement value corresponds to the number of the banknote bundles or coin rolls, for each denomination of money, measured by the load cell 261. Further, this subtraction is performed by the control unit 225c.

If the denomination of money and number of banknote bundles or coin rolls of the money actually used for the refill process (i.e., the weight of the money measured by the load cell 261) are not respectively coincident with the denomination of money and number of bundles or coin rolls, respectively inputted by the banker in the Step 17 (i.e., “NO” in the Step 21), the money management device 200 displays the error message on the error message display area, as well as displays a message or indication, on the condition display area, for indicating that the denomination of money and number of the bundles or coin rolls of the money actually used for the refill process do not correspond to the inputted information (Step 22). At the same time, the money management device 200 performs again each process from the Step 17. At this time, in order to save the time and labor of the banker for inputting again the denomination of money and number of the bundles or coin rolls as well as to check any mistake upon the input operation, it is preferred that the previous input information as shown in FIG. 32B is displayed on the display section 227. More preferably, each door or drawer of the money management device 200 may be automatically opened, when the banker can refill again the money management device 200 with the money. In place of or in addition to the aforementioned display of the error message, the banker may be informed of occurrence of the error, by a sound or voice, via a speaker (not shown) provided to the money management device 200.

Meanwhile, in the case in which the denomination of money and number of the bundles or coin rolls of the money actually used for the refill process respectively correspond to the information on the money inputted in the Step 17 (i.e., “Yes” in the Step 20), the money management device 200 transmits one series of process information, as the process cue, to the teller machine 100, via the interface 229 (Step 23). This transmission of the process cue is automatically performed, depending on the measurement result on the money in the Step 20. Namely, in response to the closing operation for the door or drawer, or in response to the push down operation for a corresponding key, by the banker, the Steps 20 through 23 are automatically performed, respectively. Accordingly, the banker need not directly measure the weight of the money, nor directly transmit the process cue.

After the process cue is transmitted, the menu is displayed, as shown in FIG. 32D, similar to the case shown in FIG. 31B. Otherwise, by a log-out operation carried out by the banker, the screen display returns to the display of the waiting state shown in FIG. 31A.

Then, the money management device 200 stores the process cue in the RAM 225e or hard disk 225g, while updating the information on the money-management-device money amount (i.e., a part of the in-hand money amount) that is managed by this device 200.

In this manner, the series of operations for refilling the money management device 200 with the money are completed.

Next, the process cue will be discussed.

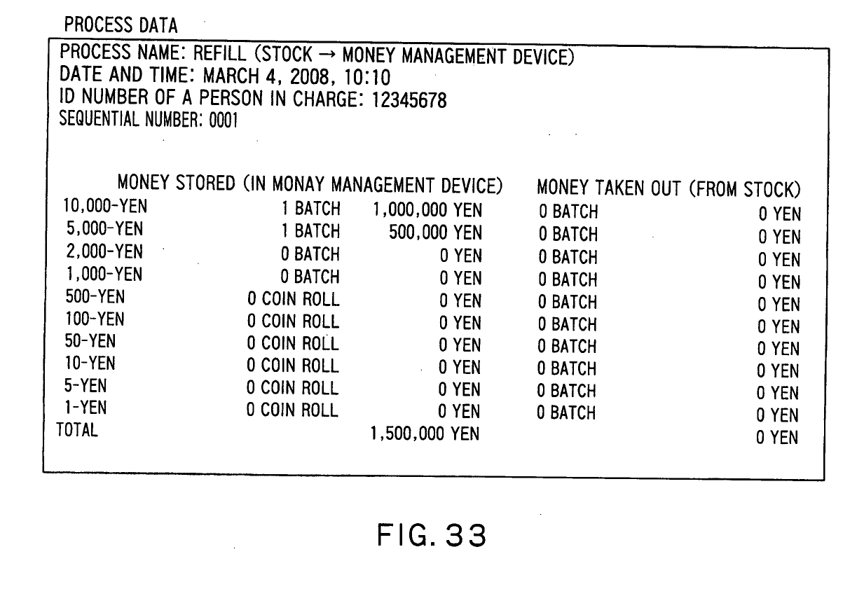

FIG. 33 illustrates the process data displayed on the display section 227 of the money management device 200. This process data includes the process name, the date and time of the process, the number of the person in charge of the process, the sequential number, the denomination (or denominations), quantity and/or amount of money stored in the money management device 200 during the process or denomination (or denominations), quantity and/or amount of money taken out from the money management device 200 during the process. It is noted that the “quantity” refers to the number of batch of the banknote bundles or number of the coin rolls or wrapped coins. Usually, each bundle of the banknotes (or banknote bundle) is prepared by bundling a predetermined number of banknotes, while each wrapped coin or coin roll is prepared by wrapping a predetermined number of coins. Accordingly, the amount of money can be calculated from the denomination and quantity of the money. Therefore, in the above example of the refill process, the input of the amount of money is omitted. However, in order to achieve more accurate and rapid management on the money handled in the process, the information on the amount of money may also be inputted to the money management device, in addition to the input of the denomination and quantity of the money.

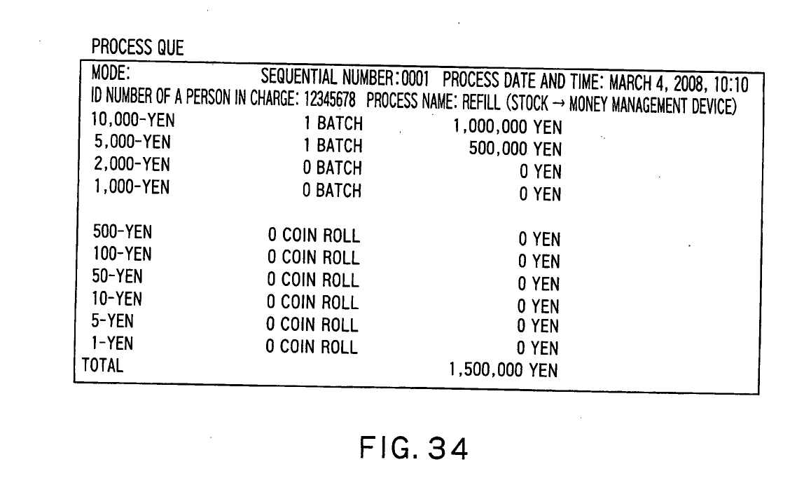

The input information shown in FIG. 32B is reflected in the content shown in FIG. 33. For instance, the item of “1. Refill” in the process menu selected in FIG. 31 (Step 14) is reflected in the process name of “Refill”. Further, the place from which the money is dispensed, e.g., the “2. Stock” selected in FIG. 32A (Step 16), is reflected in an indication of “Stock to Money management device” in parentheses of the process name. In addition, each of the denominations and quantities of the money respectively inputted, as shown in FIG. 32B (Step 17), is reflected in the denomination, quantity and/or amount of money of each denomination shown in FIG. 34.

In this case, the money management device 200 converts the process data into a suitable format that can be processed by the teller machine 100, and then stores the so-converted data, as the process cue, in the hard disk drive 225g or RAM 225e. For instance, FIG. 34 shows the content of one process cue displayed on the display section 227. In this embodiment, the money management device 200 does not include a mechanical counting section. Thus, the denomination and quantity of the money used for the refill process are manually inputted, respectively, as shown in the Step 17 of FIG. 29.

FIG. 34 displays the information on the money manually inputted in the money management device 200. As used herein, the “information on the money manually inputted” means the denomination and quantity of the money manually inputted by the banker in the Step 17 of FIG. 29.

In this case, the format of the process data may be unified with the format of the process cue. With this information processing, the need for converting the process data into the process cue can be eliminated.

In the case in which the teller machine 100 is always connected with the money management device 200 so as to communicate with each other, via the wireless LAN, optical LAN or the like, the money management device 200 can transmit the process cue, in real time, relative to the time that the refill process is performed.

Meanwhile, in the case in which the teller machine 100 and the money management device 200 are intermittently connected, by communication, with each other, the money management device 200 can temporarily stores the plurality of process data or process cues in the hard disk drive 225g or RAM 225e, during the off-line time that the money management device 200 is not connected, by communication, with the teller machine 100. Thereafter, during the on-line time that the money management device 200 is connected with the teller machine 100 so as to be able to communicate with each other, the money management device 200 will collectively transmit the untransmitted process cues stored in the hard disk drive 225g or RAM 225e to the teller machine 100.

Next, the process in the teller machine 100 after it receives the process cue will be described.

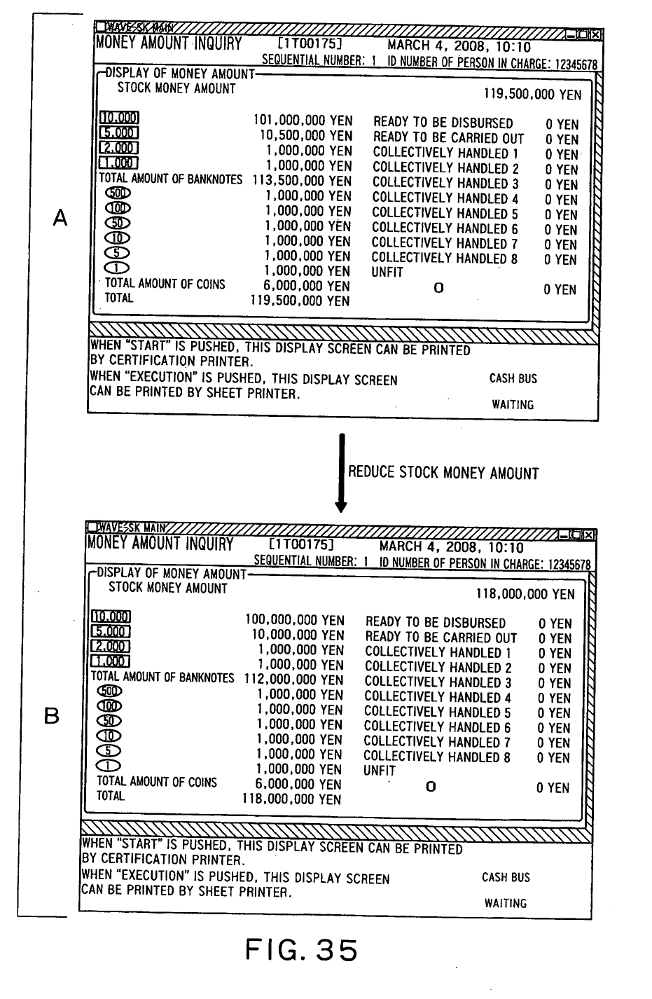

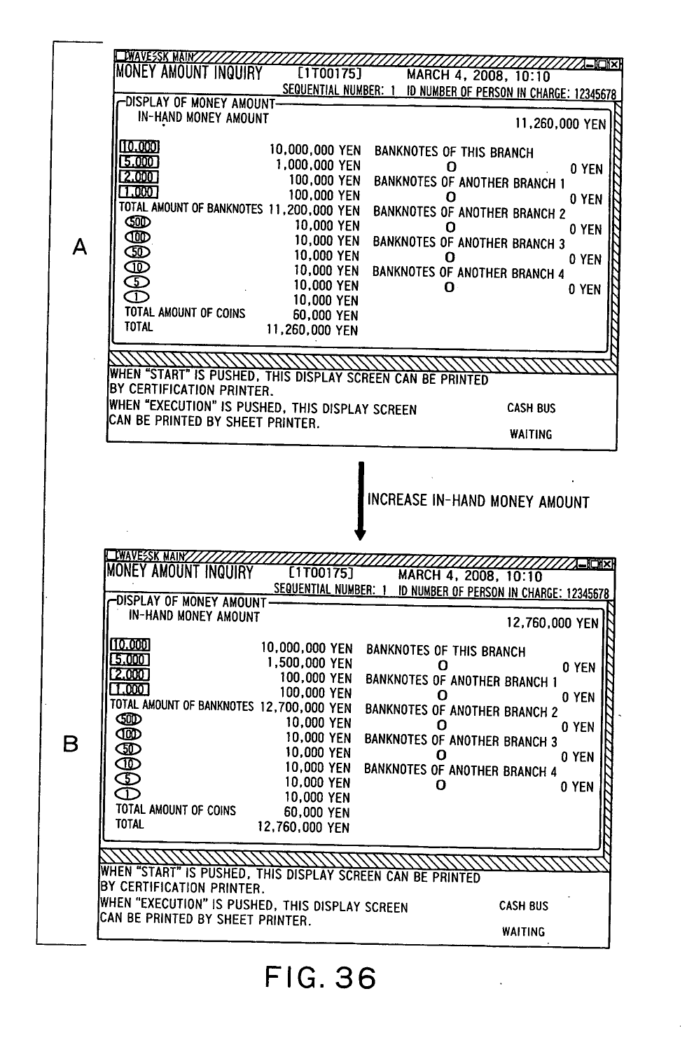

FIGS. 35A through 36B respectively show the screen displayed on the display section 15a of the teller machine 100 after it receives the process cue. Namely, once receiving the process cue via the interface 19, the teller machine 100 updates each money amount shown in FIG. 12, based on the information of this process cue.

Namely, from the process cue, the teller machine 100 can recognize that the refill process for refilling the money management device 200 with the money from the stock (or main safe) was performed. In this case, as shown in FIGS. 35A and 35B, the control unit 15c serves to subtract the amount of money used for this refill process, from the stock money amount. For this refill process, one batch of 10,000-yen banknote bundle (i.e., one hundred 10,000-yen banknotes) and one batch of 5,000-yen banknote bundle (i.e., one hundred 5,000-yen banknotes) are used, respectively. Therefore, the control unit 15c subtracts one million yen and a half million yen, respectively corresponding to the above denominations, from the money amount of the stock. As a result, the stock money amount is reduced as shown in FIG. 35B.

Meanwhile, as shown in FIGS. 36A and 36B, the control unit 15c adds the amount of money used for the refill process, to the in-hand money amount. In this process, since the one batch of 10,000-yen banknote bundle (i.e., one hundred 10,000-yen banknotes) and one batch of 5,000-yen banknote bundle (i.e., one hundred 5,000-yen banknotes) are respectively used for this refill process, the control unit 15c adds the one million yen and half million yen to the money of the respectively corresponding denominations. As a result, the in-hand money amount is increased as shown in FIG. 36B.

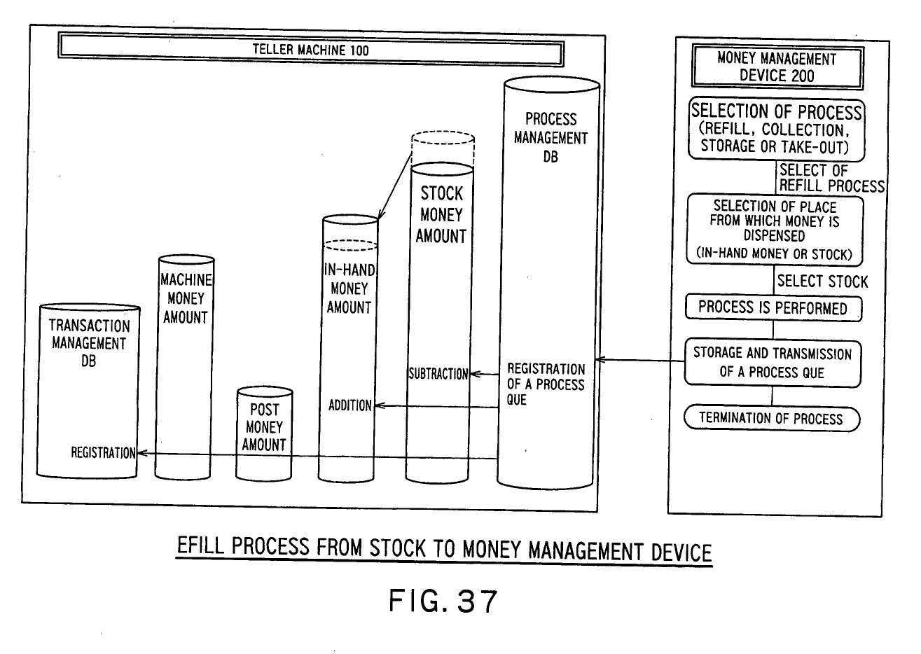

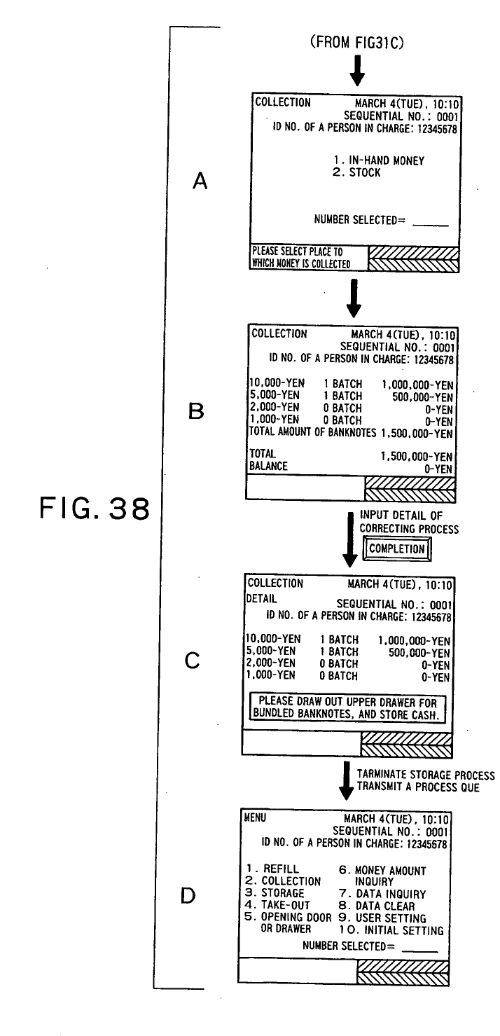

FIG. 37 schematically illustrates the flow or procedure of the whole refill process from the stock to the money management device 200. First, in the money management device 200, the banker selects the item of “Refill” as the process to be performed, as well as selects the item of “Stock” as the place from which the money is dispensed (Steps 14, 16 of FIG. 29). Once this refill process is performed, the money management device 200 stores therein the process cue, as well as transmits this process cue to the teller machine 100 (Step 23 of FIG. 29).

Once receiving the process cue, the teller machine 100 registers this process cue to the process management database. Thereafter, based on the content of this process cue, each money amount stored in the hard disk 15g is updated. In this embodiment, the money management device 200 is refilled with the money from the stock. Accordingly, in the teller machine 100, the control unit 15c subtracts the amount of money used for the refill process, from the stock money amount data, while adding the same amount of money, to the in-hand money amount data. At this time, the total amount of money stored in the teller machine 100 is not changed. Therefore, the machine money amount is unchanged.

If there is an unfit banknote included in the money used for the refill process, the quantity and amount of money of this unfit banknote is not added to the in-hand money amount data, but added to the post money amount data.

In FIG. 32A, when the item of “1. In-hand” is selected, each money amount shown in FIG. 37 is not changed unless the unfit banknote is included in the refill process. This is because the “money-management-device money amount” is one part of the “in-hand money amount”, as described above with reference to FIG. 12. However, in the case in which the “money-management-device money amount” is managed in the “in-hand money amount”, the total amount of money used for the refill process is shifted to the “money-management-device money amount” from the “in-hand money amount” other than the money-management-device money amount.

Each of the information on the process management database, transaction management database, stock money amount, in-hand money amount, post money amount and machine money amount is stored in the RAM 15e or hard disk drive 15g of the teller machine 100. Meanwhile, the subtraction and addition of each money amount is executed by the control unit 15c.

### (Collecting Process)

Now, referring to FIGS. 29, 31 and 38, the collecting process will be described. FIG. 38 shows the screen displayed, following FIG. 31C, on the display section 227 of the money management device 200, upon the collecting process.

The operations from the ID card insertion to the input of the identification number are respectively the same as those described in the Steps 11 through 15 respectively shown in FIG. 29. However, in this collecting process, the banker selects the item of “2. Collection” in FIG. 31B (Step 14). As a result, the process name (i.e., “Refill”) shown in FIG. 31C is changed into the “Collection”, as shown in FIGS. 38A through 38C.

Subsequently, the banker selects the place or section to which the funds are transferred, by using the keyboard operation section 226 (Step 16 of FIG. 29). In this collecting process, the place to which the funds are transferred is either one of the “1. In-hand money” or “2. Stock”, as shown in FIG. 38A. For instance, in the case in which the money is collected into the main safe from the money management device 200, the banker selects the item of “2. Stock”. Meanwhile, in the case in which the money is collected into the “in-hand of the banker” from the money management device 200, the banker selects the item of “1. In-hand money”. In this case, the item of “2. Stock” is selected.

Then, the banker inputs the details of the deposit/dispense operation, by using the keyboard operation section 226 (Step 17). Thereafter, when the input completion key is operated by the operator, the completion of the input operation is detected (Step 18). In this way, once this input operation is completed, guidance for guiding the operator (i.e., the banker) to collect the cash is displayed, as shown in FIG. 38C.

Thereafter, the banker collects the money from the money management device 200, in accordance with the details of the deposit/dispense operation inputted by this banker in the Step 17. Namely, the banker collects the money, based on the denomination (or denominations) and quantity thereof respectively inputted in the Step 17, from the money management device 200. In the case in which the banker selects the item of “2. Stock” in the Step 16, the banker stores the collected money in the main safe. Meanwhile, in the case in which the banker selects the item of “1. In-hand” in the Step 16, the banker will manage the collected money, at hand, as the “In-hand money of the banker”.

Then, the load cell 261 of the money management device 200 measures the weight of the actually collected money (Step 20 of FIG. 29). This weight measurement for the money is performed, in the same manner as the weight measurement for the money upon the refill process described above with reference to FIG. 29.

If the denomination and quantity of the actually collected money do not correspond to the inputted information on this money (i.e., “NO” in the Step 21), the money management device 200 displays the error message on the display area, as well as displays a message or indication for indicating that the denomination and quantity of the money actually collected are different from the inputted information, on the condition display area (Step 22). At the same time, the money management device 200 performs again each process from the Step 17. In place of or in addition to the aforementioned display of the error message, the banker may be informed of occurrence of the error, by the sound or voice, via the speaker (not shown) provided to the money management device 200.

Meanwhile, in the case in which the denomination and quantity of the actually collected money respectively correspond to the information on the money inputted in the Step 17 (i.e., “Yes” in the Step 21), the money management device 200 transmits one series of process information, as the process cue, to the teller machine 100 (Step 23), via the interface 229. This transmission of the process cue is started, in response to the closing operation of the door or drawer, or push down operation for the corresponding key, after the Step 19.

Since the operations of the money management device 200 after the transmission of the process cue are respectively the same as those in the case of the above refill process, the explanation on such operations is omitted here.

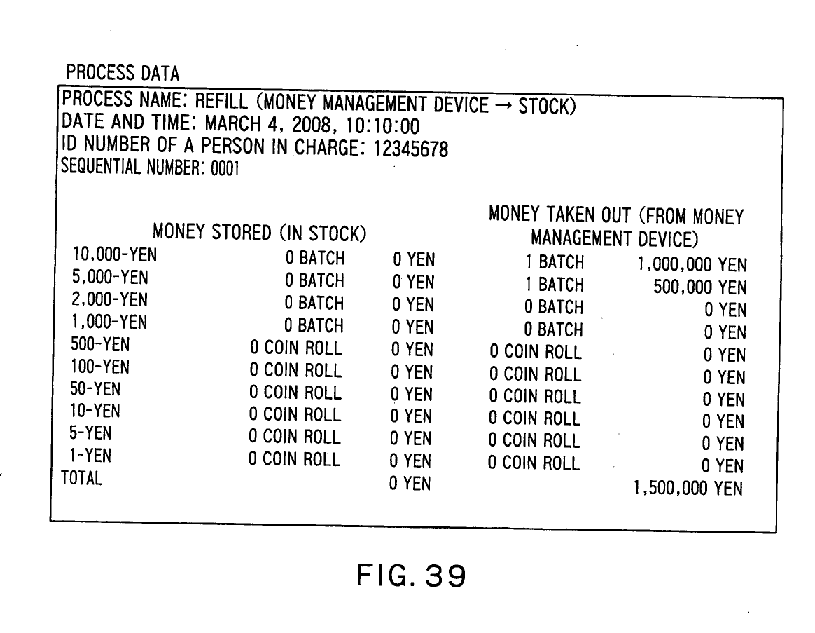

FIG. 39 illustrates the content of the process data of the money management device 200 upon the collecting process. The input information upon the collecting process is reflected in the content of the process data. For instance, the item of “2. Collection” in the process menu selected in FIG. 31B (Step 14) is reflected in the process name of “Collection” shown in FIG. 39. Further, the place into which the money is collected, i.e., the “2. Stock”, selected in FIG. 38A (Step 16) is reflected in an indication of “Money management device to Stock” in the parentheses of the process name. In addition, the denomination and quantity of the money respectively inputted in FIG. 38B (Step 17) are reflected in the denomination, quantity and amount of money, respectively listed under an indication of “Money taken out” shown in FIG. 39.

Now, referring to FIG. 34, the process cue for the collecting process will be described. The content of the process data shown in FIG. 39 is reflected in the process cue for the collecting process. Thus, the “Collection” is displayed as the process name, and the indication of “Money management device to Stock” is displayed in the parentheses of the process name, as in the case of the process data. In addition, the denomination, quantity and/or amount of money, respectively manually dispensed from the money management device 200, are also displayed in this process cue.

Meanwhile, in the case in which the item of “1. In-hand” is selected in FIG. 38A (Step of 16), an indication of “Money management device to In-hand” is displayed in the parentheses of the process name in the process data and process cue.

Next, the process in the teller machine 100 after it receives the process cue will be described.

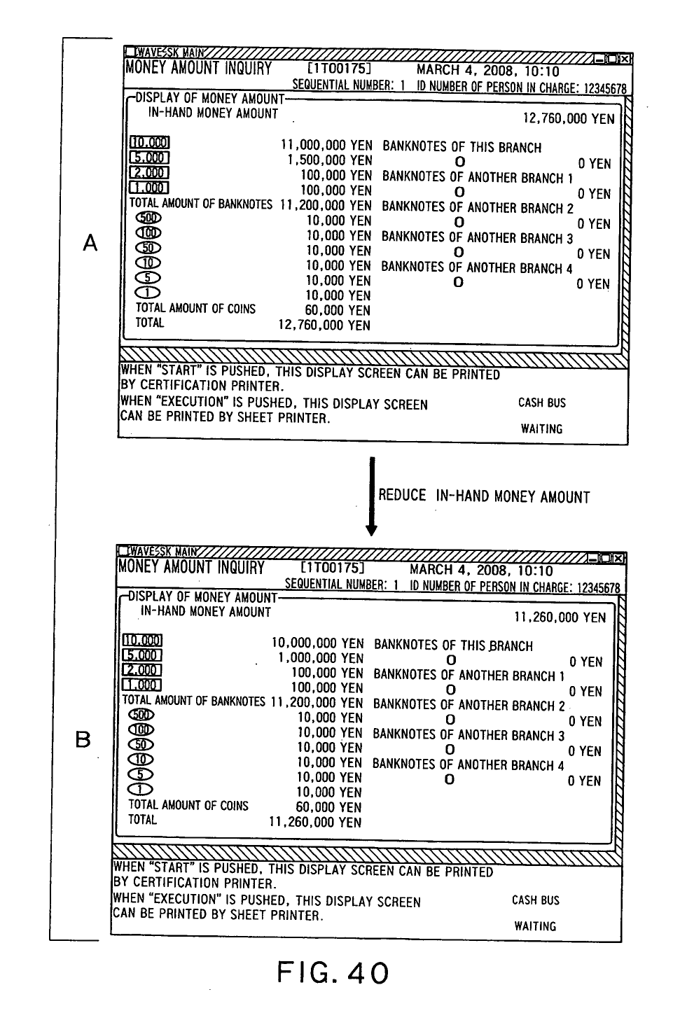

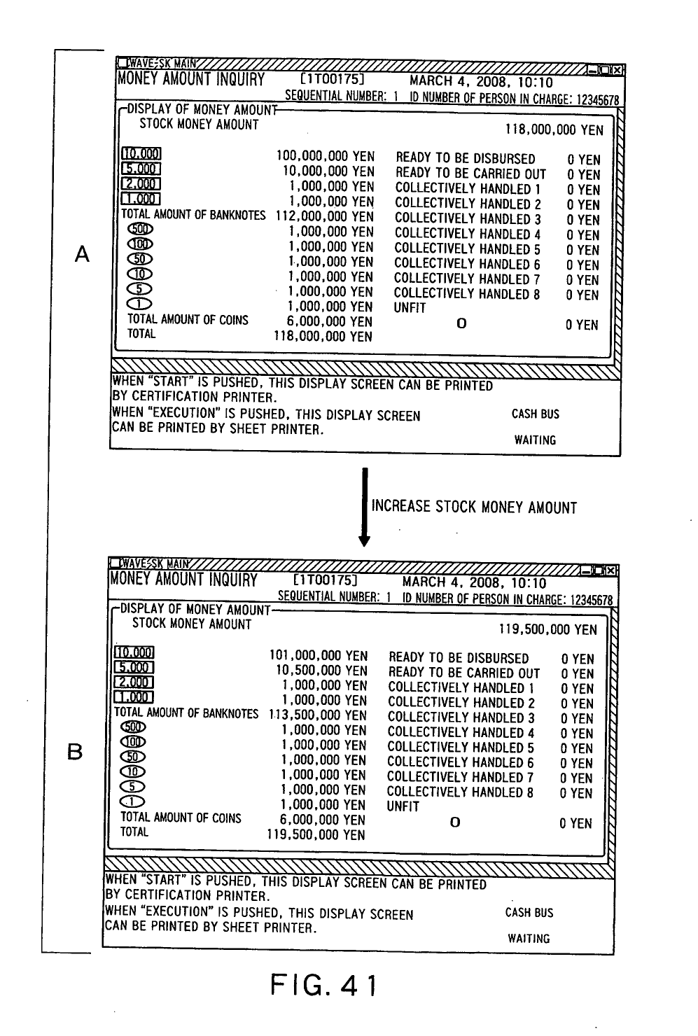

FIGS. 40A through 41B respectively illustrate the screen displayed on the display section 15a of the teller machine 100 after this machine 100 receives the process cue. In the case of the collecting process, the amount of the collected money is subtracted from the in-hand money amount (or money-management-device money amount), as shown in FIGS. 40A and 40B. Specifically, in this collecting process, one batch of 10,000-yen banknote bundle (i.e., one hundred 10,000-yen banknotes) ten-thousand-yen banknotes and one batch of 5,000-yen banknote bundle (i.e., one hundred 5,000-yen banknotes) are collected, respectively. Therefore, one million yen and a half million yen, respectively corresponding to the above denominations, are subtracted from the in-hand money amount. As a result, the in-hand money amount (or money-management-device money amount) is reduced as shown in FIG. 40B.

Further, when the item of “1. In-hand” is selected in FIG. 38A (Step 16) and when the money-management-device money amount is managed separately from the in-hand money amount other than this money-management-device money amount, the amount of the collected money is subtracted from the in-hand money amount other than the money-management-device money amount.

Meanwhile, as shown in FIGS. 41A and 41B, the amount of the collected money is added to the stock money amount.

Since the one batch of 10,000-yen banknote bundle (i.e., one hundred 10,000-yen banknotes) and one batch of 5,000-yen banknote bundle (i.e., one hundred 5,000-yen banknotes) are respectively collected in the above process, the one million yen and half million yen respectively corresponding to such denominations are respectively added to the money amount of the stock money amount. As a result, the stock money amount is increased as shown in FIG. 41B.

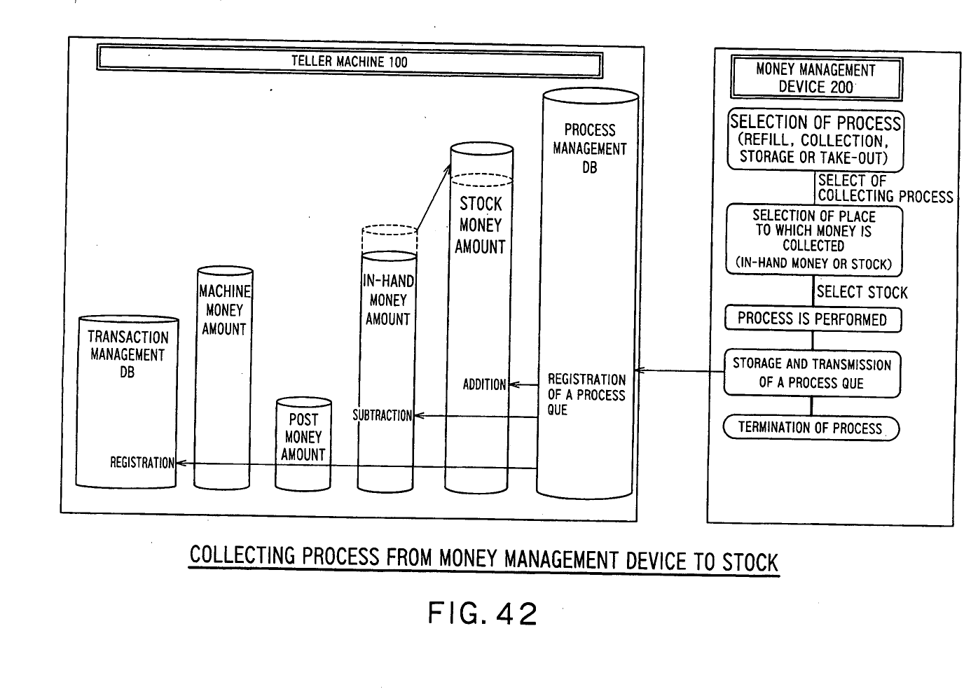

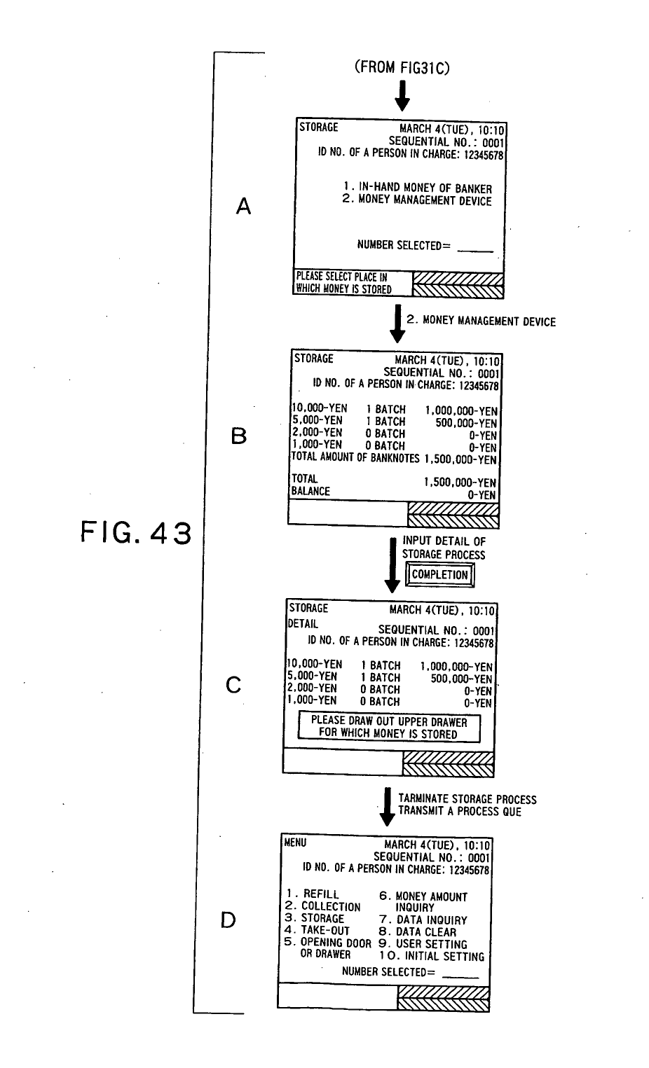

FIG. 42 is schematically illustrates the flow or procedure of the whole collecting process from the money management device 200 to the stock. In this case, the banker selects the item of “Collection”, as the process name, in the money management device 200, as well as selects the “Stock”, as the place into which the money is collected (Steps 14, 16 of FIG. 29). Then, after the collecting process is performed, the money management device 200 stores therein the process cue, as well as transmits this process cue to the teller machine 100 (Step 13).

Once receiving the process cue, the teller machine 100 has the process cue registered at the process management database, and then updates each money amount, based on the content of this process cue. In this embodiment, the money is collected from the money management device 200 into the stock. Accordingly, the amount of the collected money is subtracted from the data of the in-hand money amount in the teller machine 100. Meanwhile, the amount of the collected money is added to the data of the stock money amount. At this time, the machine money amount is not changed.

If there is the unfit banknote included in the collected money, the quantity and amount of money of this unfit banknote is not added to the stock money amount data, but added to the post money amount data.

Since the other operations for this collecting process can be readily guessed from the above refill process, the description on such operations is omitted here.

### (Storage Process)

Next, referring to FIGS. 29, 31 and 43, the storage process in the money management device 200 will be described. FIG. 43 illustrates the screen displayed, following FIG. 31C, on the display section 227 of the money management device 200, upon the storage process.

The operations from the insertion of the ID card to the input of the identification number are respectively the same as those described in the Steps 11 to 15 respectively shown in FIG. 29. However, in this storage process, the banker selects the item of “3. Storage” in FIG. 31B (Step 14). Therefore, the process name (i.e., “Refill”) shown in FIG. 31C is changed into the “Storage”, as shown in FIGS. 43A through 43C.

Then, the banker selects the place in which the money is stored, as the place to which the funds are transferred, by using the keyboard operation section 226 (Step 16). In this case, the place in which the money is stored is either of the “1. In-hand money of the banker” or “2. Money management device”. For instance, in the case in which the money deposited from the customer is stored into the money management device 200, the banker selects the item of “2. Money management device”. In the case in which the banker manages the money deposited from the customer, at hand, the banker selects the item of “1. In-hand money of the banker”. In this case, the item of “2. Money management device” is selected.

Thereafter, the banker inputs the details of the deposit/dispense operation, by using the keyboard operation section 226 (Step 17).

Then, the input completion is detected, due to the operation of the input completion key by the banker (Step 18). Once this input operation is completed, as shown in FIG. 43C, guidance for guiding the operator (i.e., the banker) to store the cash is displayed.

Thus, the banker stores the money into the money management device 200, in accordance with the details of the deposit/dispense operation inputted by this banker in the Step 17 (Step 19). Namely, the banker stores the money in the money management device 200, based on the denomination (or denominations) and quantity thereof respectively inputted in the Step 17. Then, the load cell 261 of the money management device 200 measures the weight of the actually stored money (Step 20). This weight measurement for the money is performed, in the same manner as the weight measurement for the money upon the aforementioned refill process and collecting process.

If the denomination and quantity of the actually stored money do not correspond to the inputted information on the money (i.e., “NO” in the Step 21), the money management device 200 displays the error message on the display area, as well as displays a message or indication for indicating that the denomination and quantity of the actually stored money are different from the inputted information, on the condition display area (Step 22). At the same time, the money management device 200 performs again each process from the Step 17. In this case, in addition to or in place of the aforementioned display of the error message, the banker may be informed of the occurrence of the error, by the sound or voice, via the speaker provided to the money management device 200.

Meanwhile, in the case in which the denomination and quantity of the actually stored money respectively correspond to the information on the money inputted in the Step 17 (i.e., “Yes” in the Step 21), the money management device 200 transmits one series of process information, as the process cue, to the teller machine 100 (Step 23), via the interface 229. This transmission of the process cue is started, in response to the closing balance operation of the door or drawer, or in response to the push down operation for the corresponding key, after the Step 19.

Since the operations of the money management device 200 after the transmission of the process cue are respectively the same as those in the case of the above refill process, the description on such operations is now omitted.

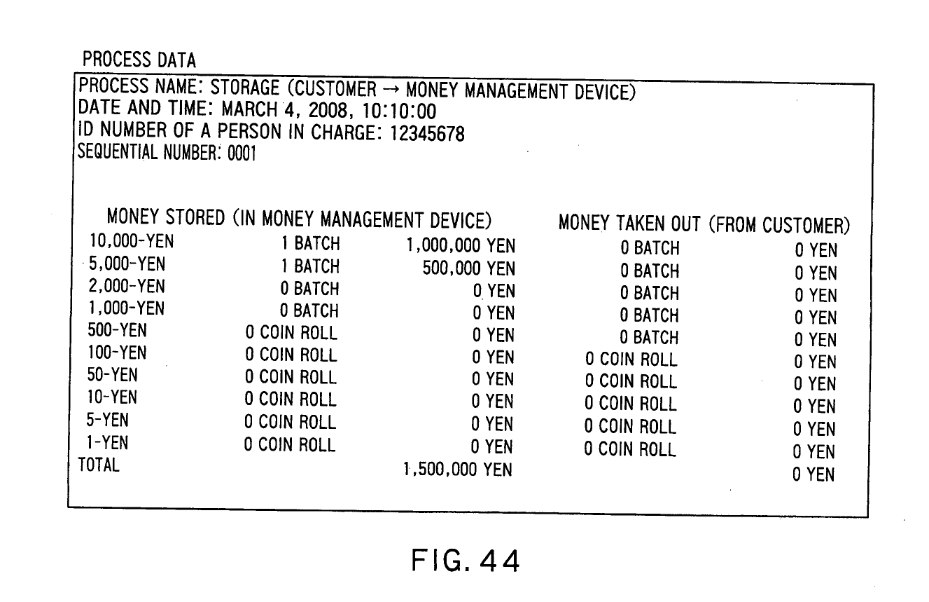

FIG. 44 illustrates the content of the process data displayed in the money management device 200 upon the storage process. The input information upon the storage process is reflected in the process data. For instance, the item of “3. Storage” in the process menu selected in FIG. 31B (Step 14) is reflected in the process name of “Storage” in FIG. 44. In addition, the place in which the money is stored (in this case, the “2. Money management device”) selected in FIG. 43A (Step 16) is reflected in an indication of “Customer to Money management device” in the parentheses of the process name in FIG. 44. Further, the denomination and quantity of the money, respectively inputted in FIG. 43B (Step 17) respectively are reflected to the denomination, quantity and amount, respectively listed under an indication of “Money stored” shown in FIG. 44.

Now, referring to FIG. 34, the process cue upon the storage process will be described. The content of the process data shown in FIG. 44 is reflected in this process cue upon the storage process. Therefore, the “Storage” is displayed as the process name, and the display in the parentheses of the process name is changed into the “Customer to Money management device”, in accordance with the content of this process data. In addition, the denomination, quantity and/or amount of money, respectively manually inputted from the money management device 200, are also displayed in this process cue.

In this case, when the item of “1. In-hand money of the banker” is selected in FIG. 43A (Step 16), the process for storing the money into the money management device 200 is not performed in the Step 19, while the banker manages this money at hand. In this case, after the banker inputs the denomination and quantity of the money in the Step 17, the measurement for the money is started in the Step 20, in response to the operation for the input completion key in the Step 18. Further, in this case, the display in the parentheses of the process name in the process data and process cue is changed into an indication of “Customer to In-hand money of the banker”.

Next, the process in the teller machine 100 after it receives the process cue will be described.

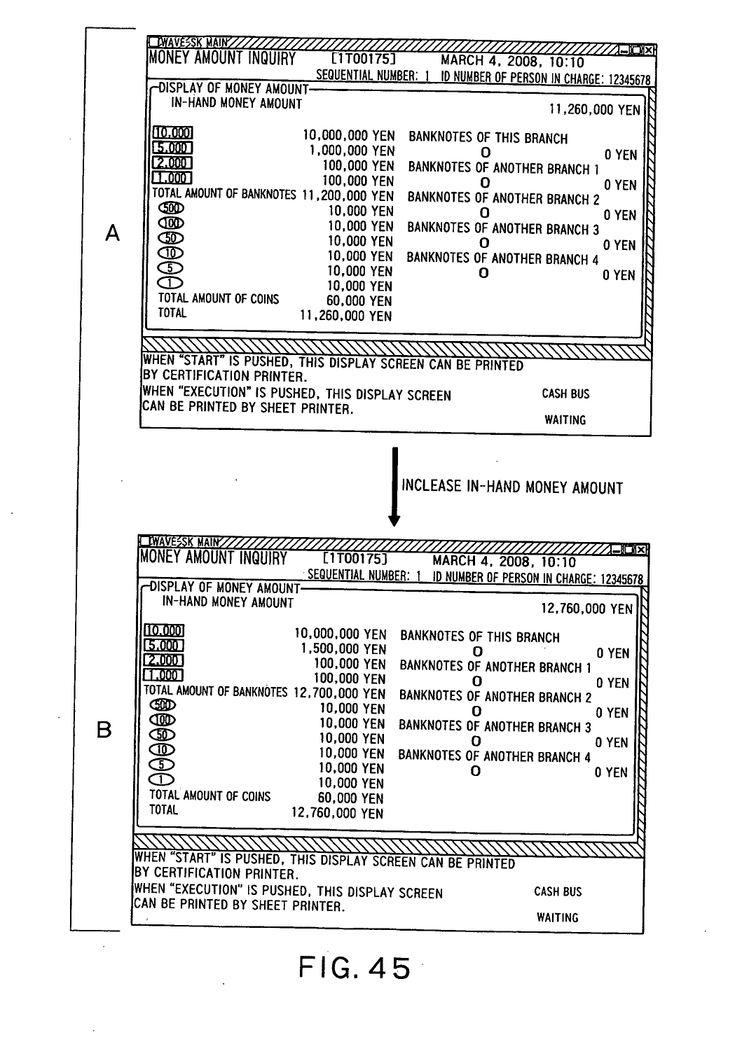

FIGS. 45A and 45B respectively illustrate the screen displayed on the display section 15a of the teller machine 100 after it receives the process cue. In the case of the storage process for storing the money into the money management device 200, the teller machine 100 adds the amount of the stored money to the in-hand money amount (or money-management-device money amount), as shown in FIGS. 45A and 45B. In this process, one batch of 10,000-yen banknote bundle (i.e., one hundred 10,000-yen banknotes) ten-thousand-yen banknotes and one batch of 5,000-yen banknote bundle (i.e., one hundred 5,000-yen banknotes) are respectively stored. Therefore, the teller machine 100 adds one million yen and a half million yen, respectively corresponding to the above denominations, to the in-hand money amount. As a result, the in-hand money amount is increased as shown in FIG. 45B.

In the case in which the item of “1. In-hand money of the banker” is selected in FIG. 43A (Step 16) and in which the money-management-device money amount is managed separately from the in-hand money amount other than the money-management-device money amount, the teller machine 100 adds the amount of the stored money to the in-hand money amount other than the money-management-device money amount.

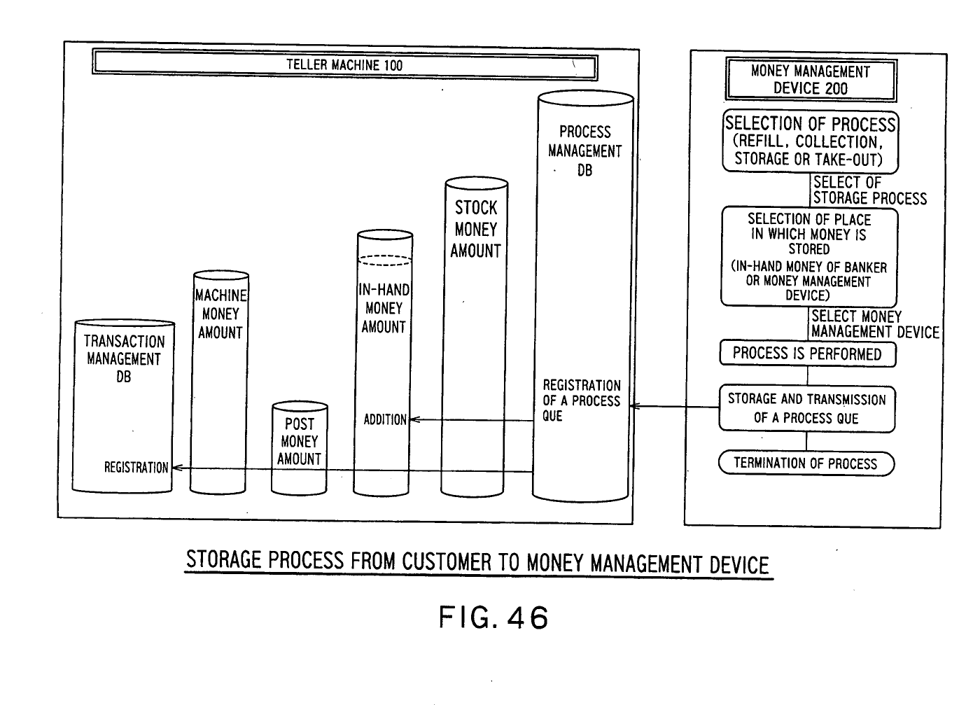

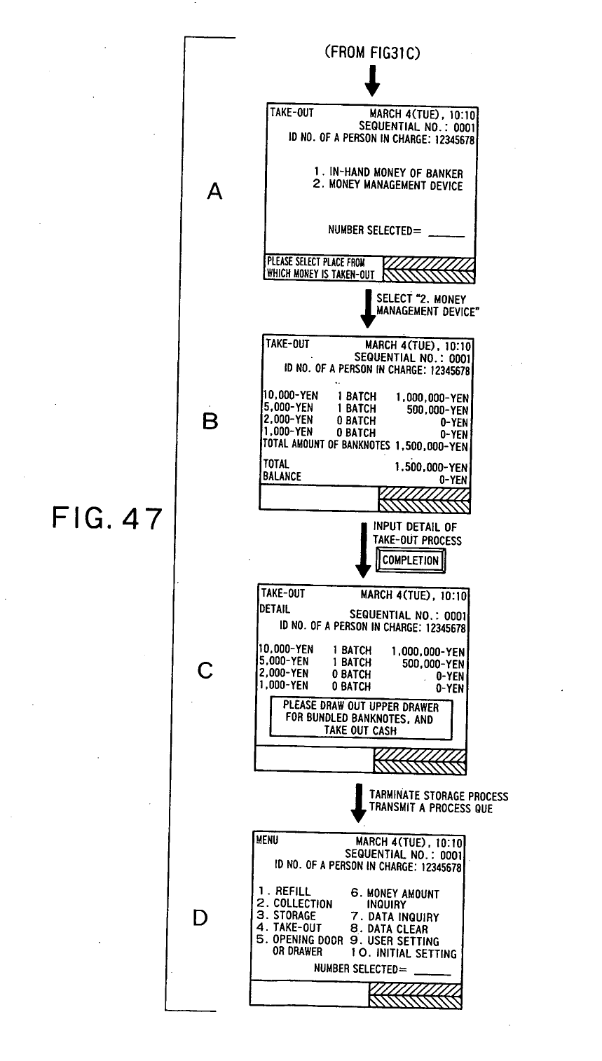

FIG. 46 schematically illustrates the flow or procedure of the whole storage process for storing the money into the money management device 200. First, in the money management device 200, the banker selects the item of “Storage” as the process to be performed, as well as selects the “Money management device” as the place in which the money is stored (Steps 14, 16 of FIG. 29). Then, once the storage process is performed, the money management device 200 stores therein the process cue, as well as transmits this process cue to the teller machine 100 (Step 23).

Once the teller machine 100 registers the received process cue in the process management database, the teller machine 100 updates each money amount, based on the content of the process cue. In this embodiment, the money is stored in the money management device 200. Therefore, the amount of the stored money is added to the in-hand money amount data. In this case, the stock money amount and the machine money amount are not changed.

If there is the unfit banknote included in the stored money, the quantity and amount of money of this unfit banknote is not added to the data on the in-hand money amount, but added to the data on the post money amount.

Since the other operations of the storage process can be readily guessed from the above refill process, the explanation on such operations is omitted here.

### (Take-Out Process)

Now, referring to FIGS. 29, 31 and 47, the take-out process in the money management device 200 will be described. FIGS. 47A through 47D respectively illustrate the screen displayed, following FIG. 31C, on the display section 227 of the money management section 200, upon the take-out process.

In this case, the operations from the ID card insertion to the input of the identification number are respectively the same as those described in the Steps 11 to 15 respectively shown in FIG. 29. However, in this take-out process, the banker selects the item of “4. Take-out” in FIG. 31B (Step 14). As a result, the process name (i.e., “Refill”) shown in FIG. 31C is changed into the “Take-out”, as shown in FIGS. 47A through 47C.

Then, the banker selects the place from which the money is taken out, as the place from which the funds are transferred, by using the keyboard operation section 226 (Step 16). In this case, the place from which the money is taken out is either one of the “1. In-hand money of the banker” or “2. Money management device”. In the case in which the money to be dispensed to the customer is taken out from the money management device 200, the banker selects the item of “2. Money management device”. Meanwhile, in the case in which the money is dispensed to the customer from the “In-hand money of the banker”, the banker selects the “1. In hand money of the banker”. In this case, the item of “2. Money management device” is selected.

Thereafter, the banker inputs the details of the deposit/dispense operation, by using the keyboard operation section 226 (Step 17).

Then, the input completion is detected, in response to the operation of the input completion key by the banker (Step 18). In this way, once this input operation is completed, guidance for guiding the operator (i.e., the banker) to take out the cash is displayed, as shown in FIG. 47C.

Thus, the banker takes out the money from the money management device 200, in accordance with the details of the deposit/dispense operation inputted by this banker in the Step 17. Namely, the banker takes out the money, based on the denomination (or denominations) and quantity thereof respectively inputted in the Step 17, from the money management device 200. Then, the load cell 261 of the money management device 200 measures the weight of the money actually taken out (Step 20).

If the denomination and quantity of the money actually taken out do not correspond to the inputted information on the money inputted in the Step 17 (i.e., “NO” in the Step 21), the money management device 200 displays the error message on the display area, as well as displays a message or indication for indicating that the denomination and quantity of the money actually taken out are different from the inputted information, on the condition display area (Step 22). At the same time, the money management device 200 performs again each process from the Step 17. In this case, in addition to or in place of the display of the error message, the banker may be informed of the occurrence of the error, by a proper sound or voice, via the speaker provided to the money management device 200.

Meanwhile, in the case in which the denomination and quantity of the money actually taken out respectively correspond to the information on the money inputted in the Step 17 (i.e., “Yes” in the Step 21), the money management device 200 transmits one series of process information, as the process cue, to the teller machine 100, via the interface 229 (Step 23). This transmission of the process cue is started, in response to the closing operation for the door or drawer, or push down operation for the corresponding key, after the Step 19.

Since the operations of the money management device 200 after the transmission of the process cue are respectively the same as those described in the case of the above refill process, the description on such operations is now omitted.

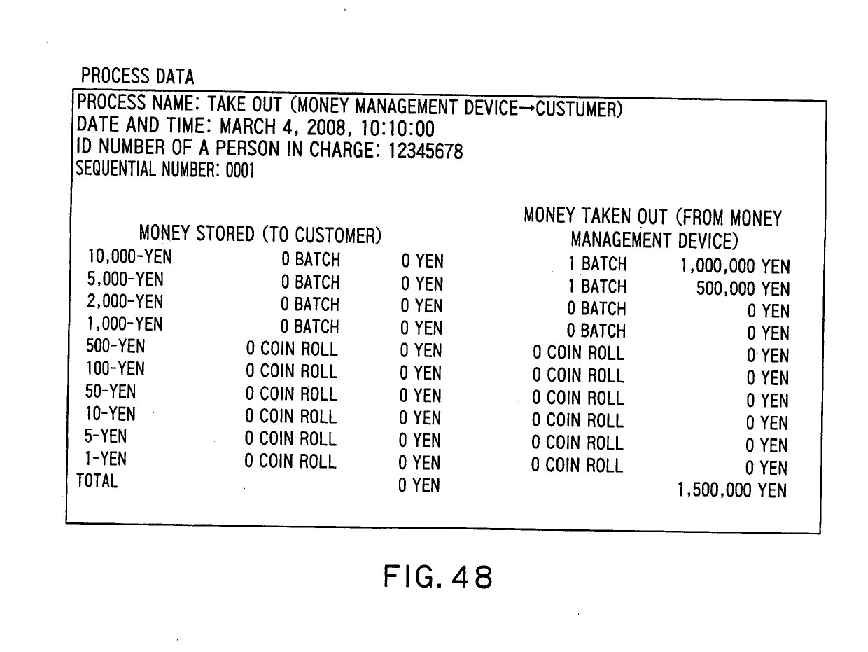

FIG. 48 illustrates the content of the process data of the money management device 200 upon the take-out process. The information inputted upon the take-out process is reflected in this process data. For instance, the item of “4. Take-out” selected in the process menu in FIG. 31B (Step 14) is reflected in the process name of “Take-out” in FIG. 48. In addition, the place from which the money is taken out (in this case, the “2. Money management device) selected in FIG. 32A (Step 16) is reflected in an indication of “Money management device to Customer” in the parentheses of the process name in FIG. 48. Further, the denomination and quantity of the money, respectively inputted in FIG. 47B (Step 17) are respectively reflected in the denomination, quantity and amount, respectively listed under the indication of “Money taken out” shown in FIG. 48.

Now, referring to FIG. 34, the process cue upon the take-out process will be described. The content of the process data shown in FIG. 48 is reflected in this process cue upon the take-out process. Thus, the “Take-out” is displayed as the process name, and the display in the parentheses of the process name is changed into the “Money management device to Customer”, in the same manner as in the process data. In addition, the quantity, amount and denomination of the money taken out from the money management device 200 are respectively displayed in this process cue.

In this case, when the item of “1. In-hand money of the banker” is selected in FIG. 47A (Step 16), the process for taking out the money from the money management device 200 is not performed in the Step 19 of FIG. 29, while the banker takes out the money from the “In-hand money of the banker” managed, at hand, by the banker. In this case, after the banker inputs the denomination and quantity of the money in the Step 17, the measurement for the money is started in the Step 20, in response to the operation for the input completion key in the Step 18. Further, in this case, the display in the parentheses of the process name in the process data and process cue is changed into an indication of “In-hand money of the banker to Customer”.

Next, the process in the teller machine 100 after it receives the process cue will be described.

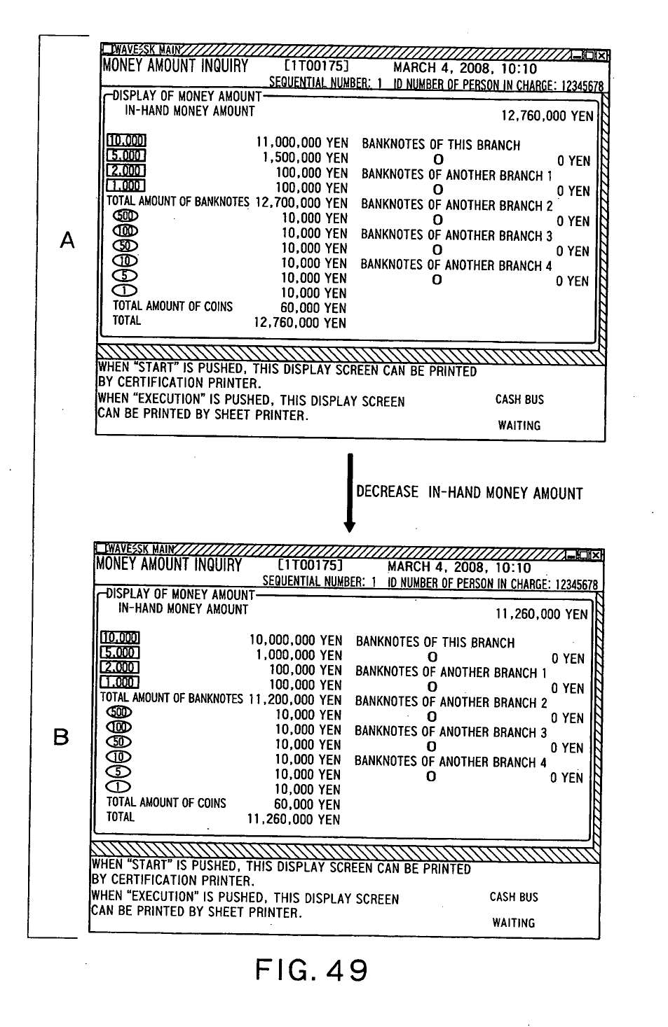

FIGS. 49A and 49B respectively illustrates the screen displayed on the display section 15a of the teller machine 100 after this machine 100 receives the process cue. In the case of the take-out process for taking out the money from the money management device 200, the teller machine 100 subtracts the amount of money taken out, from the in-hand money amount (or money-management-device money amount). In this process, one batch of 10,000-yen banknote bundle (i.e., one hundred 10,000-yen banknotes) ten-thousand-yen banknotes and one batch of 5,000-yen banknote bundle (i.e., one hundred 5,000-yen banknotes) are respectively taken out. Therefore, the teller machine 100 subtracts one million yen and a half million yen, respectively corresponding to the above denominations, from the in-hand money amount. As a result, the in-hand money amount is updated as shown in FIG. 49B.

In the case in which the item of “1. In-hand money of the banker” is selected in FIG. 47A (Step 16) and in which the money-management-device money amount is managed separately from the in-hand money amount other than this money-management-device money amount, the teller machine 100 subtracts the amount of money taken out, from the in-hand money amount other than the money-management-device money amount.

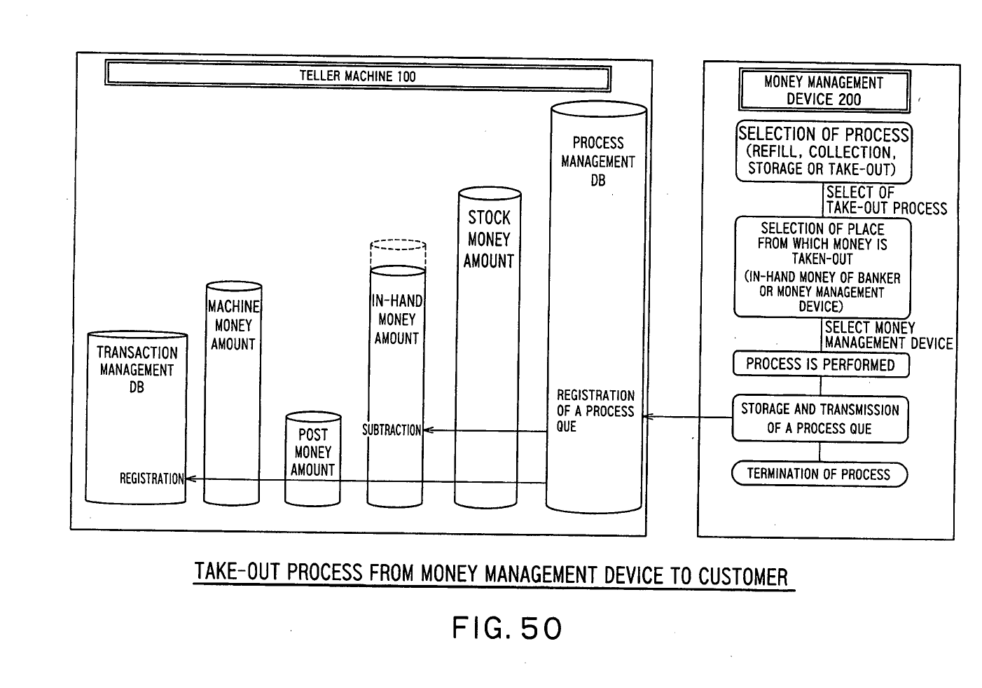

FIG. 50 schematically illustrates the flow of the whole take-out process for taking out the money from the money management device 200. First, in the money management device 200, the banker selects the item of “Take-out” as the process to be performed, as well as selects the item of “Money management device” as the place from which the money is taken out (Steps 14, 16 of FIG. 29). Then, once the take-out process is performed, the money management device 200 stores therein the process cue, as well as transmits this process cue to the teller machine 100 (Step 23 of FIG. 29).

Then, the teller machine 100 registers the received process cue in the process management database. Thereafter, based on the content of this process cue, the teller machine 100 updates each money amount. In this embodiment, the money is taken out from the money management device 200. Therefore, the amount of money taken out is subtracted from the in-hand money amount data. At this time, the stock money amount and the machine money amount is not changed.

Since the other operations of the take out process can be readily guessed from the above refill process, the explanation on such operations is omitted here.

While the “Refill” process, “Collection (or Collecting)” process, “Storage” process and “Take-out” process have been respectively described above, the other processes in the money management device 200 may also be managed, by transmitting each corresponding process cue from the money management device 200 to the teller machine 100, in order to achieve further centralized management on each money amount under the teller machine 100.

In regard to the money collected into the stock (or main safe) or money taken out from the stock, the process data is transmitted from the stock (or main safe) to the teller machine 100, without being transmitted via the money management device 200.

According to the money management system and money management method, respectively related to the above embodiment, the money management device 200 constituting the money management system, together with the teller machine 100, can be moved and used in any given place, irrespectively of the presence or absence of the connection, via the communication line, kept between the money management device 200 and the teller machine 100. In addition, the process information on the deposit/dispense operation related to both of the teller machine 100 and money management device 200 can be optionally transmitted to the teller machine 100. Thus, the teller machine 100 can serve to provide the accurate and centralized management on the in-hand money amount including the money-management-device money amount, in addition to the stock money amount, machine money amount and post money amount.

Further, when the banker deposits or dispenses the money from the money management device 200, it is not necessary for the banker to operate the teller machine 100. In addition, due to only the operation of the teller machine 100 carried out by the banker, the accurate and centralized management on all of the money amounts in the financial institution can be collectively performed. As such, the labor of the banker can be substantially saved, thus presenting significantly low-cost business management.

As described above, during the money transfer operation for the funds between the teller machine 100 and the money management device 200, the money is once handled as the “In-hand money of the banker”. Then, after the take-out process is performed, the banker stores the money in the teller machine 100. In this way, the teller machine 100 can shift the amount of the transferred money from the in-hand money amount to the machine money amount.

In the above embodiment, each process cue transmitted from the money management device 200 is stored in the memory device, such as the hard disk drive 15g, of the teller machine 100. However, without being stored in the memory device of the teller machine 100, the process cue stored in the hard disk drive 225g or the like may be transmitted from the money management device 200 to the teller machine 100, only when the teller machine 100 makes the inquiry to the money management device 200 about the process cue.

Further, by managing the money transfer process between the teller machine 100 and the money management device 200 by using the process cue, the deposit/dispense process in the money management device 200 and the deposit/dispense process related to the stock or in-hand money of the banker, respectively set in one process cue, can also be performed separately by different operators. Thus, as compared with the case in which both of the above deposit/dispense processes are performed by one operator, the time required for completing such two deposit/dispense processes can be significantly reduced. Ideally, such two deposit/dispense processes can be completed, at substantially the same time.

### Third Embodiment

The third embodiment is related to one operation for performing an interrupt process, in the case in which any one of the storing units becomes full up with the money during the deposit operation for depositing the money into the teller machine 100 or in which any one of the storing units becomes empty during the dispensing operation for dispensing the money from the teller machine 100. Namely, this third embodiment is related to the money transfer operation between the teller machine 100 and the money management device 200.

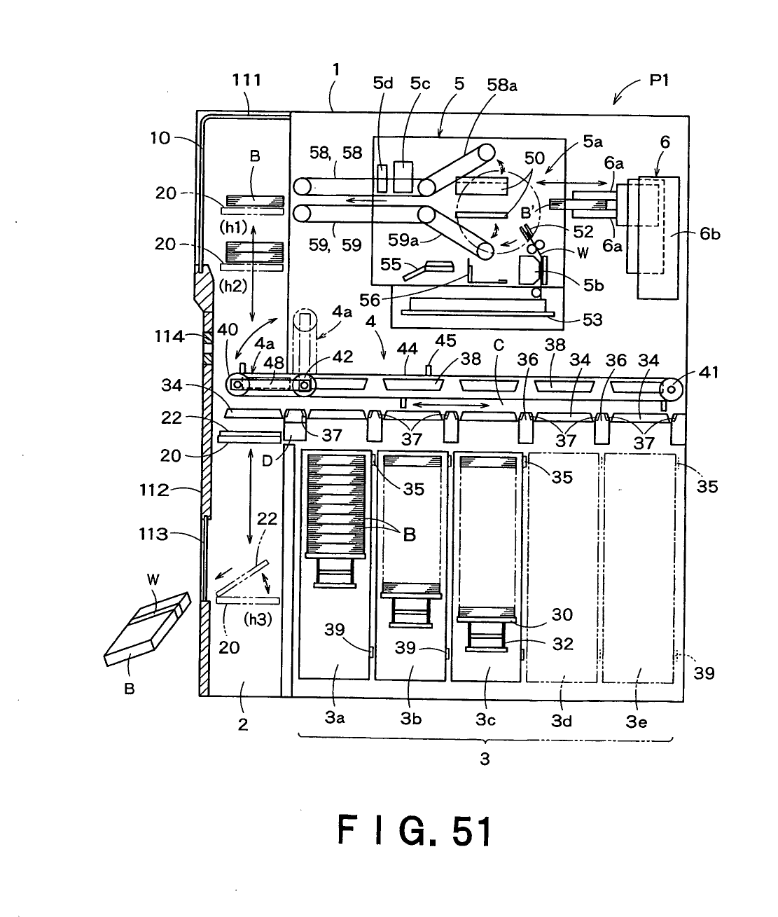

The cross section of FIG. 51 illustrates one exemplary construction of the bundled-banknote handling unit P1. First, referring to FIG. 51, specific construction of this bundled-banknote handling unit P1 will be detailed.

This bundled-banknote handling unit P1 includes a banknote-bundle lifting path 2 provided for vertically moving the banknote bundles B respectively transferred to and from this handling unit P1, and a banknote-bundle storing unit 3 configured to store therein the banknote bundles (or stored banknote bundles) B, respectively bundled in advance. Further, this bundled-banknote handling unit P1 includes a transport unit (or stored-banknote-bundle feeding unit) 4 adapted for horizontally moving the banknote bundles B between the lifting path 2 and storing unit 3, and a recognition unit (or recognition unit) D adapted for recognizing the denomination or the like of each banknote bundle B transported by the transport unit 4.

In addition, a bundling and printing unit 5, which is configured to bundle each batch B′ of a predetermined number of loose banknotes with a bundling W to prepare each banknote bundle B and to provide a predetermined printing or the like onto the bundling W, is provided above the banknote-bundle storing unit 3. Further, a batch transport unit 6 (which will be described later) is provided, behind the bundling and printing unit 5, to be optionally moved into the bundling and printing unit 5. This batch transport unit 6 can serve to carry each batch B′ of the loose banknotes into the bundling and printing unit 5 from the loose-banknote handling unit P2.

The lifting path 2, storing unit 3, transport unit 4 and bundling and printing unit 5 are respectively stored in a casing 1 shown in FIG. 51. In this case, the batch transport unit 6 can be moved in the casing 1 of the bundled-banknote handling unit P1 as well as in a casing 1′ of the loose-banknote handling unit P2 that will be described later.

The banknote-bundle lifting path 2 is arranged to extend along a front face of the casing 1. In this lifting path 2, a lifting stage (or banknote-bundle stacking unit) 20 is provided for placing thereon the banknote bundles B and then lifting them through the path 2. On a top face of this lifting stage 20, a swayable inclining plate 22 is provided to be swayably inclined lower in front than in back. An upper part of the lifting path 2 can be in communication with the exterior via a bundle deposit/dispense slot 10 that can be optionally opened and closed by a shutter (or opening and closing unit) 111. In addition, a lower part of the lifting path 2 can be wholly opened, when an opening and closing door or drawer 112 provided with a locking member 114 is opened forwardly, as well as can be partly communicated with the exterior, via a bundle release slot 113 provided, as an opening and closing shutter, to the opening and closing door or drawer 112.

The banknote-bundle storing unit 3 includes three bundle storing units 3a to 3c, respectively arranged in a line in the forward and backward directions. In this case, the bundle storing unit 3b is provided as a 10,000-yen-banknote-bundle storing unit (or 10,000-yen-bundled-banknote storing unit), and the bundle storing unit 3c is provided as a 1,000-yen-banknote-bundle storing unit (or 1,000-yen-bundled-banknote storing unit). Namely, each of such bundle storing units 3b and 3c is configured for storing therein the banknote bundles B, for each corresponding denomination of money. Meanwhile, the bundle storing unit 3a is provided, as a collective bundle storing unit, and configured for storing therein the banknote bundles B including the 10,000-yen banknotes and 1,000-yen banknotes, collectively, in a mixed state of the denominations. Each of the bundle storing units 3a to 3c is of a cassette-type storing unit that can be optionally attached and detached relative to the bundled-banknote handling unit P1. Further, each bundle storing unit 3a to 3c has a top end that can be optionally opened, and a lifting stage 30 provided therein and having a pantograph mechanism 32.

The transport unit 4 includes a pair of left and right transport belts 44, respectively extending in the horizontal direction from a point located above the storing unit 3 up to the inside of the lifting path 2. Each transport belt 44 is provided across a pair of pulleys 40, 41, while having four pins 45, respectively projecting outward from the belt 44 and arranged with a predetermined interval. Further, for each transport belt 44, a third pulley 42 is provided between the pair of pulleys 40, 41 (just behind the lifting path 2). In this case, the two pulleys 40, 42, respectively located on the side of the lifting path 2, are connected with each other, via a lever 48 that can be optionally swayed upward, by 90°, about a rotation shaft of the pulley 42.

With this configuration, a part of the transport unit 4 located on the side of the lifting path 2 can constitute a swayable evacuation part 4a that can be optionally evacuated from the inside of the lifting path 2, when this part is swayed, from its horizontal transporting position to its vertical evacuation position.

Between the transport unit 4 and each of the bundle storing units 3a to 3c (and 3d, 3e), a pair of opening and closing plates 34, respectively configured to be optionally opened and closed in the lateral direction, are provided. Further, the pair of opening and closing plates 34 are provided, in the same manner, between the swayable evacuation part 4a of the transport unit 4 and a lower part of the lifting path 2. In addition, one partition plate 36 is provided in a position between each adjacent pair of the opening and closing plates 34, respectively located corresponding to each of the bundle storing units 3a to 3c (and 3d, 3e). A pair of sensors 37 are provided, respectively, to a top end face of each partition plate 36. Each of the sensors 37 can serve to detect the pass or oblique transportation of each banknote bundle B.

Further, an empty detector 35 is provided to a top end part of each bundle storing unit 3a to 3c. Each empty detector 35 can serve to detect that the amount of banknote bundles B stored in each bundle storing unit 3a to 3c becomes considerably few (or detect a nearly empty state of each bundle storing unit 3a to 3c). Meanwhile, a full detector 39 is provided to a bottom end part of each bundle storing unit 3a to 3c. Each full detector 39 can serve to detect that each bundle storing unit 3a to 3c becomes full up with the banknote bundles B. Usually, in each bundle storing unit 3a to 3c, the banknote bundles B are stored such that the top face of the uppermost banknote bundle B is positioned to be a top end relative to the lifting stage 30. Accordingly, when the empty detector 35 detects the lifting stage 30, it can be found that the bundle storing unit corresponding to this empty detector 35 is empty. Meanwhile, when the full detector 39 detects the lifting stage 30, it can be found that the bundle storing unit corresponding to this full detector 39 is full up with the banknote bundles B.

Additionally, a recognition unit D is provided between the pair of opening and closing plates 34 located above the bundle storing unit 3a and the pair of opening and closing plates 34 located in the lifting path 2.

Further, a transport path C is provided through an elongated space surrounded by the opening and closing plates 34, partition plates 36, recognition unit D and the transport unit 4. With this configuration, each banknote bundle B can be transported along the transport path C, while being slid on the respective opening and closing plates 34 and the like, with transport force being horizontally exerted to the bundle B from each pin 45 provided to the respective transfer belts 44. In addition, pressing detector plates 38 are provided, respectively, between the pair transport belts 44. In this case, the pressing detector plates 38 are respectively located to be opposed to the respective opening and closing plates 34 above the respective bundle storing units 3a to 3c (and 3d, 3e).

Now, referring to FIG. 51, the storage and release operations for the banknote bundles B relative to each bundle storing unit 3a to 3c will be described. It is noted that each bundle storing unit is not specified, in particular, among the bundle storing units 3a to 3c (namely, unless otherwise defined, each of the bundle storing units will be expressed as “one storing unit (3a to 3c)”).

Upon the storage operation, each banknote bundle B bundled by the bundling and printing unit 5 or deposited into the handling unit P1 via the shutter 111 is first placed on the stage 20. Thereafter, the stage 20 is lowered to a position in which the uppermost one of the stacked banknote bundles B corresponds to the level of the transport unit 4, thereby each stacked banknote B is allowed to be transported by the transport unit 4. Then, each banknote bundle B is transported by the transport unit 4 up to a certain pair of opening and closing plates 34 corresponding to a desired storing unit (3a to 3c) in which this banknote bundle B is stored. Meanwhile, in this storing unit (3a to 3c), the lifting stage 30 is raised up to the level for receiving the banknote bundle B to be stored in the storing unit. In this state, the pair of opening and closing plates 34 are laterally opened, respectively, for allowing the banknote bundle B to be dropped down onto the lifting stage 30 (or onto the banknote bundles B already stacked on this stage 30). Thereafter, the pair of opening and closing plates 34 are closed, and then the lifting stage 30 is lowered to a predetermined position. In this way, the storage operation for each banknote bundle B can be completed.

Meanwhile, upon the dispense operation, the pair of opening and closing plates 34, corresponding to one bundle storing unit (3a to 3c) from which the banknote bundles B are dispensed, are opened respectively. Then, the lifting stage 30, on which the banknote bundles B are placed, is raised in this bundle storing unit (3a to 3c). Further, while the pair of opening and closing plates 34 are opened, the corresponding pressing detector plate 38 is moved downward, in order to control the level of the lifted banknote bundles B. More specifically, once the pressing detector plate 38 is pushed upward by the uppermost banknote bundle B, this plate 38 can serve as a switch for stopping the raising operation for the stage 30. Thus, only the uppermost banknote bundle B can be released onto the transport path C. In this way, the banknote bundles B can be released and transported, one by one, by the transport unit 4.

In this case, the bundling and printing unit 5 shown in FIG. 51 includes a bundling unit 5a and a printer (or printing unit) 5b. The bundling unit 5a is adapted for preparing each banknote bundle B (or bundled banknote batch), by bundling each batch B′ of the loose banknotes transported by the batch transport unit 6, with the bundling W. The printer (or printing unit) 5b is adapted for providing a predetermined printing or the like onto the bundling W of each banknote bundle B. Further, the bundling unit 5a includes a grasping unit 50 adapted for grasping or holding each batch B′ of the loose banknotes, and a pivot arm 52 adapted for allowing the bundling W (that is pulled out from a roll 53) to be wound around each grasped loose-banknote batch B′. As the bundling unit 5a of this type, any suitable unit or device that has been publicly known can be used. In addition, this bundling unit 5a includes an adhesion tool 55 adapted for adhering both end portions of each wound bundling W together, and a cutter 56 adapted for cutting the bundling W into a length commensurate with each of banknote bundle.

Further, the bundling and printing unit 5 includes upper transport belts (or banknote-bundle feeding unit) 58, 59, respectively provided for feeding each banknote bundle B toward an upper portion of the lifting path 2. Additionally, in a position adjacent to the transport belts 58 located above the other transport belts 59, a bank name stamp 5c adapted for stamping a name of the financial institution on the bundling W of each banknote bundle B, and an unfit banknote stamp 5d adapted for stamping an unfit banknote mark on the bundling W of each banknote bundle including the unfit banknote are arranged respectively. Furthermore, on the side of the grasping unit 50, the transfer belts 58, 59 respectively includes swayable evacuation parts 58a, 59a that can be optionally evacuated or swayed outside, respectively, for example, upon winding the bundling W around each batch of the loose banknotes. It is noted that the bundling and printing unit 5 is configured to can hold a preset number (e.g., four batches) of the banknote bundles B (or bundled banknote batches), before such banknote bundles B are fed into the lifting path 2 (or onto the stage 20).

Now, further referring to FIG. 51, the batch transport unit 6 arranged to be used, commonly, for the bundled-banknote handling unit P1 as well as for the loose-banknote handling unit P2, will be described. This batch transport unit 6 includes a pair of upper and lower grasping units 6a, respectively adapted for grasping each batch B′ of the loose banknotes, and a transfer unit 6b adapted for transferring the respective grasping units 6a. Specifically, the transfer unit 6b of this batch transport unit 6 can serve to transfer the grasping units 6a, reciprocally, in the forward and backward directions, as well as transfer these grasping units 6a, laterally, between the bundled-banknote handling unit P1 and the loose-banknote handling unit P2.

### (Basic Operation)

Next, referring to FIG. 51, the content of the basic operation (or control) related to the dispensing process in the banknote handling machine of this embodiment will be described.

### (1) Dispensing Operation for the Stored Banknote Bundles

This operation is provided for dispensing the banknote bundles B (or stored banknote bundles) stored in the banknote-bundle storing unit 3, and then taking out such dispensed banknote bundles from the bundle inlet/outlet 10, in the bundled-banknote handling unit P1.

More specifically, in the bundled-banknote handling unit P1 shown in FIG. 51, the banknote bundles B are released from each storing unit 3a to 3c (usually, except for the collective bundle storing unit 3c) corresponding to the denomination of money to be dispensed, onto the transport path C. Once released onto the transport path C, the banknote bundles B are transported into the lifting path 2 by the transport unit 4, and then stacked on the lifting stage 20 waiting at the place. Then, the swayable evacuation part 4a of the transport unit 4 is swayed, from the transporting position to the evacuation position, thus being evacuated from the inside of the lifting path 2. Thereafter, in the case of dispensing only the stored banknote bundles, the stage 20 is raised up to a dispensing position h2, and then the shutter 111 is opened, in order to open the bundle inlet/outlet 10. Thus, the banknote bundles B can be taken out (or dispensed) via the opened bundle inlet/outlet 10.

### (2) Dispensing Operation for the Bundled Banknote Batches

This operation is provided for first feeding out the loose banknotes S, respectively stored in loose-banknote storing units 8a to 8e of the loose-banknote handling unit P2, into the bundled-banknote handling unit P1, then bundling such dispensed loose banknotes S into banknote bundles B (bundled banknote batches) in the bundled-banknote handling unit P1, and finally dispensing or taking out the so-prepared banknote bundles B, from the bundled-banknote handling unit P1, via the bundle inlet/outlet 10.

More specifically, in the loose-banknote handling unit P2, the loose banknotes S are fed out, one by one, from the loose-banknote storing units 8a to 8e (usually, 8c is provided as a 5,000-yen loose-banknote storing unit, and 8d is provided as a 2,000-yen loose-banknote storing unit) respectively corresponding to the denominations of the banknote bundles B to be dispensed, by a feeding mechanism 86, and then transported along a dispensing transport path R2. Thereafter, such loose banknotes S (except for the banknotes fed to a dispensing reject box 77) are passed through a dispensing recognition unit D2, then stacked in stackers 76a, 76b, and finally transported, respectively, as the batch (or batches) B′ of the loose banknotes, to the bundled-banknote handling unit P1, by the transport unit 6.

Thereafter, each batch B′ of the loose banknotes transported to the bundled-banknote handling unit P1 shown in FIG. 51 is fed into the bundling and printing unit 5 by the transport unit 6. Subsequently, the batch B′ of the loose banknotes fed into the bundling and printing unit 5 is bundled, with the bundling W, by the bundling unit 5a, and then the so-prepared banknote bundle B (i.e., the so-bundled banknote batch) is fed out into the lifting path 2 by the respective transport belts 58, 59. During this operation, the predetermined printing or the like is provided onto the bundling W by the printer 5b, as well as the bank name is stamped thereon by the bank name stamp 5c. If required, the unfit banknote mark is further stamped on the bundling W by the unfit banknote stamp 5d.

Then, each banknote bundle B fed to the lifting path 2 is stacked on the lifting stage 20 (or on the banknote bundles already stacked on this stage 20). At this time, the lifting stage 20 is waiting in a receiving position h1 as depicted in the drawing. Thereafter, this stage 20 is lowered to the dispensing position h2. Then, the shutter 111 is opened in order to open the bundle inlet/outlet 10. As such, the banknote bundles B can be taken out (or dispensed) from the opened bundle inlet/outlet 10.

### (Dispensing Process)

Next, the content of the dispensing process (or operation) in the banknote handling machine of this embodiment will be described.

Now, assume that dispense of three hundred and fifty 10,000-yen banknotes, one hundred and thirty 5,000-yen banknotes, one hundred and ten 2,000-yen banknotes and four hundred and eighty 1,000-yen banknotes is instructed. In this case, when the number of the banknotes of each denomination is divided by hundred, the quotient and remainder obtained by this division will respectively correspond to the number of the banknote bundles and number of the remaining loose banknotes, respectively prepared for this dispensing process (i.e., one hundred banknotes corresponds to one batch of banknote bundle, for each denomination of money). Namely, in this case, three batches of 10,000-yen banknote bundles and the remaining fifty 10,000-yen loose banknotes, one batch of 5,000-yen banknote bundle and the remaining thirty 5,000-yen loose banknotes, one batch of 2,000-yen banknote bundle and the remaining ten 2,000-yen loose banknotes, and four batches of 1,000-yen banknote bundles and the remaining eighty 1,000-yen loose banknotes are prepared to be dispensed, respectively.

Then, the control unit outputs an instruction for dispensing the loose banknotes based on this result. Meanwhile, for the banknote bundles, the control unit controls the dispensing process, differently, depending on the presence or absence of the bundle storing unit for each denomination of the banknotes. Namely, the instruction for dispensing the stored banknote bundles is outputted, for each denomination of the banknotes, for which the bundle storing unit is present (in this case, the bundle storing unit for the 10,000-yen banknotes and the bundle storing unit for the 1,000-yen banknotes are provided, respectively).

Meanwhile, for each denomination of the banknotes, for which the bundle storing unit is not provided (in this case, the bundle storing unit for the 5,000-yen banknotes and the bundle storing unit for the 2,000-yen banknotes are not provided, respectively), the control unit outputs the instruction for dispensing each bundled banknote batch, after the stacking operation for the corresponding loose banknotes is ended.

In this case, if the required number of batch of the bundled banknote batches is greater than the preset number of batch that can be held in the bundling and printing unit 5, the bundling and dispensing operations are once stopped, respectively, at the point of time the number of batch of the bundled banknote batches reaches the preset number of batch that can be held in the bundling and printing unit 5. At this time, the bundled banknote batches already prepared are brought into the waiting state in the bundling and printing unit 5. Meanwhile, if the required number of batch of the bundled banknote batches is less than the preset number of bundle that can be held in the bundling and printing unit 5, all of the bundled banknote batches are brought into the waiting state in this unit 5, until the number of batch the bundled banknote batches held in the bundling and printing unit 5 reaches such a required number of the bundles.

Thereafter, once the stacking operation for the stored banknote bundles onto the lifting stage 20 is ended, the bundling and dispensing operations are restarted, respectively (i.e., the stacking operation for the bundled banknote batches is started again). Then, until the number of the stacked banknote bundles reaches the required number, the stacking operation for the bundled banknote batches (onto the stored banknote bundles already stacked on the lifting stage 20) is performed. It is noted that the shutter 111 is opened in order to open the bundle inlet/outlet 10, after all of the banknote bundles B (including the stored banknote bundles and bundled banknote batches) to be dispensed are stacked on the lifting stage 20.

Now, referring again to FIG. 51, the content of the basic operation (or control) related to the depositing process in the money handling machine of this embodiment will be described.

### (1) Depositing Operation for the Stored Banknote Bundles

This operation is provided for storing the banknote bundles B respectively deposited via the bundle inlet/outlet 10 into the banknote-bundle storing unit 3 of the bundled-banknote handling unit P1.

More specifically, in the bundled-banknote handling unit P1 shown in FIG. 51, the shutter 111 is first opened in order to open the bundle inlet/outlet 10, and then the banknote bundles B are deposited via the opened bundle inlet/outlet 10. At this time, the stage 20 is elevated up to the dispensing position h2. At the same time, the swayable evacuation part 4a of the transport unit 4 is swayed, from the transporting position to the evacuation position, to be evacuated from the inside of the lifting path 2. If required, the opening and closing plates 34 located in the lifting path 2 are opened, respectively. Then, the stage 20, on which the banknote bundles B are placed, is lowered to a point in the vicinity of the opening and closing plates 34 located in the lifting path 2, and the swayable evacuation part 4a is returned from the evacuation position to the transporting position. At this time, the stage 20 is positioned, such that the top face of the banknote bundles B placed on the stage 20 will be in contact with the bottom face of each transport belt 44.

Thus, the banknote bundles B placed on the stage 20 can be respectively transported toward the transport pass C by the transport unit 4, with the denomination of money of each banknote bundle B being recognized by the recognition unit D. Then, the banknote bundles B are deposited in any one of the bundle storing units 3a to 3c, for each denomination thereof.

### (2) Depositing Operation for the Bundled Banknote Batches

This operation is provided for first bundling each batch B′ of the loose banknotes stored in the loose banknote handling unit P2 into the banknote bundle B (or bundled banknote batch) in the bundled-banknote handling unit P1, and then storing the so-prepared banknote bundle in any one of the bundle storing units 3a to 3c of the bundled-banknote handling unit P1.

More specifically, in the loose-banknote handling unit P2, the loose banknotes S are fed out, one by one, from the loose-banknote storing units 8a to 8e (usually, 8c is provided as the 5,000-yen loose-banknote storing unit, and 8d is provided as the 2,000-yen loose-banknote storing unit) respectively corresponding to the denominations of the banknote bundles B to be dispensed, by the feeding mechanism 86, and then transported along the dispensing transport path R2. Thereafter, such loose banknotes S (except for the banknotes fed to the dispensing reject box 77) are passed through the dispensing recognition unit D2, then stacked in the stackers 76a, 76b, and finally transported, respectively, as the batch (or batches) B′ of the loose banknotes, to the bundled-banknote handling unit P1, by the transport unit 6.

Thereafter, each batch B′ of the loose banknotes transported to the bundled-banknote handling unit P1 shown in FIG. 51 is fed into the bundling and printing unit 5 by the transport unit 6. Then, the batch B′ of the loose banknotes fed into the bundling and printing unit 5 is bundled, with the bundling W, by the bundling unit 5a, and then the so-prepared banknote bundle B (i.e., the so-bundled banknote batch) is fed out into the lifting path 2 by the respective transport belts 58, 59. During this operation, the predetermined printing is provided on the bundling W by the printer 5b, as well as the bank name is stamped thereon by the bank name stamp 5c. If required, the unfit banknote mark is further stamped on the bundling W by the unfit banknote stamp 5d.

Then, each banknote bundle B fed to the lifting path 2 is stacked on the lifting stage 20 (or on the banknote bundles already stacked on the stage 20). Thereafter, by performing the above “Depositing operation for the stored banknote bundles”, the banknote bundles B can be stored in any one of the banknote storing units 3a to 3c.

As used herein, the “depositing process” refers to a process including the transport process for transporting the bundled banknotes, respectively deposited via the bundle inlet/outlet 10, to the banknote bundle storing unit 3 from this inlet/outlet 10. Further, as used herein, the “dispensing process” refers to a process including the transport process for feeding out the banknotes from the banknote bundle storing unit 3, and then transporting such banknotes to the bundle inlet/outlet 10.

While the banknote handling units P1, P2 have been described above with reference to FIG. 51, the construction of the coin handling units 12, 13 can be readily envisioned from the construction illustrated in FIG. 51.

Further, the other parts of the teller machine 100 and money management device 200, than the banknote handling units P1, P2, are respectively constructed as described and illustrated above.

Hereinafter, the interrupt process or operation, in the case in which any one of the storing units becomes full up with the money during the depositing process into the teller machine 100 or in which any one of the storing units becomes empty during the dispensing process from the teller machine 100, will be described.

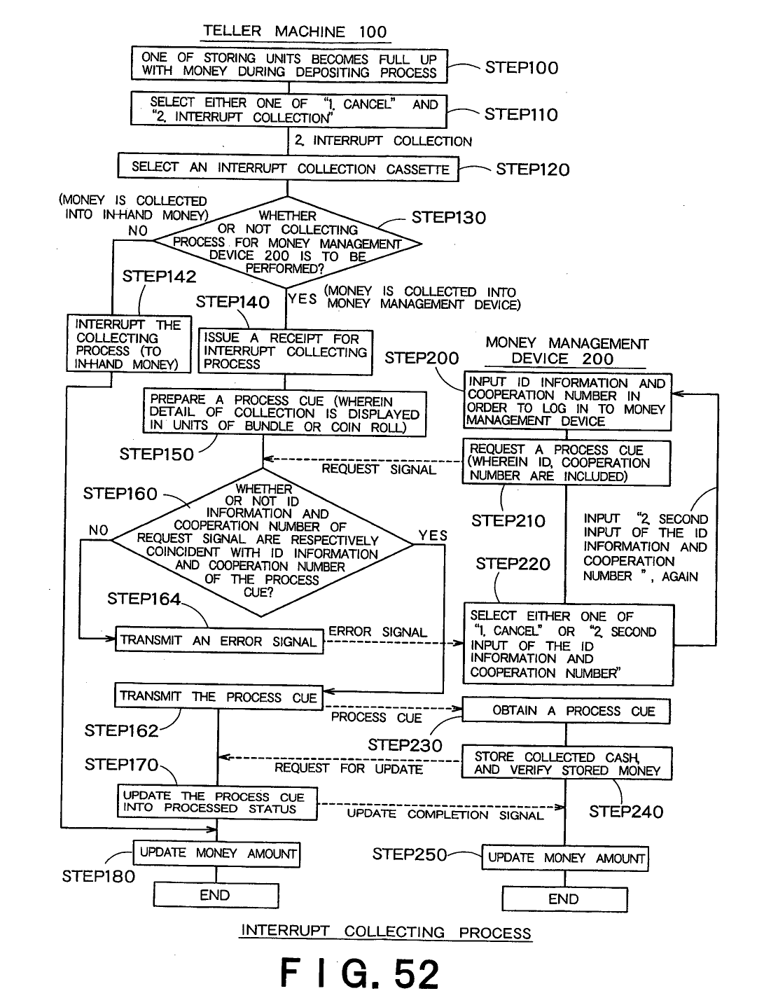

The flow chart of FIG. 52 illustrates the interrupt collecting process in the case in which any one of the storing units becomes full up with the money during the depositing process for depositing the money into the teller machine 100. In this embodiment, in the case in which any one of the storing units (e.g., 3a to 3e in FIG. 51) becomes full up with the money during the depositing process for depositing the money into the teller machine 100, this depositing process is interrupted even in the middle of the process, while the money of the storing unit that is full up with the money will be transferred to the money management device 200 (or in-hand money). Then, once the money of such a full storing unit is transferred to the money management device 200 (or in-hand money), the depositing process is restarted. Herein, the “in-hand money” refers to the money managed, at hand, by the operator (e.g., the banker). Further, the “in-hand money” is managed, as the in-hand money amount, together with the money stored in the money management device 200, by the teller machine 100 (see FIG. 52).

First, assume that one of the storing units becomes full up with the money during the depositing process in the teller machine 100 (S100). For instance, when one full detector 39 shown in FIG. 51 detects the corresponding lifting stage 30, the teller machine 100 recognizes that any one of the storing units is full up with the money. Then, the teller machine 100 controls the display section 15a to display thereon an indication of “1. Cancel” or “2. Interrupt collection” (S110). The item of “1. Cancel” indicates a process for stopping the depositing process being performed at this point of time. Meanwhile, the item of “2. Interrupt collection” indicates a process for interrupting the depositing process, and then collecting the money from the full storing unit of the teller machine 100 into the money management device 200. Then, the operator selects either one of the “1. Cancel” or “2. Interrupt collection”. However, in the case in which a part of the money deposited in the depositing process is already stored in the storing unit 3, if the operator selects the “1. Cancel”, this depositing process is once interrupted. Thereafter, only when the operator logs in again, by using the same ID, and select the same process, the depositing process can be further continued.

In the Step S110, when the operator selects the item of “2. Interrupt collection”, the teller machine 100 operates the display section 15a to display thereon the selection screen for selecting an interrupt collection cassette (S120). In this case, the “interrupt collection cassette” means the bundle storing unit from which the money is to be collected, among the bundle storing units 3a to 3e of the storing unit 3. At this time, the storage condition in each bundle storing unit is also displayed on the display section 15a. Thus, the operator can confirm not only the full bundle storing unit, but also the amount of money stored in each bundle storing unit. Then, the operator selects the storing unit from which the money is to be collected, among the storing units. At this time, the operator may select not only the full storing unit, but also another storing unit that is in a nearly full up storage condition.

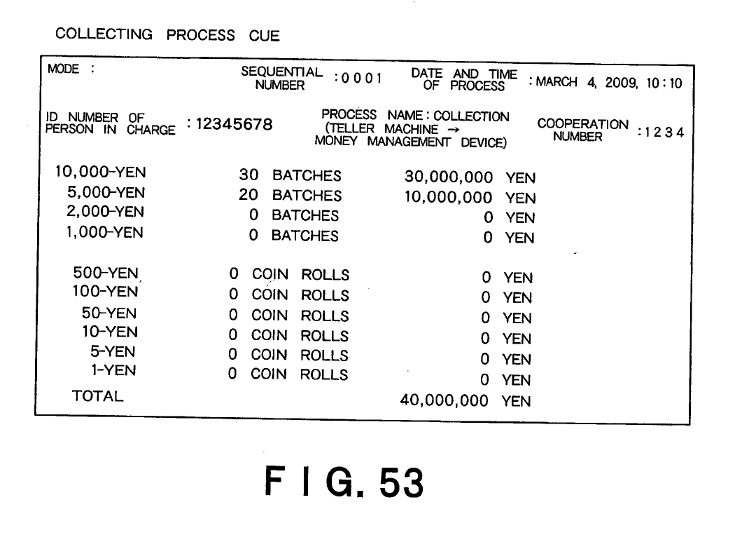

After the storing unit from which the money is to be collected is selected, the teller machine 100 operates the display section 15a to display thereon the selection screen for selecting whether or not the collecting process into the money management device 200 is to be performed (S130). When the operator selects the indication of “1. Yes”, the collecting process into the money management device 200 is performed (S140). More specifically, the teller machine 100 dispenses the banknote bundles B from the bundle release slot 113 or bundle inlet/outlet 10, as well as issues the certification slip (or receipt) on which the cooperation number used for the certification for the cooperation process is recorded. For instance, this receipt may be a slip of paper on which the cooperation number or the like is printed. More specifically, the content recorded or printed on the receipt includes the same information as the process cue that will be described later with reference to FIG. 53. In this case, the number of batch of the bundles (or coin rolls) of the money to be dispensed may be designated by the operator, or calculated by the main control unit 15c of the teller machine 100.

In the case in which the operator designates the number of batch of the bundles (or coin rolls) of the money to be dispensed, the teller machine 100 controls the display section 15a to display thereon an input screen for inputting the number of batch of the bundles (or coin rolls) of the money (S140). Then, the operator inputs the number of batch of the bundles (or coin rolls) of the money to be dispensed, depending on the amount of money deposited. Thus, the teller machine 100 dispenses the money, by the inputted number of batch of the bundles (or coin rolls), from the storing unit selected in the Step S120. In this case, the operator can optionally increase or decrease the number of batch of the bundles (or coin rolls) of the money to be collected, depending on the amount of money deposited into the teller machine 100 upon the depositing process.

Meanwhile, in the case in which the number of batch of the bundles (or coin rolls) of the money to be collected is calculated by the main control unit 15c, this number of batch of the bundles (or coin rolls) to be collected is calculated, based on the number of batch of the bundles (or coin rolls) of the money stored in the storing unit selected in the Step S120. For instance, the main control unit 15c calculates the number of batch of the bundles to be collected, as a half of the number of batch of the banknote bundles B stored in the selected storing unit. In this way, the input operation by the operator for inputting the number of batch of the bundles (or coin rolls) can be omitted. Of course, the calculated number of batch of the bundles (or coin rolls) may be optionally increased or decreased by the operator.

Then, the teller machine 100 prepares the collecting process cue (S150). More specifically, the main control unit 15c serves as a process information preparation unit for preparing the collecting process cue, as the cooperation process information on the money.

FIG. 53 schematically illustrates the collecting process cue (i.e., the cooperation process information). This collecting process cue is provided for indicating the number of batch of the bundles (or coin rolls) of the money actually dispensed, for each denomination thereof. In this case, the “Process name” is “Collection (Teller machine to Money management device)”, indicating the process cue related to the collecting process from the teller machine 100 to the money management device 200. The cooperation number is assigned to each collecting process or refill process, and is used for the certification for each cooperation process. Of course, a different cooperation number is always assigned to each different process. In the collecting process cue shown in FIG. 53, the number of batch of the bundles and amount of money of the banknote bundles B to be collected are respectively shown, for each denomination of money. However, the display of the amount of money may be omitted, because it can be readily calculated from the denomination and number of batch of the bundles (or coin rolls) of the money to be collected. While only the bundled banknotes are displayed in the collecting process cue shown in FIG. 53, the wrapped coins (or coin rolls) may also be displayed in the same manner. For instance, in the case of collecting the wrapped coins from the wrapped-coin handling machine 13, the main control unit 15c can also serve to display the denomination and number of the wrapped coins to be collected, in the collecting process cue. Further, the information of each collecting process cue is stored in the ROM 15d or RAM 15e.

Now, referring to FIG. 52 again, the operator goes through a procedure for the depositing process in the money management device 200, by using the receipt issued from the teller machine 100. First, the operator inputs the ID information to the money management device 200, in order to log in to this device 200 (S200). For instance, this ID information includes a personal ID, a password and the like, respectively provided for identifying the operator. Further, the operator inputs the cooperation number recorded on the receipt (S200).

Then, the money management device 200 transmits a request signal for requesting the process cue to the teller machine 100 (S210). This request signal includes the aforementioned ID information and cooperation number. Once the teller machine 100 receives the request signal, the main control unit 15c compares the ID information of the collecting process cue stored in the ROM 15d or RAM 15e with the ID information included in the request signal. In addition, the main control unit 15c compares the cooperation number of the collecting process cue stored in the ROM 15d or RAM 15e with the cooperation number included in the request signal.

In the case in which the ID information of the collecting process cue is coincident with the ID information included in the request signal and in which the cooperation number of the collecting process cue is coincident with the cooperation number included in the request signal (i.e., “YES” in Step S160), the teller machine 100 transmits this collecting process cue to the money management device 200 (S162). However, if either one of the ID information or cooperation number of the collecting process cue is not coincident with the other ID information or cooperation number included in the request signal (i.e., “NO” in the Step S160), the teller machine 100 transmits an error signal indicating that either one of the ID information or cooperation number is not coincident with the other ID information or cooperation number, to the money management device 200 (S164). In this manner, by verifying the ID information, the teller machine 100 can confirm whether or not the operator that collected the money from the teller machine 100 is the same person as the operator that will store the money in the money management device 200. Further, by verifying the cooperation number, even in the case in which the plurality of process cues are stored in the ROM 15d or RAM 15e, the teller machine 100 can search a necessary process cue and transmit it to the money management device 200.

Once receiving the aforementioned error signal, the money management device 200 informs the operator of the verifying result that the ID information of the collecting process cue is not coincident with the ID information included in the request signal, or of the verifying result that the cooperation number of the collecting process cue is not coincident with the cooperation number included in the request signal. In addition, the money management device 200 operates the display section 227 to display thereon the item of “1. Cancel” together with an item of “2. Input the ID information and cooperation number” (S220). In this case, the item of “1. Cancel” indicates a process for stopping the interrupt collecting process being performed at the point of time of this display operation. Namely, when the “1. Cancel” is selected, the procedure or flow returns to the Step S110. Then, in this Step S110, the operator can stop the depositing process being performed at this point of time, or otherwise can carry out again the interrupt collecting process from the beginning.

Meanwhile, the item of “2. Input the ID information and cooperation number” in the Step S220 indicates a process for inputting again the ID information and/or cooperation number. For instance, in the case in which the operator thinks that incorrect ID information and/or cooperation number might be inputted mistakenly, this operator selects the item of “2. Input the ID information and cooperation number”. Then, the ID information and/or cooperation number can be inputted again, thereby to perform the process again from the Step S210. It is noted that once receiving the error signal, the money management device 200 will not open the storage drawers 211 to 214.

Meanwhile, in the case in which the ID information of the collecting process cue is coincident with the ID information included in the request signal and in which the cooperation number of the collecting process cue is coincident with the cooperation number included in the request signal (i.e., “YES” in the Step S160), the teller machine 100 transmits the process cue (S162). Then, the money management device 200 receives this collecting process cue (S230). At this time, the money management device 200 informs the operator of the fact that this device 200 has received the collecting process cue. Further, at this time, the money management device 200 may automatically open the storage drawers 211 to 214, in response to the acquisition of the collecting process cue. Thus, the operator can store the money collected from the teller machine 100 in any suitable one of the storage drawers 211 to 214 (S240).

In this embodiment, the operator inputs both of the ID information and cooperation number to the money management device 200, while the teller machine 100 verifies both of the ID information and cooperation number for the transmission of the process cue. However, the teller machine 100 may verify only one of the ID information and cooperation number for the transmission of the process cue. However, for ensuring higher security, it is preferred that the teller machine 100 verifies both of the ID information and cooperation number for the transmission of the process cue.

Once the operator closes the storage drawers 211 to 214 after storing the money in any one of the storage drawers 211 to 214, the money management device 200 verifies whether or not the denomination and number of batch of the bundles (or coin rolls) of the stored money respectively correspond to the information on the denomination and number of batch of the bundles (or coin rolls) included in the collecting process cue. More specifically, the money management device 200 starts the automatic reconciling operation, in response to the closing operation for the respective storage drawers 211 to 214. In this automatic reconciling operation, the weight measurement for the money is performed for each denomination thereof, and the number of batch of the bundles or (coin rolls) is calculated for each denomination of the money, and then the so-calculated number of batch of the bundles or (coin rolls) is compared with the information on the collecting process cue.

As a result, if the denomination and number of batch of the bundles (or coin rolls) of the stored money are not respectively coincident with the denomination and number of batch of bundles (or coin rolls) of the money included in the collecting process cue, the money management device 200 operates the display section 227 to display thereon the error message. In this case, in addition to the error message, the display section 227 displays thereon the denomination of money that does not correspond to the information of the collecting process cue, as well as displays thereon the number of batch of the bundles (or coin rolls) less than required or greater than limited. At this time, the money management device 200 may automatically open again the storage drawers 211 to 214. In this case, since the ID information and cooperation number are already verified, the operator can determine that the money of an incorrect denomination or of an incorrect number of batch of bundles (or coin rolls) has been stored in the money management device 200. Thus, the operator can deposit again the money of a correct denomination or of a correct number of batch of bundles (or coin rolls), into the money management device 200.

Meanwhile, if the denomination and number of batch of the bundles (or coin rolls) of the stored money are respectively coincident with the denomination and number of batch of bundles (or coin rolls) of the money indicated in the collecting process cue, the money management device 200 transmits an update request to the teller machine 100. This update request is outputted, as collecting process completion information, for indicating that the money transfer operation for the collecting process has been normally completed, as well as for altering the collecting process cue stored on the side of the teller machine 100 into the processed status.

Once receiving the update request via the communication IF 19, the teller machine 100 alters the collecting process cue, from the unprocessed status into the processed status (S170). For instance, the process condition of each collecting process cue can be updated by logically inverting flag information included in the collecting process cue. In this case, the flag information is stored, together with each corresponding collecting process cue, in the ROM 15d or RAM 15e.

After updating the collecting process cue, the teller machine 100 transmits an update completion signal to the money management device 200. In addition, after the transmission of the update completion signal, the teller machine 100 updates the money amount (S180). With this update operation for the money amount, the teller machine 100 terminates a series of interrupt collecting processes. Meanwhile, once receiving the update completion signal, the money management device 200 updates the money amount (S250). At this point of time, the money management device 200 also terminates the series of interrupt collecting processes. Thereafter, the teller machine 100 restarts the interrupted depositing process.

By the way, in the case in which the operator does not select the collecting process into the money management device 200 in the Step S130 (i.e., “No” in the Step S130), the money is collected into the in-hand money of the banker (S142). In this case, since the teller machine 100 is not cooperated with the money management device 200, the collecting process cue is not prepared. Namely, in the teller machine 100, the money amount is updated by the key operation carried out by the operator, after the money is collected (S180). In this case, the money amount of the money management device 200 can be updated upon the next cooperation process between the teller machine 100 and the money management device 200.

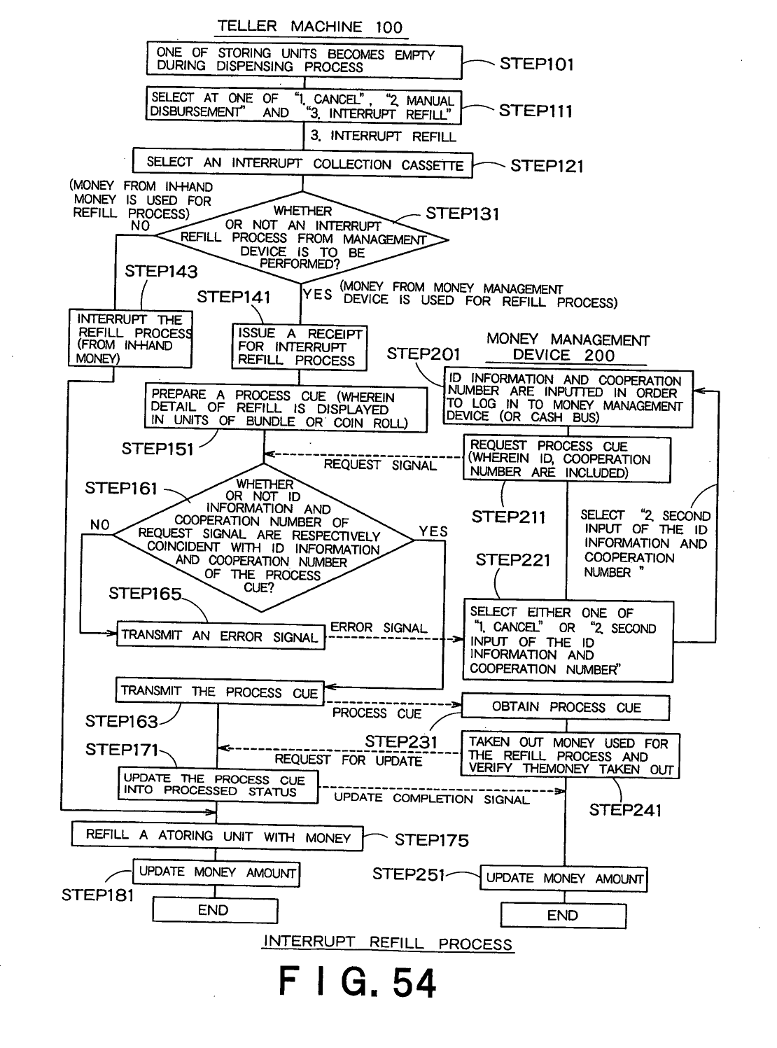

The flow chart of FIG. 54 illustrates the interrupt refill process in the case in which any one of the storing units becomes empty during the dispensing operation for dispensing the money from the teller machine 100. In this embodiment, when any one of the storing units (e.g., 3a to 3e of FIG. 51) becomes empty during the dispensing process for the money from the teller machine 100, this dispensing process is interrupted even in the middle of the process, and then the empty storing unit is refilled with the money from the money management device 200 (or in-hand money). In this way, once the refill process for the storing unit with the money is ended, the dispensing process is restarted.

First, assume that any one of the storing units becomes empty (e.g., completely empty or nearly empty) in the teller machine during the dispensing operation 100 (S101). For instance, this empty state or condition of the storing unit can be detected, when the empty detector 37 shown in FIG. 51 detects a certain lifting stage 30. At this time, the teller machine 100 recognizes that the one of the storing units becomes empty. Then, the teller machine 100 controls the display section 15a to display thereon the item of “1. Cancel”, “2. Manual disbursement” or “3. Interrupt refill” (S111). In this case, the item of “1. Cancel” indicates a process for stopping the interrupt refill relative to the dispensing process being performed at this point of time. The item of “2. Manual disbursement” indicates a process for preparing the cash to be dispensed, by applying the in-hand money of the operator (or banker) to the money already dispensed from the teller machine 100. When this “2. Manual disbursement” is selected, the teller machine 100 does not perform the cooperation process with the money management device 200. The item of “3. Interrupt refill” indicates a process for interrupting the depositing process, and then refilling the storing unit 3 of the teller machine 100 with the money from the money management device 200. Then, the operator selects any one of the “1. Cancel”, “2. In-hand disbursement” and “3. Interrupt refill”. However, in the case in which a part of the money is already dispensed from the storing unit 3 for the dispensing process, the operator cannot select the item of “1. Cancel”. This is because the part of the money already dispensed should be once returned to the storing unit 3. However, if the dispensing operation is not yet started upon the selection of the item, the operator can select the item of “1. Cancel”.

When the operator selects the item of “3. Interrupt refill” in the Step S111, the teller machine 100 operates the display section 15a to display thereon the selection screen for an interrupt refill cassette (S121). In this case, the “interrupt refill cassette” means the storing unit to be refilled with money, among the storing units (e.g., 3a to 3e) of the storing unit 3. At this time, the storage condition in each bundle storing unit is displayed on the display section 15a. Thus, the operator can confirm not only the empty storing unit, but also the amount of money stored in each storing unit. Then, the operator selects the storing unit to be refilled with the money, among the storing units. At this time, the operator may select not only the empty storing unit, but also another storing unit that is in a nearly empty condition. In addition to the bundled (or wrapped) money in the storing unit 3, the loose money (i.e., the loose banknotes and loose coins), from which the bundled (or wrapped) money can be prepared, may also be displayed on the display section 15a. In this way, the operator can also refill the storing unit with the loose money, thereby securely preventing the storing unit from being empty. In the case of refilling the storing unit with the loose money, the operator prepares the loose money from the bundled money taken out from the money management device 200, and then refill the teller machine 100 with the so-prepared loose money. If required, the loose money can be optionally bundled.

After the storing unit to be refilled with the money is selected, the teller machine 100 operates the display section 15a to display thereon the selection screen for selecting whether or not the refill process from the money management device 200 is to be performed (S131). In this case, if the operator selects the indication of “1. Yes”, the refill process from the money management device 200 is performed (S141). More specifically, the teller machine 100 first issues the certification slip (or receipt) on which the cooperation number used for the certification for the cooperation process is recorded. The content recorded or written on the receipt includes the same information as a refill process cue that will be described later. The number of batch of bundles (or coin rolls) of the money to be used for the refill process may be designated by the operator, or calculated by the main control unit 15c of the teller machine 100.

In the case in which the operator designates the number of batch of bundles (or coin rolls) of the money to be used for the refill process, the teller machine 100 controls the display section 15a to display thereon the input screen for inputting the number of batch of bundles (or coin rolls) of the money (S141). Then, the operator inputs the number of batch of bundles (or coin rolls) of the money to be used for the refill process, depending on the amount of money to be dispensed. Thus, the main control unit 15c of the teller machine 100 serves to prepare the refill process cue for indicating the inputted number of batch of the bundles (or coin rolls), based on the denomination of money corresponding to the storing unit selected in the Step S121. In this case, the operator can optionally increase or decrease the number of batch of bundles (or coin rolls) of the money to be used for the refill process, depending on the amount of money to be dispensed to the teller machine 100.

In the case in which the number of batch of bundles (or coin rolls) of the money to be used for the refill process is calculated by the main control unit 15c, this number of batch of bundles (or coin rolls) of the money to be used for the refill process is calculated, based on the capacity (i.e., the maximum number of batch of bundles (or coin rolls) that can be used for the refill process) of the storing unit selected in the Step S121. For instance, the main control unit 15c calculates the number of batch of bundles of the money to be used for the refill process, as a half of the capacity (i.e., the maximum number of batch of the bundles that can be used for the refill process) of the selected bundle storing unit. In this way, the input operation by the operator to input the number of batch of bundles (or coin rolls) can be omitted. Of course, the calculated number of batch of bundles (or coin rolls) may be optionally increased or decreased by the operator.

Then, the teller machine 100 prepares the refill process cue (S151). More specifically, the main control unit 15c serves as the process information preparation unit for preparing the refill process cue, as the process information on the money.

Because the general concept of the refill process cue is similar to the collecting process cue shown in FIG. 53, this refill process cue will be described, without referring to any other special drawing than FIG. 53. Namely, this refill process cue is provided for indicating the number of batch of bundles (or coin rolls) of the money scheduled to be used for the refill process, for each denomination of the money. Accordingly, in this case, the “Process name” shown in FIG. 53 is changed into “Refill (Money management device to Teller machine)”, indicating the process cue related to the refill process from the money management device 200 to the teller machine 100. Again, the different cooperation number is assigned to each different refill process cue. Further, in each refill process cue, the number of batch of bundles and amount of money of the banknote bundles B to be used for the refill process are respectively indicated, for each denomination of money. The other concept of this refill process cue is the same as the concept of the collecting process cue shown in FIG. 53. Further, like the collecting process cue, the refill process cue is also stored in the ROM 15d or RAM 15e.

Now, returning to FIG. 54, the operator goes through a procedure for the dispensing process in the money management device 200. First, the operator inputs the ID information to the money management device 200 in order to log in to this device 200 (S201). Further, the operator inputs the cooperation number recorded on the receipt (S200). Then, the money management device 200 transmits the request signal. Since the transmission operation concerning this request signal for the refill process is generally the same as the transmission operation concerning the request signal for the collecting process, the explanation on details of the transmission operation in this refill process is omitted here. Further, since the verifying operation for the refill process cue is substantially the same as the verifying operation for the aforementioned collecting process cue, the explanation on details of the verifying operation in this refill process is now omitted. Namely, the operations in Steps S161, S163 and S165 are respectively the same as the operations in the Steps S160, S162 and S164, respectively shown in FIG. 52. In addition, the operations in Steps S211, S221 and S231 are respectively the same as the operations in the Steps S210, S220 and S230, respectively shown in FIG. 52.

Once obtaining the refill process cue in the Step S231, the money management device 200 informs the operator of the fact that this device 200 has obtained the refill process cue. Further, the money management device 200 may automatically open the storage drawers 211 to 214, in response to the acquisition of the refill process cue. Thus, the operator can take out the money scheduled to be used for refilling the teller machine 100, from the drawers 211 to 214 (S241).

After the money is taken out from the drawers 211 to 214 and when the operator closes the storage drawers 211 to 214, the money management device 200 verifies whether or not the denomination and number of batch of bundles (or coin rolls) of the money taken out respectively correspond to the information on the denomination and number of batch of bundles (or coin rolls) included in the refill process cue. More specifically, the money management device 200 starts the automatic reconciling operation, in response to the closing operation for the respective storage drawers 211 to 214. In this automatic reconciling operation, the weight measurement for the money is performed for each denomination thereof, and the number of batch of the bundles or (coin rolls) is calculated, for each denomination of the money, and then the so-calculated number of batch of the bundles or (coin rolls) is compared with the information on the refill process cue.

As a result, if the denomination and number of batch of the bundles (or coin rolls) of the money taken out are not respectively coincident with the denomination and number of batch of bundles (or coin rolls) of the money indicated in the refill process cue, the money management device 200 operates the display section 227 to display thereon the error message. In this case, in addition to the error message, the display section 227 displays thereon the denomination of money that is not coincident with the information of the refill process cue, as well as displays thereon the number of batch of the bundles (or coin rolls) less than required or greater than limited. At this time, the money management device 200 may automatically open the storage drawers 211 to 214. In this case, since the ID information and cooperation number are already verified, the operator can determine that the money of the incorrect denomination or of the incorrect number of batch of bundles (or coin rolls) has been taken out from the money management device 200. Thus, the operator can take out again the money from the money management device 200, with the denomination and number of batch of bundles (or coin rolls) of the money respectively corresponding to those in the information of the refill process cue.

Meanwhile, if the denomination and number of batch of the bundles (or coin rolls) of the money taken out are respectively coincident with the denomination and number of batch of bundles (or coin rolls) of the money indicated in the refill process cue, the money management device 200 transmits the update request to the teller machine 100. This update request is outputted, as take-out process completion information, for indicating that the money in the refill process is normally taken out from the money management device 200, as well as for altering the refill process cue stored on the side of the teller machine 100 into the processed status.

Once receiving the update request via the communication IF 19, the teller machine 100 alters the refill process cue, from the unprocessed status into the processed status (S171). For instance, the process condition of each refill process cue can be updated by logically inverting the flag information included in the refill process cue. In this case, the flag information is stored, together with each corresponding refill process cue, in the ROM 15d or RAM 15e.

After updating the refill process cue, the teller machine 100 transmits the update completion signal to the money management device 200. Then, after the transmission of the update completion signal, the operator refills the storing unit of the teller machine 100 with the money taken out from the money management device 200 (S175). This refill process with the money is performed by depositing the money into the inlet/outlet 10 of the teller machine 100. After the refill process with money, the teller machine 100 updates the money amount (S181). With this update operation for the money amount, the teller machine 100 terminates a series of interrupt refill processes. Meanwhile, once receiving the update completion signal, the money management device 200 updates the money amount (S251). At this point of time, the money management device 200 also terminates the series of interrupt refill processes. Thereafter, the teller machine 100 restarts the interrupted dispensing process.

By the way, in the case in which the operator does not select the take-out process from the money management device 200 in the Step S131 (i.e., “No” in the Step S131), the operator uses the in-hand money for refilling the teller machine 100 (S143). In this case, since the teller machine 100 is not cooperated with the money management device 200, the refill process cue is not prepared. Thereafter, when the teller machine 100 is refilled with the money in the Step S175, the money amount is updated by the key operation carried out by the operator (S181). In this case, the money amount of the money management device 200 can be updated in the next cooperation process between the teller machine 100 and the money management device 200.

The above description is provided for explaining the collecting process and refill process, respectively related to the bundled banknotes and/or wrapped-coins. However, such processes can also be applied to the loose banknotes and/or loose coins. In this case, the expression of “the number of batch of bundles (or coin rolls)” is changed into “the number of money”.

As described above, in this embodiment, even in the case in which any one of the storing units in the teller machine 100 is full up with the money during the depositing process into the teller machine 100, the operator can smoothly collect the money from the teller machine 100 into the money management device 200, by setting the teller machine 100 and money management device 200 to be in cooperation with each other. Further, even in the case in which any one of the storing units in the teller machine 100 becomes empty during the dispensing process from the teller machine 100, the operator can smoothly refill the teller machine 100 with the money from the money management device 200, by arranging the teller machine 100 and money management device 200 to be cooperated with each other, in the same manner as in the above case. Namely, according to this embodiment, a substantially continuous or seamless handling operation for the money can be achieved.

Further, with the cooperation between the teller machine 100 and the money management device 200, the teller machine 100 can perform the well accurate and centralized management on the stock money amount, machine money amount and post money amount, as well as on the in-hand money amount including the money-management-device money amount.

### Fourth Embodiment

The fourth embodiment is related to the whole collecting process for the money stored in the money management device 200.

### (Whole Collecting Process for the Money Stored in the Money Management Device 200)

Hereinafter, one operation (that will be referred to as the “whole collecting process”), in which all of the money stored in the money management device 200 is collected as the in-hand money of the operator, will be described.

Usually, in this whole collecting process, the following operations are performed. Namely, in this process, the operator confirms the money amount stored in the money management device 200, and writes this money amount on a note or the like. Then, in the teller machine 100, the operator selects the take-out process from the money management device 200 to the in-hand money, and manually inputs the money amount of the money management device 200. Thereafter, based on the money amount manually inputted, the teller machine 100 prepares the process cue, and transmits it to the money management device 200. In this way, the operator can collect all of the money stored in the money management device 200.

However, in this operation, it is necessary for the operator to write the money amount of the money management device 200 on the note or the like, and then manually input this money amount to the casher machine 100. Therefore, the labor of this operator is rather increased, thus being likely to cause the operator to make mistakes upon the input operation.

In view of such inconvenience, a new whole collecting process is proposed herein.

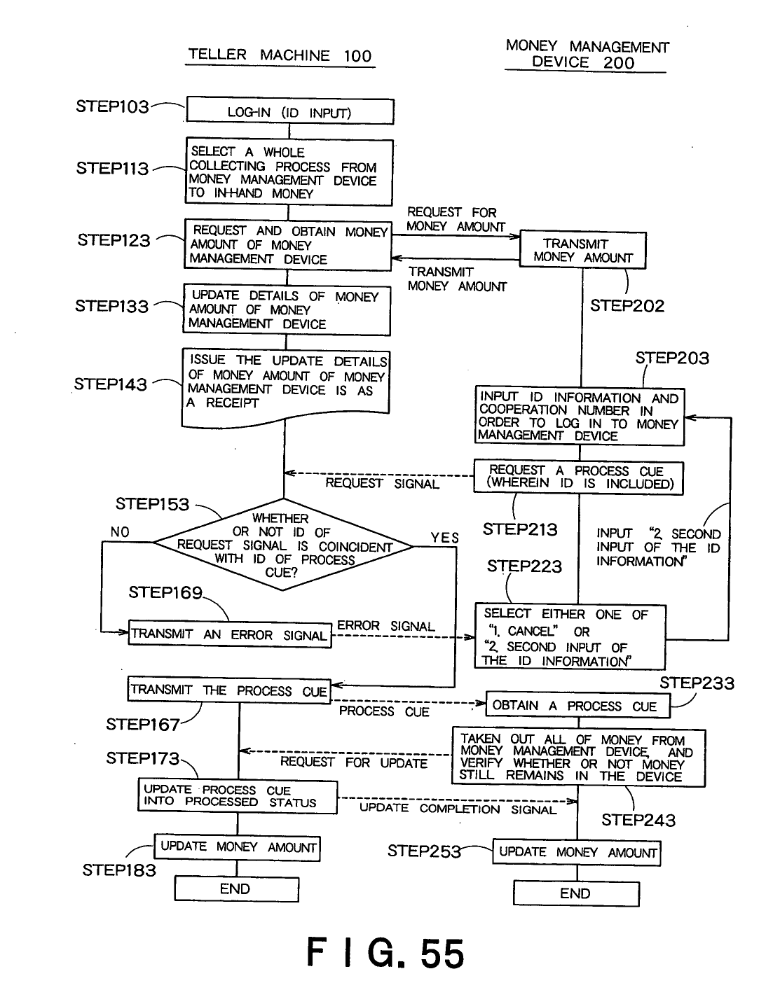

The flow chart of FIG. 55 illustrates the whole collecting process related to this embodiment. First, the operator inputs the ID information to the teller machine 100 in order to log in to this machine 100 (S103). Once the operator logs in to the teller machine 100, the teller machine 100 controls the display section 15a to display thereon the process menu. Then, from this process menu, the operator selects the “Whole collecting process” (S113). Once the “Whole collecting process” is selected, the screen of FIG. 19B is displayed in the money management device 200. Thereafter, when the ID information is inputted, the process menu of FIG. 19C is displayed.

Further, once the whole collecting process is selected, the teller machine 100 transmits a money amount request signal to the money management device 200, in order to confirm the total amount of money stored in the money management device 200 (S123). This money amount request signal is provided for requesting the information on the total amount of money stored in the money management device 200.

Once receiving the money amount request signal, the money management device 200 transmits the information on the total amount of money stored in this money management device 200 to the teller machine 100 (S202). At this time, the ID information is not verified. This is because there is no money transfer operation, as well as because only the information on the money amount of the money management device is transmitted and received between the teller machine 100 and the money management device 200.

Once receiving the information on the money amount of the money management device 200, the teller machine 100 reflects this money amount information to the money-management-device money amount 4X shown in FIG. 12, as well as to a bill of the whole collecting process (S133).

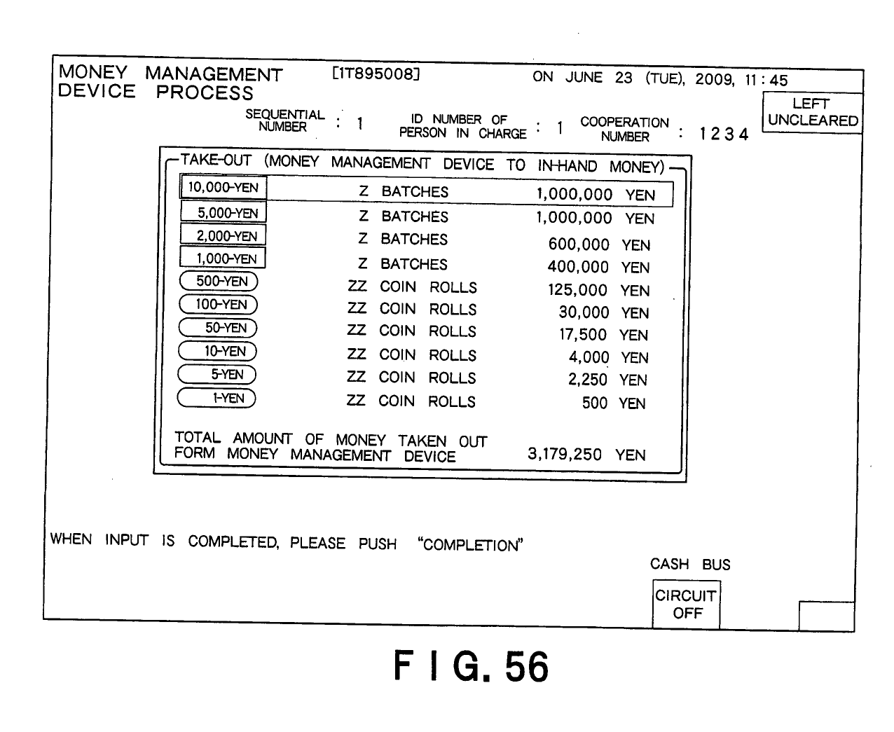

FIG. 56 schematically illustrates one example of the bill of the whole collecting process. This bill is displayed on the display section 15a of the teller machine 100, and includes the information on the denomination and number of batch of bundles (or coin rolls) of all of the money stored in the money management device 200. Further, this bill may include the information on the ID information and identification number of the operator. While, in FIG. 56, the amount of money is displayed for each denomination thereof, this display may be omitted because the amount of money can be readily calculated from the denomination and number of batch of bundles (or coin rolls) of the money collected. Meanwhile, for the loose banknotes or loose coins, the amount of money is displayed by using the number of such money.

Now referring again to FIG. 55, the operator pushes down a completion button of the teller machine 100, after confirming the bill of the whole collecting process. Thus, the teller machine 100 issues the bill, as the receipt, including the money amount information on the money management device 200 (S143).

Then, the operator goes through a procedure for the whole collecting process in the money management device 200, by using the receipt issued from the teller machine 100. At this time, the operations in Steps S203, S213, S223, S233 and S253 are respectively similar to the operations in the Steps S200, S210, S220, S230 and S250 respectively shown in FIG. 52. In addition, the operations in Steps S153, S167, S169, S173 and S183 are respectively similar to the operations in the Steps S150, S160, S162, S164, S170 and S180, respectively shown in FIG. 52. Therefore, the explanation on details of such steps is omitted here.

Once the money management device 200 obtains the process cue, the operator collects all of the money in the money management device 200, and manages this money as the in-hand money (S242). At this time, the money management device 200 verifies the presence of the money still remaining therein (S242). More specifically, the money management device 200 starts the automatic verify operation, in response to the closing operation for the storage drawers 211 to 214. In this automatic verify operation, the weight measurement for the money is performed for each denomination thereof, in order to confirm that there is no remaining money over all of the denominations.

If there is the remaining money of some denomination, the money management device 200 controls the display section 227 to display thereon the error message. In this case, in addition to the error message, the display section 227 displays thereon the denomination and number of batch of bundles (or coin rolls) of the money remaining in the money management device 200. At this time, the money management device 200 may automatically open the storage drawers 211 to 214. Thus, the operator can collect all of the money from the money management device 200.

When the money amount is updated in each Step S183, S253, the total amount of money stored in the money management device 200 is all added to the in-hand money amount. Thus, the money-management-device money amount becomes zero.

In the whole collecting process according to this embodiment, when the operator selects the whole collecting process, the money-management-device money amount is automatically updated between the teller machine 100 and the money management device 200. Thus, the teller machine 100 can obtain an accurate money-management-device money amount. As such, the teller machine 100 can prepare the bill and receipt, based on this updated money-management-device money amount. As a result, the necessity for the operator to write or record the money amount of the money management device 200 on the note or the like can be eliminated, as well as the necessity for the operator to manually input the money amount to the casher machine 100 can be eliminated. Therefore, the labor of the operator can be substantially saved, thereby positively preventing occurrence of the mistakes of the operator during the input operation.

### Fifth Embodiment

The fifth embodiment is related to the data clear process of the teller machine 100 and money management device 200.

### (Data Clear Process of the Teller Machine 100 and Money Management Device 200)

This data clear process is provided for determining or fixing, periodically (e.g., for each day), each of the money amounts of the teller machine 100, money management device 200, in-hand money and stock. Herein, the data clear process is also referred to as the so-called closing balance operation.

Usually, in the data clear process, the operator confirms the total amount of money stored in the teller machine 100 and the process performed in the teller machine 100, in order to determine the money amount and count for each day. At this time, even in the case in which the data on the money-management-device money amount is different from the total amount of money actually stored in the money management device 200 (i.e., in the case of an unfixed money amount), the teller machine 100 can perform the data clear process.

However, if the teller machine 100 performs the data clear process while leaving the money amount of the money management device 200 unfixed, there is a risk that some inaccurate or incorrect process may be overlooked.

Therefore, in order to address such inconvenience, a new data clear process is proposed herein.

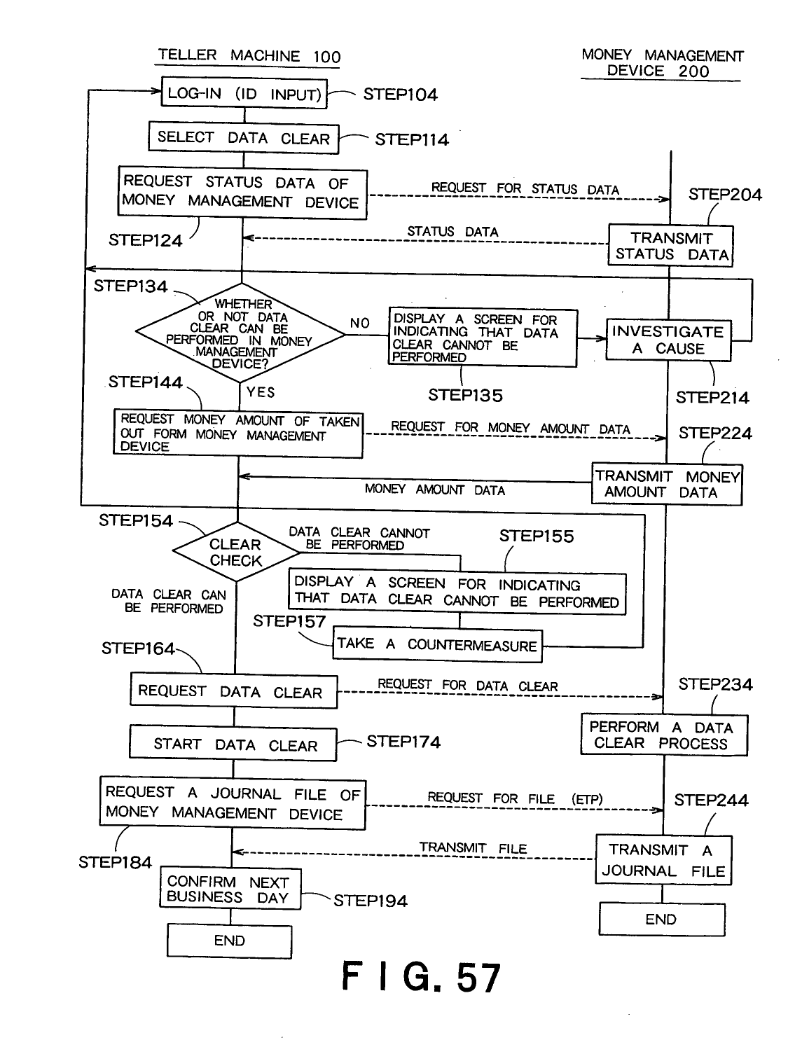

The flow chart of FIG. 57 illustrates the data clear process of this embodiment. First, the operator inputs the ID information to the teller machine 100 in order to log in thereto (S104). Once the operator logs in, the teller machine 100 operates the display section 15a to display thereon the process menu. Then, the operator selects an item of “Data clear” from the process menu (S114). When the “Data clear” is selected, the money management device 200 displays the screen of FIG. 19B, and then the process menu of FIG. 19C is displayed with the input of the ID information. Thereafter, the “Data clear” in the process menu of FIG. 19C is selected.

In this way, once the data clear process is selected, the teller machine 100 transmits a condition data request to the money management device 200, in order to confirm whether or not the money management device 200 is in a state in which the data clear process can be performed therein (S124). As used herein, the “state in which the data clear process can be performed” means a state in which the money amount of the money management device 200 can be detected, a state in which the money management device 200 is not being used, a state in which the teller machine 100 is managed, or the like. Thus, once receiving the condition data request, the money management device 200 will transmit condition data, as information for determining whether or not the data clear process can be performed in the money management device 200, to the teller machine 100 (S204).

Then, once receiving the condition data from the money management device 200 (S134), the teller machine 100 confirms whether or not the money management device 200 is in the state that the data clear process can be performed therein, based on the transmitted condition data.

If the money management device 200 is not in the state that the data clear process can be performed therein (i.e., “NO” in the step S134), the teller machine 100 operates the display section 15a to display thereon an indication for indicating that the money management device 200 is not in the state that the data clear process can be performed therein (S135).

Thus, the operator investigates the cause for the money management device 200 not being in the state that the data clear process can be performed therein (S214). At this time, if required, the operator may log in to the money management device 200. In this way, once clarifying the cause, the operator pushes down the completion button in the money management device 200. Thereafter, the steps S124 and S206 are performed again. As such, the teller machine 100 can obtain updated condition data. Then, the teller machine 100 confirms again whether or not the money management device 200 is in the state that the data clear process can be performed therein, based on the updated condition data (S134).

However, if the cause for the money management device 200 not being in the state that the data clear process can be performed therein cannot be clarified, the operator turns off the load cell 261 for measuring the weight of the money in the money management device 200, or otherwise disconnects the money management device 200 from the teller machine 100. Thus, even though the money management device 200 is not in the state that the data clear process can be performed therein, the teller machine 100 can independently continue the data clear process in this machine 100.

Meanwhile, if the money management device 200 is in the state that the data clear process can be performed therein (i.e., “YES” in the step S134), the teller machine 100 transmits the money amount request to the money management device 200, in order to obtain the money amount data on the money stored in the money management device 200 (S144). Once receiving the money amount request, the money management device 200 transmits the money amount data thereof to the teller machine 100 (S224).

Thereafter, once receiving the money amount data of the money management device 200, the teller machine 100 performs the clear check (S154). For instance, this clear check is provided for checking the machine money amount 1, post money amount 2, limit amount of money that can remain in the money-management-device money amount 4X, unprocessed process cue (or cooperation process information) or the like. As a result, if it is found that the data clear process cannot be performed (S154), e.g., because any of the above money amounts is less than the limit amount of money that can remain therein, the teller machine 100 controls the display section 15a to display thereon the condition that the data clear process cannot be performed (S155). Then, in order to address such a condition, the operator refills the related storing unit in the teller machine 100 or money management device 200 with the money (S157). In this case, the money used for this refill process is taken out from the main safe or in-hand money. Meanwhile, if the unprocessed process cue remains in the teller machine 100, the aforementioned storage process, take-out process, refill process, collecting process or the like is further performed for processing such an unprocessed process cue. In this case, since the money amount is altered, the teller machine 100 requests again the money amount data on the money management device 200 (S144). Thereafter, the teller machine 100 confirms again whether or not the money management device 200 is in the state that the data clear process can be performed therein, based on the updated the money amount data (S154).

As a result, if the money management device 200 is not yet in the state that the data clear process can be performed therein, the operator can terminate this data clear process. Otherwise, the manager may forcedly bring the money management device 200 into the state that the data clear process can be performed therein, in the Step S154.

Meanwhile, if the data clear process can be performed (i.e., “YES” in the step S154), the teller machine 100 transmits the data clear request to the money management device 200 (S162). In this case, while transmitting the data clear request, the teller machine 100 also starts the data clear process in this machine 100 (S172). Once receiving the data clear request, the money management device 200 performs the data clear process (S234). Thus, the money amount on the day of this data clear process can be determined or fixed, in the money management device 200.

Thereafter, the teller machine 100 requests the journal file of the money management device 200, in regard to the data clear process. Then, in response to the request for the journal file, the money management device 200 transmits the journal file to the teller machine 100. This journal file is provided as log information concerning all of the processes (e.g., the storage process, take-out process, collecting process, refill process and the like) associated with the money transfer operations respectively performed on the day of the data clear process, and includes the date and time on which each process was performed, the denomination and number of batch of bundles (or coin rolls) of the money transferred, the ID information of each operator and the like.

Once obtaining the journal file from the money management device 200, the teller machine 100 stores this journal file in the RAM 15e. Thus, the teller machine 100 can perform the centralized management on all of the information concerning the money management device 200 on the day of the data clear process.

Thereafter, the teller machine 100 confirms the next business day (S194). More specifically, the teller machine 100 sets the date of the next business day. If the next day is a holiday, the teller machine 100 sets the next business day as the next day of the holiday.

In this way, the teller machine 100 can not only perform the data clear process for this machine 100, but also perform the data clear process for the money management device 200. As such, the teller machine 100 can prevent the data clear process from being performed with the money amount of the money management device 200 being left unfixed, thereby positively preventing any inaccurate process from being overlooked.

Any suitable combinations of any of the above first to fifth embodiments can be implemented, without departing from the spirit and scope of the present invention. Further, any suitable combinations of all of the first to fifth embodiments can also be implemented, without departing from the spirit and scope of this invention.

1-32. (canceled)

33. A money management system including a teller machine configured to manage money amount in a branch of a financial institution, and a money management device that is connectable with the teller machine so as to be able to communicate with each other, and is capable of independently or solely managing the money amount,
wherein the teller machine comprises:
a money amount management unit configured to manage the money amount including a money-management-device money amount that is the amount of money stored in the money management device;
a cooperation-process-information preparation unit configured to prepare cooperation process information for specifying the content of a storage/take-out process, in the case in which the storage/take-out process is performed in the money management device; and
a cooperation-process-information transmission/reception unit configured to transmit and receive the cooperation process information between the teller machine and the money management device, such that the teller machine manages the money amount including the money-management-device money amount.

34. The money management system according to claim 33, wherein an individual cooperation number is assigned to each cooperation process information, such that the content of the storage/take-out process specified in the cooperation process information is specified by each corresponding cooperation number, and the content of the storage/take-out process specified by the cooperation process information includes information on the denomination and quantity of the money to be handled in the storage/take-out process.

35. The money management system according to claim 33, wherein a person in charge of performing the storage/take-out process is specified in the cooperation process information, such that the cooperation process information and storage/take-out process is specified, respectively, when the person in charge of the storage/take-out process inputs individual ID information to the money management device.

36. The money management system according to claim 33, wherein the money amount managed by the money amount management unit includes a machine money amount that is the total amount of money stored in the teller machine, a stock money amount that is the total amount of money stored in a main safe in the branch of the financial institution, and an in-hand money amount that is the total amount of money manually managed.

37. The money management system according to claim 36, wherein the in-hand money amount includes the money-management-device money amount.

38. The money management system according to claim 36, wherein the storage/take-out process specified by the cooperation process information includes a money transfer process between the money deposited/dispensed by a customer and the money management device, the money transfer process between the stock money amount and the money-management-device money amount, and the money transfer process between the in-hand money amount and the money-management-device money amount.

39. The money management system according to claim 33, wherein upon the preparation of the cooperation process information, if the money amount of the money management device, as a result of performing the storage/take-out process to be specified, would exceed a maximum-limit amount of money that is stored in the money management device, registration of this cooperation process information is rejected.

40. A money management method using a money management system including a teller machine configured to manage the money amount in a branch of a financial institution, and a money management device that is connectable with the teller machine so as to be able to communicate with each other, and is capable of independently or solely managing the money amount,
the money amount, which is managed by the teller machine, including the money-management-device money amount that is the total amount of money stored in the money management device,
the method comprising:
preparing the cooperation process information for specifying the content of the storage/take-out process, by using the teller machine, in the case of performing the storage/take-out process in the money management device; and
transmitting and receiving the cooperation process information between the teller machine and the money management device, such that the teller machine manages the money amount including the money-management-device money amount.

41. A money management system including a teller machine configured to manage a money amount in a branch of a financial institution, and a money management device that is connectable with the teller machine so as to be able to communicate whit each other, and is capable of independently managing the money amount,
wherein the teller machine comprises:
a money amount management unit configured to manage the money amount including a money-management-device money amount that is the total amount of money stored in the money management device;
a cooperation-process-information preparation unit configured to prepare cooperation process information for specifying the content of a storage/take-out process, when the storage/take-out process is performed in the money management device;
a cooperation-process-information transmission/reception unit configured to transmit and receive the cooperation process information between the teller machine and the money management device, such that the teller machine manages the money amount including the money-management-device money amount; and
a cooperation-process-information search unit configured to search and specify the cooperation process information that is in an unprocessed status, upon a closing balance operation.

42. The money management system according to claim 41, wherein the money amount managed by the money amount management unit includes a machine money amount that is the total amount of money stored in the teller machine, a stock money amount that is the total amount of money stored in a main safe in the branch of the financial institution, and an in-hand money amount that is the total amount of money manually managed.

43. The money management system according to claim 42, wherein the in-hand money amount includes the money-management-device money amount.

44. The money management system according to claim 41, wherein the teller machine further comprises a data clear unit configured to perform a data clear process for clearing the cooperation process information temporarily stored in a predetermined work area of the teller machine and money management device, after this cooperation process information on all transaction processes, including the storage/take-out process performed after the previous closing balance operation, is totalized, recorded and stored, upon the present closing balance operation.

45. The money management system according to claim 44, wherein once the information on the start of the data clear process is transmitted from the teller machine to the money management device, the money management device totalizes the cooperation process information on all of the transaction processes including the storage/take-out process performed in the money management device in a predetermined period, in order to prepare an electronic journal file, and then transmits this electronic journal file to the teller machine.

46. The money management system according to claim 45, wherein the teller machine further comprises a clear unit configured to clear the cooperation process information temporarily stored in the predetermined work area of the money management device, by remote control, after the teller machine obtains the electronic journal file.

47. The money management system according to claim 44, wherein the data clear unit is capable of forcedly continuing the data clear process, irrespectively of the presence of the cooperation process information being in the unprocessed status, and the teller machine further comprises a printer configured to print and output a certification print indicating that forced continuation of the data clear process is selected, in the case in which the data clear process is forcedly continued.

48. The money management system according to claim 41, the teller machine further comprises a status altering unit capable of altering the status of the cooperation process information, irrespectively of the process condition of the storage/take-out process being actually performed.

49. A money management method using a money management system including a teller machine configured to manage a money amount in a branch of a financial institution, and a money management device that is connectable with the teller machine so as to be able to communicate with each other and that is capable of independently or solely managing the money amount,
the money amount, which is managed by the teller machine, including a money-management-device money amount that is the total amount of money stored in the money management device, and
the method comprising
preparing the cooperation process information for specifying the content of the storage/take-out process, by using the teller machine, in the case of performing the storage/take-out process in the money management device;
transmitting and receiving the cooperation process information between the teller machine and the money management device, such that the teller machine manages the money amount including the money-management-device money amount; and
searching and specifying the cooperation process information that is in the unprocessed status, upon the closing balance operation.

50. A money management system including a teller machine configured to manage a money amount in a branch of a financial institution, and a money management device that is connectable with the teller machine so as to be able to communicate with each other,
wherein the money management device comprises:
a storing unit configured to store therein money;
a memory configured to store therein money amount of the storing unit; and
a communication unit configured to transmit process information to the teller machine, the process information including the denomination, quantity and/or amount data of money deposited into the storing unit or dispensed from the storing unit, in the case in which the money is deposited into the storing unit or in which the money is dispensed from the storing unit; and
wherein the teller machine comprises:
another communication unit configured to receive the process information from the money management device;
another memory configured to store therein at least money amount of the teller machine and money amount of the money management device; and
an operation unit configured to updating at least the money amount of the money management device, based on the process information.

51. The money management system according to claim 50,
wherein the money management device further comprises:
an input unit provided for inputting the denomination, quantity and/or amount of money deposited into the storing unit or dispensed from the storing unit;
a measurement unit configured to determine the denomination and measure quantity and/or amount of money, the money being actually deposited into the storing unit or actually dispensed from the storing unit; and
an error information unit configured to inform an operator for the money management device of an error, in the case in which the denomination, quantity and/or amount of money inputted via the input unit are different from the denomination, quantity and/or amount of money measured by the measurement unit,
wherein if the denomination, quantity and/or amount of money inputted via the input unit are respectively coincident with the denomination, quantity and/or amount of money measured by the measurement unit, the money management device transmits the process information to the teller machine, and
wherein if the denomination, quantity and/or amount of money inputted via the input unit are different from the denomination, quantity and/or amount of money measured by the measurement unit, the money management device informs the operator for this money management device of the error, without transmitting the process information to the teller machine.

52. The money management system according to claim 50,
wherein the money management system further comprises:
a safe configured to store therein the money in the branch of the financial institution,
wherein the memory of the teller machine stores therein stock money amount which is amount of money stored in the safe, and
wherein in the case in which the money management device is refilled with the money from the safe or in which the money is collected from the money management device into the safe, the communication unit of the money management device transmits the process information including the denomination, quantity and/or amount of money used for refilling the money management device or money collected into the safe, to the teller machine, and then the operation unit of the teller machine updates the stock money amount, based on the process information.

53. The money management system according to claim 50,
wherein the memory of the teller machine stores therein the in-hand money amount that is managed, at hand, by a person in charge of handling the money in the branch of the financial institution,
wherein in the case in which the money management device is refilled with the money from the in-hand money or in which the money is collected from the money management device into the in-hand money, the communication unit of the money management device transmits the process information including the denomination, quantity and/or amount of money used for refilling the money management device or money collected into the in-hand money, to the teller machine, and then the operation unit of the teller machine updates the money amount of the in-hand money, based on the process information.

54. The money management system according to claim 50,
wherein in the case in which the person in charge of handling the money stores the money deposited from the customer, into the money management device in the branch of the financial institution, the money management device adds the amount of money deposited from the customer, to the money amount of the storing unit,
wherein in the case in which the person in charge of handling the money takes out the money disbursed to the customer from the money management device in the branch of the financial institution, the money management device subtracts the amount of money to be disbursed to the customer, from the money amount of the storing unit,
wherein the communication unit of the money management device transmits the process information including the denomination, quantity and/or amount of money stored in the storing unit or money taken out from the storing unit, to the teller machine, and
wherein the operation unit of the teller machine updates the money amount of the money management device, based on the process information.

55. A money management method using a money management system including a teller machine configured to manage a money amount in a branch of a financial institution, and a money management device that is connectable with the teller machine so as to be able to communicate with each other,
the money amount, which is managed by the teller machine, including the money amount of the money management device,
the method comprising:
determining the denomination and measuring quantity and/or amount of money deposited into the money management device or dispensed from the money management device, in the money management device, in the case in which the money is deposited into the money management device or in which the money is dispensed from the money management device;
inputting the denomination, quantity and/or amount of money deposited into the money management device or money dispensed from the money management device, to the money management device;
transmitting process information including the denomination, quantity and/or amount of money deposited into the money management device or money dispensed from the money management device, from the money management device to the teller machine, by using the money management device, in the case in which the denomination, quantity and/or amount of money measured in the measurement operation are respectively coincident with the denomination, quantity and/or amount of money inputted in the input operation; and
updating at least the money amount of the money management device, by using the teller machine, based on the process information.

56. A teller machine connected with a money management device so as to be able to communicate with each other, the money management device configured to store and manage money therein,
the teller machine comprising:
a storing unit configured to store therein the money;
a full detector configured to detect a full-up condition of the storing unit with the money stored therein;
an operation unit configured to generate cooperation process information indicating information on the money collected, in the case in which the money stored in the storing unit is collected into the money management device; and
a transmission/reception unit configured to transmit the cooperation process information to the money management device, as well as to receive collecting completion information for indicating that the money is collected into the money management device on the basis of the cooperation process information, from the money management device,
wherein the operation unit interrupts a depositing process, when the full detector detects the full-up condition of the storing unit with the money stored therein during the depositing process, and then restarts this depositing process, after receiving the collecting completion information.

57. A teller machine connected with a money management device so as to be able to communicate with each other, the money management device configured to store and manage money therein,
the teller machine comprising:
a storing unit configured to store therein the money;
an empty detector configured to detect a nearly empty condition of the storing unit with the money stored therein;
an operation unit configured to generate cooperation process information indicating information on the money used for a refill process, in the case in which the storing unit is refilled with the money from the money management device; and
a transmission/reception unit configured to transmit the cooperation process information to the money management device, as well as to receive take-out completion information for indicating that the money is taken out from the money management device on the basis of the cooperation process information, from the money management device,
wherein the operation unit interrupts a dispensing process, when the empty detector detects the nearly empty condition of the storing unit with the money stored therein during the dispensing process, and then restarts this dispensing process, after receiving the take-out completion information.

58. The teller machine according to claim 56,
wherein the cooperation process information includes a first cooperation number assigned to a money transfer process between the teller machine and the money management device,
wherein the transmission/reception unit receives a second cooperation number from the money management device, the second cooperation number inputted to the money management device by an operator based on the cooperation process information, and
wherein the transmission/reception unit transmits the cooperation process information to the money management device, in the case in which the first cooperation number is coincident with the second cooperation number.

59. The teller machine according to claim 57,
wherein the cooperation process information includes a first cooperation number assigned to a money transfer process between the teller machine and the money management device,
wherein the transmission/reception unit receives a second cooperation number from the money management device, the second cooperation number inputted to the money management device by an operator based on the cooperation process information, and
wherein the transmission/reception unit transmits the cooperation process information to the money management device, in the case in which the first cooperation number is coincident with the second cooperation number.

60. The teller machine according to claim 56, wherein the operation unit updates each of the money amount data on the money stored in the teller machine as well as on the money stored in the money management device, after receiving the collecting completion information or the take-out completion information.

61. The teller machine according to claim 57, wherein the operation unit updates each of the money amount data on the money stored in the teller machine as well as on the money stored in the money management device, after receiving the collecting completion information or the take-out completion information.

62. The teller machine according to claim 56, wherein the operation unit updates the money amount of the teller machine and the money amount of the in-hand money of the operator for the teller machine, without generating the cooperation process information, in the case in which the money stored in the storing unit is collected as the in-hand money of the operator for the teller machine.

63. The teller machine according to claim 57, wherein the operation unit updates the money amount of the teller machine and the money amount of the in-hand money of the operator for the teller machine, without generating the cooperation process information, in the case in which the in-hand money of the operator for the teller machine is used for refilling the storing unit.

64. A money management device connected with a teller machine so as to be able to communicate with each other, the teller machine configured to store therein money as well as to deposit or dispense the money,
the money management device comprising:
a storing unit configured to store therein the money;
an operation unit, which is configured to generate a request signal for requesting cooperation process information from the teller machine, the cooperation process information including information on the money collected into the money management device or information on the money used for refilling the teller machine, and which is configured to generate collecting completion information for indicating that the money is collected from a storing unit into the money management device based on the cooperation process information, or to generate take-out completion information for indicating that the money is taken out from the money management device based on the cooperation process information; and
a transmission/reception unit configured to transmit the collecting completion information or take-out completion information, to the teller machine, in the case in which the money is collected into the storing unit based on the cooperation process information obtained from the teller machine, or in which the money is taken out from the storing unit based on the cooperation process information.

65. The money management device according to claim 64,
wherein the cooperation process information includes a first cooperation number assigned to a money transfer process between the teller machine and the money management device,
wherein the request signal includes a second cooperation number inputted to the money management device by an operator, and
wherein the money management device transmits the request signal to the teller machine, in the case in which the second cooperation number is inputted thereto, while the money management device receives the cooperation process information from the teller machine, in the case in which the first cooperation number is coincident with the second cooperation number.

66. The money management device according to claim 64, wherein the operation unit updates each of the money amount data on the money stored in the teller machine as well as on the money stored in the money management device, after transmitting the collecting completion information or take-out completion information.
